(19) United States
(12) Patent Application Publication
(10) Pub. No.: US 2018/0269729 A1
(43) Pub. Date: Sep. 20, 2018

(54) MOTOR AND METHOD FOR MANUFACTURING STATOR

(71) Applicant: ASMO CO., LTD., Shizuoka-ken (JP)

(72) Inventors: Yoshiaki TAKEMOTO, Toyohashi-shi (JP); Shigemasa KATO, Toyohashi-shi (JP); Masashi MATSUDA, Kakegawa-shi (JP); Hironari SUZUKI, Kariya-shi (JP); Kazunori SHIMADA, Toyohashi-shi (JP); Sho NAKANO, Kariya-shi (JP); Takahiro TSUCHIYA, Toyohashi-shi (JP)

(73) Assignee: ASMO CO., LTD., Shizuoka-ken (JP)

(21) Appl. No.: 15/562,928

(22) PCT Filed: Nov. 29, 2016
(86) PCT No.: PCT/JP2016/085256

§ 371 Date: Sep. 29, 2017

(30) Foreign Application Priority Data
Dec. 3, 2015 (JP) 2015-236660
Feb. 16, 2016 (JP) 2016-026874
Apr. 4, 2016 (JP) 2016-075305
Sep. 9, 2016 (JP) 2016-176860
Sep. 9, 2016 (JP) 2016-176861
Sep. 9, 2016 (JP) 2016-176862

(51) Int. Cl. H02K 1/14; H02K 21/22; H02K 15/02; H02K 3/52

(52) U.S. Cl. CPC H02K 1/145; H02K 1/146; H02K 3/525; H02K 15/022; H02K 21/22

(57) ABSTRACT

A motor comprises an A-phase stator unit, a B-phase stator unit, and a rotor. The phase stator unit and the B-phase stator unit respectively contain a coil unit and a pair of stator cores, each pair of stator cores having a plurality of claw-shaped magnetic poles. The rotor comprises at least two permanent magnets facing the claw-shaped magnetic poles of the A-phase stator unit and the claw-shaped magnetic poles of the B-phase stator unit, respectively. The A-phase stator unit and the B-phase stator unit are provided side by side in the axial direction, displaced from one another by a prescribed electrical angle. The two permanent magnets are arranged side by side in the axial direction, displaced from one another by a prescribed electrical angle. The direction of displacement between the A-phase stator unit and the B-phase stator unit is the opposite of the direction of displacement between the two permanent magnets.

### TECHNICAL FIELD

The present invention relates to a motor and a method for manufacturing a stator.

### BACKGROUND ART

A rotor used in a moter may be a permanent field Lundell construction rotor that includes two rotor cores and a field magnet (for example, refer to patent document 1). Each of the two rotor cores includes a plurality of claw poles arranged in the circumferential direction. The two rotor cores are coupled to each other. The field magnet is located between the two rotor cores so that the claw poles of the two rotor cores alternately function as different magnetic poles. In such a Lundell construction rotor, to change the number of poles in the rotor, the number of claw poles may be changed without changing the structure of the field magnet. Thus, the Lundell construction rotor allows the number of poles to be easily changed.

### PRIOR ART DOCUMENT

### Patent Document

Patent Document 1: Japanese Unexamined Utility Model Publication No. 5-43749

### SUMMARY OF THE INVENTION

### Problems that are to be Solved by the Invention

However, in a motor having the above rotor, when changing the number of poles (slots) in the stator in accordance with a change in the number of poles in the rotor, for example, there is a need to change the winding mode of the coil in addition to the shape (e.g., number of teeth) of the stator core. Therefore, in a motor that includes a Lundell construction rotor, it is desirable that the motor have a structure that allows the number of poles to be easily changed in the stator in addition to the rotor while generating a high output.

It is an object of the present invention to provide a motor that allows the number of poles to be easily changed while generating a high output and a method for manufacturing a stator core and a rotor core of the motor.

### Means for Solving the Problem

To achieve the above object, one aspect of the present invention is a motor that includes an A-phase stator unit, a B-phase stator unit, and a rotor. The A-phase stator unit includes two stator cores, each of which includes a plurality of claw poles arranged at equal angular intervals, and a coil located between the stator cores. The B-phase stator unit includes two stator cores, each of which includes a plurality of claw poles arranged at equal angular intervals, and a coil located between the stator cores. The rotor includes at least two permanent magnets respectively opposed to the claw poles of the A-phase stator unit and the claw poles of the B-phase stator unit. The A-phase stator unit and the B-phase stator unit are arranged next to each other in an axial direction and shifted from each other by a predetermined electrical angle. The two permanent magnets are arranged next to each other in the axial direction and shifted from each other by a predetermined electrical angle. A direction in which the A-phase stator unit and the B-phase stator unit are shifted from each other is opposite to a direction in which the two permanent magnets are shifted from each other.

Japanese Laid-Open Patent Publication No. 2007-181303 describes a prior art example of a motor that includes a Lundell construction stator and a rotor including a permanent magnet, which is opposed to the stator in the radial direction and functions as magnetic poles. The Lundell construction stator includes two annular stator cores having a plurality of claw poles arranged in the circumferential direction. The claw poles of the two stator cores are coupled so as to be alternately arranged in the circumferential direction. A coil is located between the two stator cores in the axial direction so that the claw poles of the two stator cores function as different magnetic poles.

In a motor such as that described above, it is desirable that cogging torque be reduced to reduce vibration.

Japanese Laid-Open Patent Publication No. 2013-158072 describes a prior art example of a motor that includes a stator, which includes a plurality of stator units arranged next to one another at intervals of a predetermined electrical angle in the axial direction, and a rotor, which includes a permanent magnet opposed to the stator in the radial direction and functioning as magnetic poles. Each of the stator units includes two annular stator cores having a plurality of claw poles arranged in the circumferential direction. The claw poles of the two stator cores are coupled so as to be alternately arranged in the circumferential direction. A coil is located between the two stator cores in the axial direction so that the claw poles of the two stator cores function as different magnetic poles.

In a motor such as that described above, it is desirable that thrust force be reduced to reduce vibration.

Additionally, in the stator of Japanese Laid-Open Patent Publication No. 2007-181303, each stator core includes a core back portion. The core back portion is located, for example, on a portion of the stator core at a side opposite to the claw poles of the stator core in the radial direction and extends in the same direction as the claw poles. The arrangement of the core back, portion on the stator core inhibits magnetic saturation.

In a stator such as that described above, although the arrangement of the core back portion inhibits magnetic saturation of a core member (stator core), components of the core member (stator core) including the claw poles are complex.

Additionally, a Lundell construction stator such as that described in Japanese Laid-Open Patent Publication No. 2007-181303 needs to be positioned relative to a housing in the radial direction so that the positional relationship of the stator and the rotor is determined.

Additionally, a known Lundell construction stator includes two annular stator cores, which have a plurality of claw poles arranged in the circumferential direction, and a coil, which is located between the two stator cores in the axial direction. The claw poles of the two stator cores are arranged so as to be alternately arranged in the circumferential direction. Further, a known Lundell-type motor includes such a Lundell-type stator and a rotor including a permanent magnet opposed to the claw poles of the Lundell-type stator in the radial direction. Japanese Laid-open Patent Publication No. 2003-71984 discloses an example of a stator and motor having claw poles (claw poles).

In a motor such as that described in Japanese Laid-Open Patent Publication No. 2009-71984, it is desirable that cogging torque be reduced to reduce vibration.

Additionally, for example, the Lundell-type stator described in Japanese Laid-open Patent Publication No. 2013-158072 is supported by a support member located at a side of the stator in the axial direction. The surface of the support member opposed to the stator supports electric components such as a conduction member connected to an end (drawn out wire) of the coil of the stator and a print board.

In a motor such as that described in Japanese Laid-Open Patent Publication No. 2013-158072, the electric component connected to the wire drawn out of the coil of the stator is located between the support member and the stator. This hinders the coupling when the wire drawn out of the coil is connected to the electric component.

### BRIEF DESCRIPTION OF THE DRAWINGS

FIG. 1 is a perspective cross-sectional view showing a first embodiment of a motor according to the present invention.

FIG. 2 is an exploded perspective view showing the motor of FIG. 1.

FIG. 3 is an exploded perspective view showing the stator of FIG. 1.

FIGS. 4A and 4B are diagrams showing the positional relationship between the stator and the rotor of FIG. 1.

FIGS. 5A and 5B are diagrams showing the positional relationship between a stator and a rotor of a comparative example of the first embodiment.

FIG. 6A is a graph showing the cogging torques of the first embodiment and the comparative example, and FIG. 6B is a graph showing the magnitude of the cogging torque of each order component.

FIG. 7A is a plan view showing a stator of a further example of the first embodiment and FIG. 7B is a cross-sectional view taken along line X-X in FIG. 7A.

FIG. 8 is an exploded perspective view showing the stator of FIGS. 7A and 7B.

FIG. 9A is a partially exploded perspective view showing the stator of FIG. 8, and FIGS. 9B and 9C are perspective views showing the stator of FIG. 9.

FIG. 10A is a perspective view showing a stator of a further example of the first embodiment, and FIG. 10B is a cross-sectional view of FIG. 10A.

FIG. 11 is a perspective cross-sectional view showing a second embodiment of a motor according to the present invention.

FIG. 12 is an exploded perspective view showing the motor of FIG. 11.

FIG. 13 is an exploded perspective view showing the stator of FIG. 11.

FIGS. 14A and 14B are diagrams showing the positional relationship between the stator and the rotor of FIG. 11.

FIGS. 15A and 15B are diagrams showing thrust force generated in the motor of FIG. 11.

FIG. 16 is a graph showing the thrust forces of the motor of FIG. 11 and a first comparative example.

FIG. 17 is a graph showing the relationship between the magnetic pole property rate and the thrust force of the motor of FIG. 11.

FIG. 18 is a perspective cross-sectional view showing a motor of a reference embodiment of the second embodiment.

FIG. 19 is an exploded perspective view showing the motor of FIG. 18.

FIG. 20A is an exploded perspective view of the stator of FIG. 18, and FIG. 20B is a partially enlarged view of FIG. 20A.

FIG. 21 is a diagram showing thrust force generated in the motor of FIG. 18.

FIGS. 22A and 22B are diagrams showing the positional relationship between the stator and the rotor of FIG. 18.

FIG. 23 is a graph showing the thrust forces of the motor of FIG. 18 and a second comparative example.

FIGS. 24A and 24B are enlarged perspective views showing stator cores of further examples of the second embodiment.

FIGS. 25A and 25B are perspective views showing stators of further examples of the second embodiment.

FIG. 26 is a cross-sectional view showing a third embodiment of a motor according to the present invention.

FIG. 27 is an exploded perspective view showing the motor of FIG. 26.

FIG. 28 is an exploded perspective view showing the stator of FIG. 26.

FIG. 29 is a perspective cross-sectional view showing the stator of FIG. 26.

FIG. 30 is a cross-sectional view showing a fourth embodiment of a motor according to the present invention.

FIG. 31 is an exploded perspective view showing the motor of FIG. 30.

FIG. 32A is a front view showing the stator core of FIG. 30, and FIG. 32B is a rear view showing the stator core of FIG. 30.

FIG. 33 is a perspective cross-sectional view showing the stator of FIG. 30.

FIG. 34 is a perspective cross-sectional view showing the structure for drawing out a coil in a modified example of the fourth embodiment.

FIG. 35 is a perspective cross-sectional view showing a stator of a modified example of the fourth embodiment.

FIG. 36 is a front view showing a stator core of a modified example of the fourth embodiment.

FIG. 37 is a cross-sectional view showing the stator core of FIG. 36.

FIG. 38 is a cross-sectional view showing a stator core of a modified example of the fourth embodiment.

FIG. 39 is a cross-sectional view showing a stator of a modified example of the fourth embodiment.

FIG. 40 is a perspective cross-sectional view showing a fifth embodiment of a motor according to the present invention.

FIG. 41 is an exploded perspective view showing the motor of FIG. 40.

FIG. 42 is an exploded perspective view showing the stator of FIG. 40.

FIG. 43A is a top view showing the stator of FIG. 40, FIG. 43B is a side view showing the stator of FIG. 43A, and FIG. 43C is an enlarged view showing the stator of FIG. 43A.

FIGS. 44A and 44B are diagrams showing the positional relationship between the stator and the rotor of FIG. 40.

FIG. 45 is a graph showing the cogging torques of the fifth embodiment and a comparative example.

FIG. 46 is a graph showing the relationship between the dimension of salient poles of an auxiliary pole member and the cogging torque in a sixth embodiment according to the present invention.

FIG. 47 is a graph showing the relationship between the dimension of salient poles of the auxiliary pole member and the cogging torque of a fourth-order component in the sixth embodiment according to the present invention.

FIG. 48 is a perspective view showing an auxiliary pole member of the sixth embodiment according to the present invention.

FIG. 49 is a graph showing the cogging torques of a sixth embodiment, the fifth embodiment, and a comparative example.

FIG. 50 is a graph showing the magnitudes of the cogging torques of each order component of the sixth embodiment and the comparative example.

FIG. 51 is a cross-sectional view of a seventh embodiment according to the present invention.

FIG. 52 is an exploded perspective view showing the motor of FIG. 51.

FIG. 53 is an exploded perspective view showing the stator of FIG. 51.

FIGS. 54A and 54B are diagrams showing the positional relationship between the stator and the rotor of FIG. 51.

FIG. 55 is a plan view showing the circuit board of FIG. 51.

FIG. 56 is a diagram showing the positions of Hall sensors in the motor of FIG. 51.

FIG. 57 is a cross-sectional view of a rotor of a modified example of the seventh embodiment in a direction orthogonal to the axis.

FIG. 58A is a cross-sectional view taken along line 8a-8a in FIG. 57, and FIG. 58B is a cross-sectional view taken along line 8b-8b in FIG. 57.

### EMBODIMENTS OF THE INVENTION

A first embodiment of a motor will now be described below.

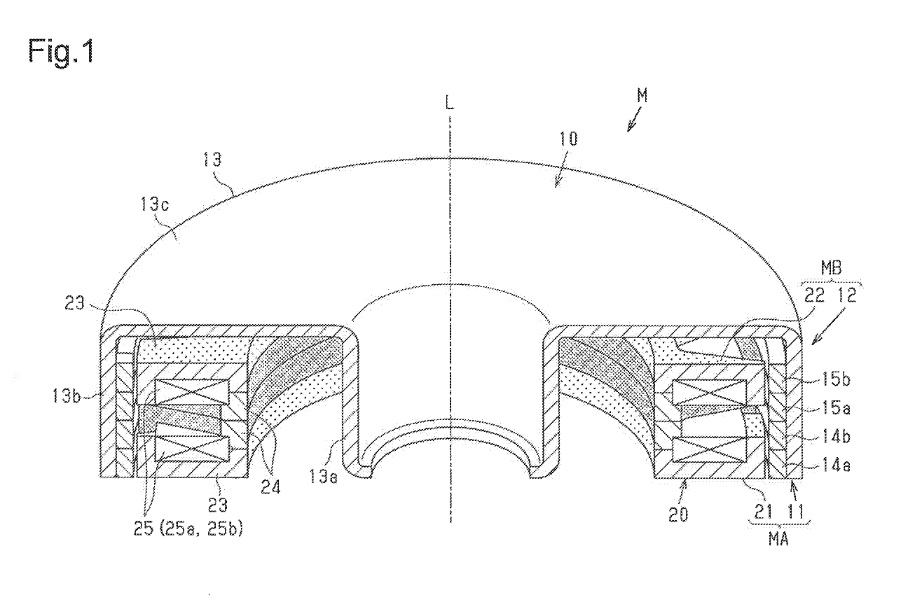

As shown in FIG. 1, the present embodiment of a motor M is a brushless motor and includes a rotor 10, which is rotationally supported by a support shaft of a housing (not shown), and a stator 20, which is fixed to the housing.

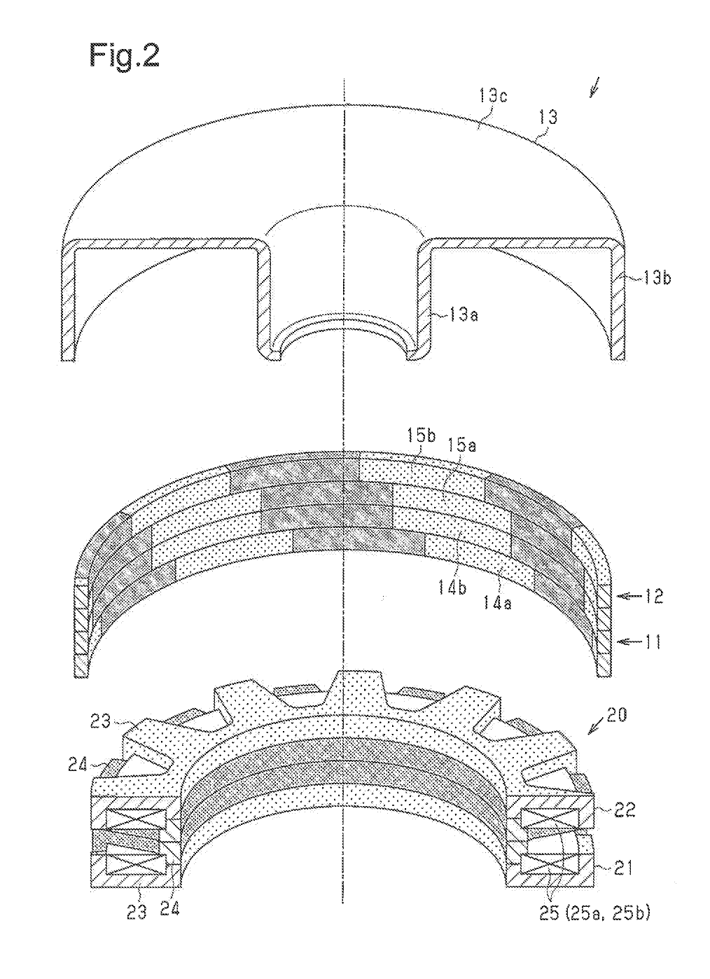

As shown in FIGS. 1 and 2, the rotor 10 includes two-phase rotor units, namely, an A-phase rotor unit 11 and a B-phase rotor unit 12. To obtain the rotor units, the rotor 10 includes a rotor core 13, which is formed by a magnetic element, and four magnets (A-phase first magnet 14a, A-phase second magnet 14b, B-phase first magnet 15a, and B-phase second magnet 15b) fixed to the rotor core 13.

The rotor core 13 includes a cylindrical inner cube 13a, the center of which conforms to an axis L of the rotor 10, a cylindrical outer tube 13b, the center of which conforms to the axis L and located at a circumferentially outer side of the inner tube 13a, and an upper wall end 13c, which connects an axial end (upper end) of the inner tube 13a and an axial end (upper end) of the outer tube 13b. The upper wall end 13c is flat and annular in a direction orthogonal to the axis L. In the rotor core 13, the inner surface of the inner tube 13a is supported by a bearing (not shown) onto the support shaft, which is described above and not shown in the drawings.

The A-phase first magnet 14a, the A-phase second magnet 14b, the B-phase first magnet 15a, and the B-phase second magnet 15b are sequentially arranged on the inner surface of the outer tube 13b from the open end of the rotor core 13 toward the upper wall end 13c in the axial direction. The A-phase first and second magnets 14a, 14b have the same dimension in the axial direction and are located at positions opposing to an A-phase stator unit 21, which will be described later, in the radial direction to form the A-phase rotor unit 11. In the same manner, the B-phase first and second magnets 15a, 15b have the same dimension, which is also same as the dimension of the A-phase first and second magnets 14a, 14b, in the axial direction and are located at positions opposed to a B-phase stator unit 22, which will be described later, in the radial direction to form the B-phase rotor unit 12. The magnets 14a, 14b, 15a, 15b are magnetized in the radial direction so that north poles and south poles are alternately arranged at equal intervals in the circumferential direction. Additionally, the number of poles in each of the magnets 14a, 14b, 15a, 15b is the same. The rotor 10 of the present embodiment has twelve poles (six pole pairs).

The stator 20 includes annular stator units 21, 22. In the present embodiment, the stator unit 21 is used for the A-phase and supplied with A-phase drive current. The stator unit 22 is used for the B-phase and supplied with B-phase drive current.

The stator units 21, 22, which have the same structure and the same shape, are arranged next to each other in the axial direction. The A-phase stator unit 21 is located proximate to the open end (lower side) of the rotor core 13 in the axial direction. The B-phase stator unit 22 is located proximate to the upper wall end 13c (upper side) in the axial direction. The structure for supporting the stator units 21, 22 is such that the A-phase stator unit 21 is supported by the housing, which is described above and not shown in the drawings, and the B-phase stator unit 22 is supported by the A-phase stator unit 21.

In the motor M having the above structure, as shown in FIG. 1, the A-phase stator unit 21 and the A-phase rotor unit 11, which is located at a circumferentially outer side of the A-phase stator unit 21 and includes the A-phase first and second magnets 14a, 14b, form an A-phase motor unit MA. In the same manner, the B-phase stator unit 22 and the B-phase rotor unit 12, which is located at a circumferentially outer side of the B-phase stator unit 22 and includes the B-phase first and second magnets 15a, 15b, form a B-phase motor unit MB.

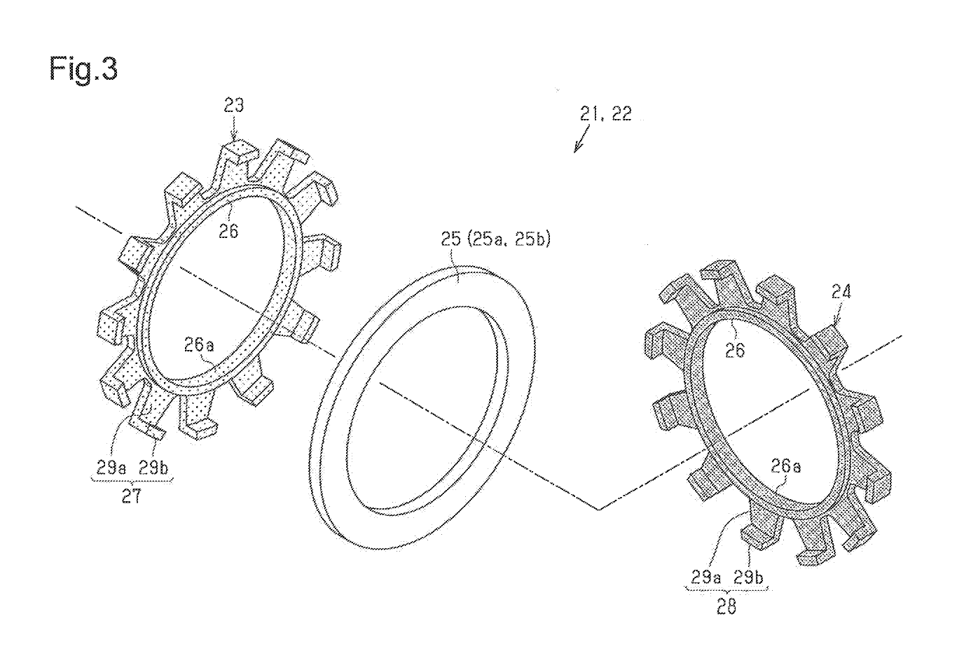

As shown in FIG. 3, each of the A-phase and B-phase stator units 21, 22 includes two stator cores (first stator core 23 and second stator core 24), which have the same structure, and a coil 25, which is located between the two stator cores 23, 24.

The stator cores 23, 24 each include a tube 26 and a plurality (twelve in present embodiment) of claw poles 27, 28 extending circumferentially outward from the tube 26. The claw poles of the first stator core 23 are referred to as first claw poles 27. The claw poles of the second stator core 24 are referred to as second claw poles 28. The claw poles 27, 28 have the same shape. The first claw poles 27 are arranged at equal intervals (thirty-degree intervals) in the circumferential direction. The second claw poles 28 are also arranged at equal intervals (thirty-degree intervals) in the circumferential direction.

Each of the claw poles 27, 28, which extend radially outward from the tube 26, is perpendicularly bent and directed in the axial direction. In each of the claw poles 27, 28, the portion extending radially outward from the tube 26 is referred to as a radial extension 29a, and the distal portion bent in the axial direction is referred to as a pole portion 29b. The radial extension 29a has a dimension in the circumferential direction that narrows toward the circumferentially outer side. The pole portion 29b has an outer circumferential surface (radially outer surface) that is arcuate about the axis L.

The stator cores 23, 24, which include the claw poles 27, 28 having the perpendicular shape, may be formed by bending a plate or performing die casting. Alternatively, the stator cores 23, 24 may be formed by mixing magnetic powder such as iron powder with an insulator such as a resin and performing heat press-molding on the mixture in a mold.

The first and second stator cores 23, 24 having the above structure are coupled so that the first and second claw poles 27, 28 (pole portions 29b) are opposed to each other in the axial direction (refer to FIG. 3). In this coupling state, the pole portions 29b of the first claw poles 27 and the pole portions 29b of the second claw poles 28 are alternately arranged in equal intervals in the circumferential direction. More specifically, the stator 20 of the present embodiment has twenty-four poles. The first and second stator cores 23, 24 are fixed to each other with the tubes 26 in contact with each other in the axial direction.

In this coupling state, the coil 25 is located between the first and second stator cores 23, 24 in the axial direction. The coil 25 includes a winding 25a, which is annularly wound in the circumferential direction of the stator 20, and an insulative resin bobbin 25b, which is located between the winding 25a and the first and second stator cores 23, 24. The coil 25 is located between the radial extension 29a of each of the first claw poles 27 and the radial extension 29a of each of the second claw poles 28 in the axial direction and between the tube 26 of each of the stator cores 23, 24 and the pole portions 29b of the claw poles 27, 28 in the radial direction.

The A-phase and B-phase stator units 21, 22, which are configured as described above, each have the so-called Lundell construction. More specifically, the A-phase and B-phase stator units 21, 22 each have a twelve-pole Lundell construction that excites the first and second claw poles 27, 28 into different magnetic poles whenever current is supplied to the winding 25a of the coil 25 located between the first and second stator cores 23, 24.

A comparative example of a motor M1, which is the subject of the comparison with the motor M of the above embodiment, will now be described.

The motor M1 of the comparative example includes a rotor 50, which is shown by the schematic structure in FIG. 5A, and a stator 60, which is shown by the schematic structure in FIG. 5B. The stator 60 includes two-phase Lundell construction stators, namely, an A-phase stator unit 61 and a B-phase stator unit 62. The stator units 61, 62 of the comparative example have the same structure as the stator units 21, 22 of the above embodiment and thus will not be described in detail.

The rotor 50 of the comparative example includes an A-phase rotor unit 51 and a B-phase rotor unit 52, which are paired with the A-phase stator unit 61 and the B-phase stator unit 62 in the same manner as the rotor 10 of the above embodiment. However, the rotor 50 of the comparative example differs from the rotor 10 of the above embodiment in the arrangement of magnets in the rotor units 51, 52. More specifically, in the rotor 50 of the comparative example, the A-phase rotor unit 51, which is opposed to the A-phase stator unit 61, includes one A-phase magnet 53 in the axial direction, and the B-phase rotor unit 52, which is opposed to the B-phase stator unit 62, includes one B-phase magnet 54 in the axial direction. Thus, while the rotor units 11, 12 of the rotor 10 in the above embodiment each include two of the magnets 14a, 14b, 15a, 15b in the axial direction, the rotor units 51, 52 of the rotor 50 in the comparative example each include one of the magnets 53, 54 in the axial direction.

Additionally, in the motor M1 of the comparative example, in the stator 60, the A-phase stator unit 61 is shifted from the B-phase stator unit 62 by an electrical angle θ1 (forty-five degrees in present embodiment) in the clockwise direction. In the rotor 50, the A-phase rotor unit 51 is shifted from the B-phase rotor unit 52 by an electrical angle 92 (forty-five degrees in present embodiment) in the counterclockwise direction. Thus, in the motor M1 of the comparative example, the phase difference between the A-phase motor unit and the B-phase motor unit is set to ninety degrees. The second order components of cogging torques of the two-phase motor have opposite phases in the same waveform. Thus, the second order components cancel out each other and have a small value. The structure of the motor M1 of the comparative example effectively decreases the cogging torque.

As compared to the motor M1 of the comparative example, the motor M of the present embodiment has a structure that further effectively decreases the cogging torque.

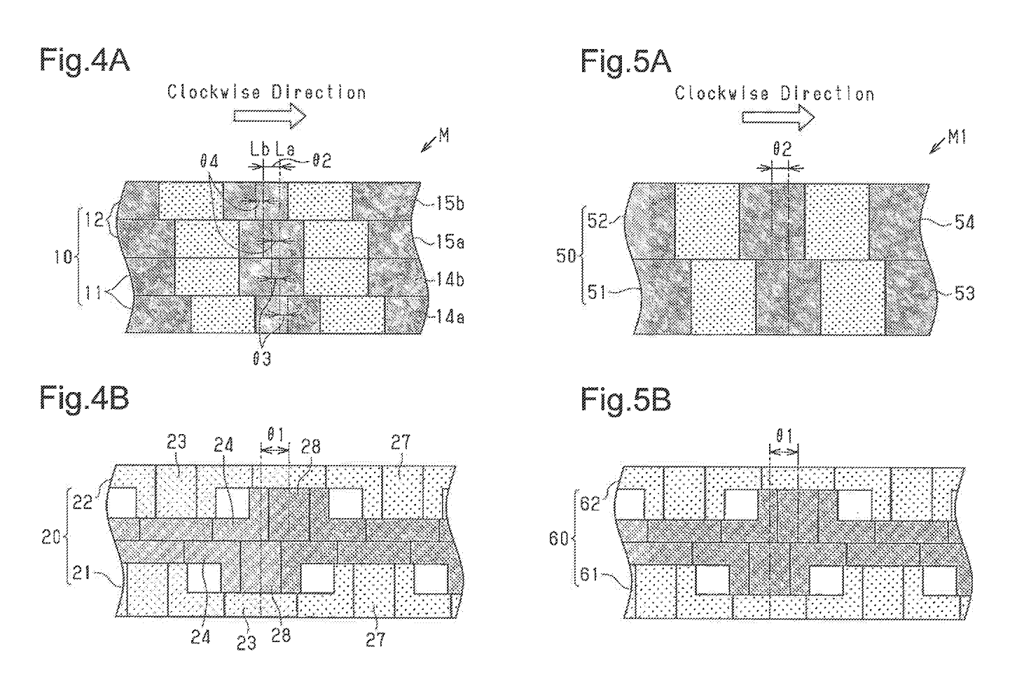

More specifically, as shown in FIG. 4B, the A-phase and B-phase stator units 21, 22 of the stator 2 0 are shifted from each other in the same manner as the stator units 61, 62 of the stator 60 of the comparative example. That is, the first and second claw poles 27, 28 of the B-phase stator unit 22 are shifted from the first and second claw poles 27, 28 of the A-phase stator unit 21 by the electrical angle θ1 (forty-five degrees in present embodiment) in the clockwise direction.

However, as shown in FIG. 4A, in the rotor 10 of the present embodiment, the A-phase and B-phase rotor units 11, 12 respectively include the A-phase first and second magnets 14a, 14b and the B-phase first and second magnets 15a, 15b. More specifically, each phase includes two magnets that are separated in the axial direction. The B-phase rotor unit 12 is shifted from the A-phase rotor unit 11 by the electrical angle 62 (forty-five degrees in present embodiment) in the counterclockwise direction. In other words, the rotor units 11, 12 of the two phases have reference positions La, Lb that are shifted from each other by the electrical angle θ2.

The A-phase rotor unit 11 is arranged so that the A-phase first magnet 14a is shifted from the reference position La by an electrical angle θ3 (22.5 degrees in present embodiment) in the clockwise direction, and the A-phase second magnet 14b is shifted from the reference position La by the electrical angle θ3 in the counterclockwise direction. The B-phase rotor unit 12 is arranged so that the B-phase first magnet 15a is shifted from the reference position Lb by an electrical angle θ4 (22.5 degrees in present embodiment) in the clockwise direction, and the B-phase second magnet 15b is shifted from the reference position Lb by the electrical angle θ4 in the counterclockwise direction. The A-phase second magnet 14b and the B-phase first magnet 15a, which are adjacent to each other, are aligned with each other in the circumferential direction due to the shifting directions and the shifting angles.

In the motor M of the present embodiment, which includes the A-phase and B-phase rotor units 11, 12 having the above structure and the stator units 21, 22 described above, the phase difference between the A-phase motor unit MA and the B-phase motor unit MB is also set to ninety degrees. The A-phase drive current is supplied to the winding 25a of the coil 25 of the A-phase stator unit 21. The B-phase drive current is supplied to the winding 25a of the coil 25 of the B-phase stator unit 22. The A-phase drive current and the B-phase drive current are each alternating current. The phase difference between the A-phase drive current and the B-phase drive current is set to ninety degrees in the present embodiment. Thus, rotational torque is generated due to the relationship between the stator units 21, 22 and the magnets 14a, 14b, 15a, 15b and rotates the rotor 10.

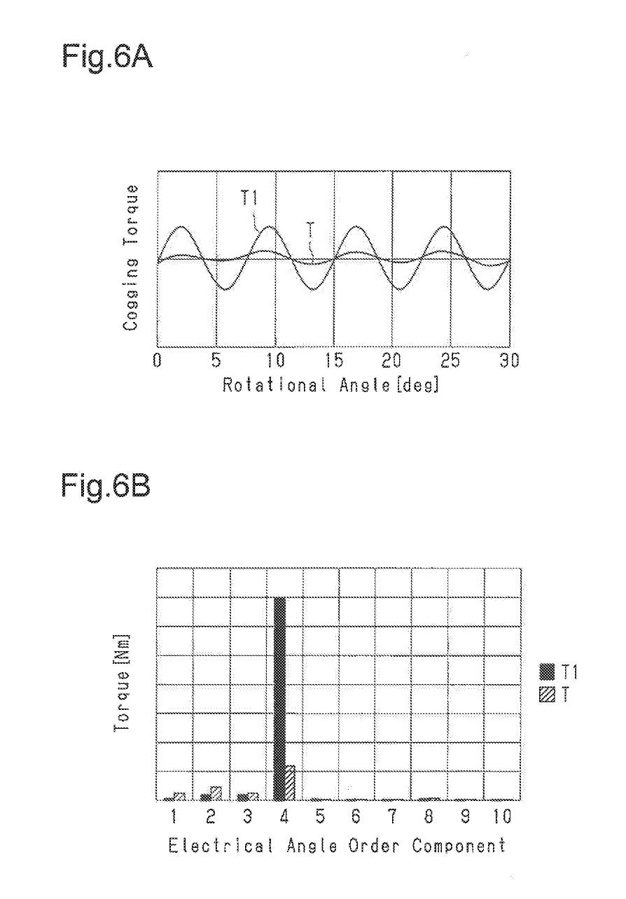

As shown in FIG. 6A, as compared to cogging torque T1 of the motor M1 of the comparative example, cogging torque T of the motor M of the present embodiment is further reduced. This is because the A-phase first and second magnets 14a, 14b of the embodiment are located at different angles and the B-phase first and second magnets 15a, 15b are located at different angles. This produces the so-called skew effect, which moderates changes in the magnetic field of each phase. Additionally, FIG. 6B indicates that in particular, the fourth order component of the cogging torque T of the motor M of the present embodiment is effectively reduced among the high order components as compared to the cogging torque T1 of the motor M1 of the comparative example. Thus, the motor M of the present embodiment has a structure that produces effects for reducing the cogging torque T.

The first embodiment has the advantages described below.

(1) The A-phase rotor unit 11, which is opposed to the A-phase stator unit 21, includes the two A-phase first and second magnets 14a, 14b that are separated in the axial direction and located at different angles. Also, the B-phase rotor unit 12, which is opposed to the B-phase stator unit 22, includes the two B-phase first and second magnets 15a, 15b that are separated in the axial direction and located at different angles. Thus, changes in the magnetic field of each phase become moderate. This reduces the cogging torques of the A-phase and B-phase motor units MA, MB and ultimately the cogging torque T of the motor M. In the present embodiment, in particular, the fourth order component of the cogging torque T is effectively reduced.

(2) The magnets 14a, 14b, 15a, 15b of the two phases have the same dimension in the axial direction. This balances the A-phase and B-phase motor units MA, MB in a favorable manner. Ultimately, the motor M obtains a favorable magnetic balance.

(3) The A-phase rotor unit 11 and the B-phase rotor unit 12 include the reference positions La, Lb, respectively. The reference position La of the A-phase rotor unit 11 and the reference position Lb of the B-phase rotor unit 12 are shifted from each other by an electrical angle (forty-five degrees in present embodiment) that is equal to the angle by which the A-phase stator unit 21 and the B-phase stator unit 22 are separated (forty-five degrees in present embodiment). The direction in which the reference position Lb of the B-phase rotor unit 12 is shifted from the reference position La of the A-phase rotor unit 11 is opposite to the direction in which the B-phase stator unit 22 is shifted from the A-phase stator unit 21. The two permanent magnets 14a, 14b of the A-phase rotor unit 11 are shifted from the reference position La of the A-phase rotor unit 11 toward opposite sides of the reference position La by one-half of the electrical angle (forty-five degrees in present embodiment). The two permanent magnets 15a, 15b of the B-phase rotor unit 12 are shifted from the reference position Lb of the B-phase rotor unit 12 toward opposite sides of the reference position Lb by one-half of the electrical angle (forty-five degrees in present embodiment). Thus, changes in the magnetic field of the magnets 14a, 14b, 15a, 15b of each phase including the reference positions La, Lb (appropriate positions) become moderate. This ensures the reduction in the cogging torques of the A-phase and B-phase motor units MA, MB and ultimately the cogging torque T of the motor M.

The first embodiment may be modified as follows.

In the above embodiment, the present invention is applied to the motor M of an outer rotor type. Instead, the present invention may be applied to an inner rotor type motor.

In the above embodiment, the magnets 14a, 14b, 15a, 15b of the rotor 10 have twelve poles (six pole pairs). The claw poles 27, 28 of the stator 20 have twenty-four poles. However, the number of poles is not limited to those described above.

The A-phase and B-phase rotor units 11, 12 of the above embodiment respectively include the two magnets 14a, 14b and the two magnets 15a, 15b, which are divided in the axial direction. Instead, each phase may include three magnets or more. Additionally, the number of divided magnets in one phase may differ from that in the other phase. In the A-phase and B-phase rotor units 11, 12, the magnets 14a, 14b, 15a, 15b may be divided and arranged over the rotor units of the two phases. The magnets 14a, 14b, 15a, 15b have the same dimension in the axial direction. Instead, the magnets 14a, 14b, 15a, 15b may have different dimensions in the axial direction.

Although not particularly described, the magnets 14a, 14b, 15a, 15b of the above embodiment may each include a plurality of magnets divided into each magnetic pole or each pair of magnetic poles or a single tubular magnet. Additionally, the magnets 14a, 14b, 15a, 15b may be coupled to the rotor core 13. Alternatively, the magnets 14a, 14b, 15a, 15b may be integrally formed with the rotor core 13. Further, the magnets 14a, 14b, 15a, 15b may be formed by an integral magnet from the positional relationship between the A-phase second magnet 14b and the B-phase first magnet 15a.

In the above embodiment, the electrical angles θ1, θ2 are set to forty-five degrees, and the electrical angles θ3, θ4 are set to 22.5 degrees. However, the angles are not limited to those described above.

The stator 20 of the above embodiment may be changed to the structure described below.

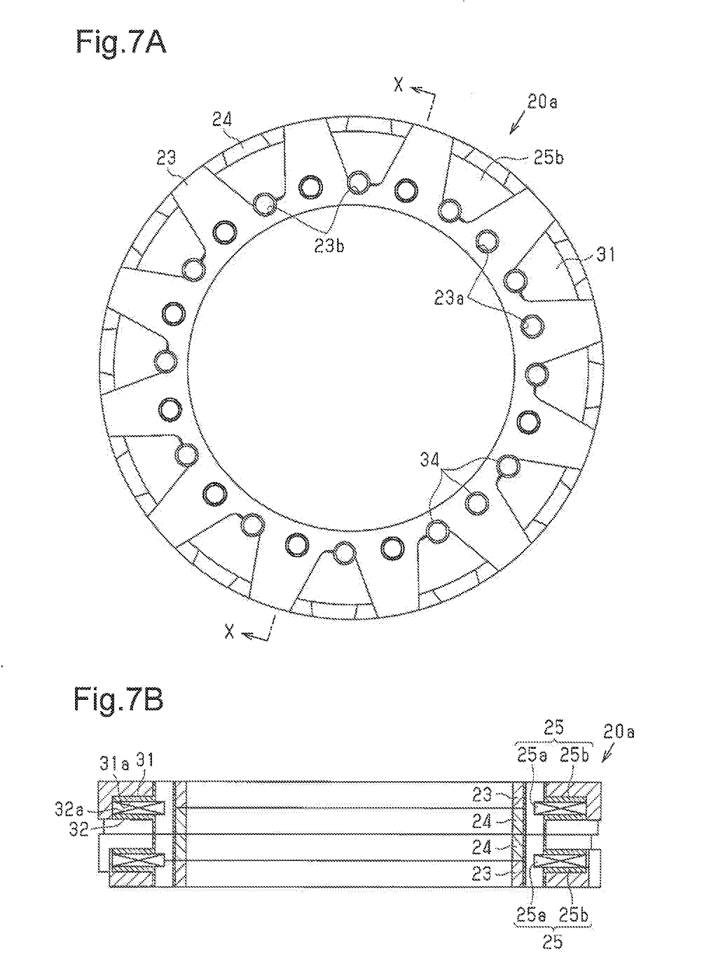

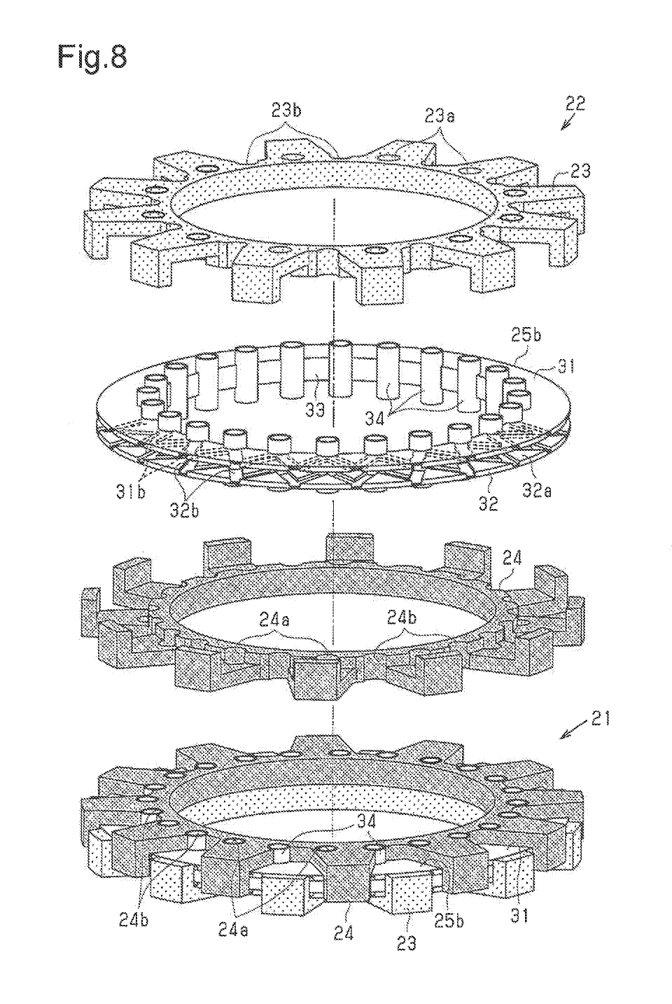

For example, FIGS. 7A, 7B, and 8 show a stator 20a that improves the cooling properties. The bobbin 25b of the coil 25 is formed from a resin and annular so that the cross section in the axial direction is C-shaped and open at the radially outer side. The bobbin 25b includes an upper wall 31, a lower wall 32, and a radially inner wall 33, which are C-shaped. The upper wall 31 and the lower wall 32 respectively include inner surfaces 31a, 32a located at the side contacting the winding 25a. The inner surfaces 31a, 32a include grooves 31b, 32b, each of which extends in the circumferential direction linearly zigzagging between the radially outer edge and the radially inner edge. Preferably, the term “C-shaped” refers to the shape in which the upper wall 31 is orthogonal to the radially inner wall 33 and the lower wall 32 is orthogonal to the radially inner wall 33. The radially inner wall 33 includes a plurality of tubes 34 extending in the axial direction and arranged at equal intervals in the circumferential direction. Each of the tubes 34 includes an axially intermediate portion, which is in communication with the grooves 31b, 32b extending in the inner surfaces 31a, 32a of the upper and lower walls 31, 32.

The tubes 34 project upward from the upper wall 31 and downward from the lower wall 32. Accordingly, the first and second stator cores 23, 24 respectively include fitting holes 23a, 24a and fitting recesses 23b, 24b, which are fitted to the projections of the tubes 34. The bobbin 25b and the first and second stator cores 23, 24 are used in each of the A-phase and B-phase stator units 21, 22. The tubes 34 of the bobbins 25b are arranged so that the circumferential positions are aligned with each other between the phases and so that the inner spaces of the tubes 34 that are continuous in the axial direction are in communication with each other in the axial direction.

Heat generated, for example, by the energizing of the winding 25a is discharged toward the radially outer side through the grooves 31b, 32b or moved toward the radially outer side through the grooves 31b, 32b and then discharged through the tubes 34 in the axial direction. This effectively discharges the generated heat and cools the stator 20a. Only one of the set of the tubes 34 and the set of the grooves 31b, 32b may be used.

When ends of the tubes 34 are fitted to the fitting holes 23a, 24a and the fitting recesses 23b, 24b of the stator cores 23, 24, the bobbin 25b (coil 25) is positioned relative to the stator cores 23, 24. This increases the fixing power of the bobbin 25b. The inner spaces of the tubes 34 may be used as passages through which the wire end (not shown) of the winding 25a is drawn out.

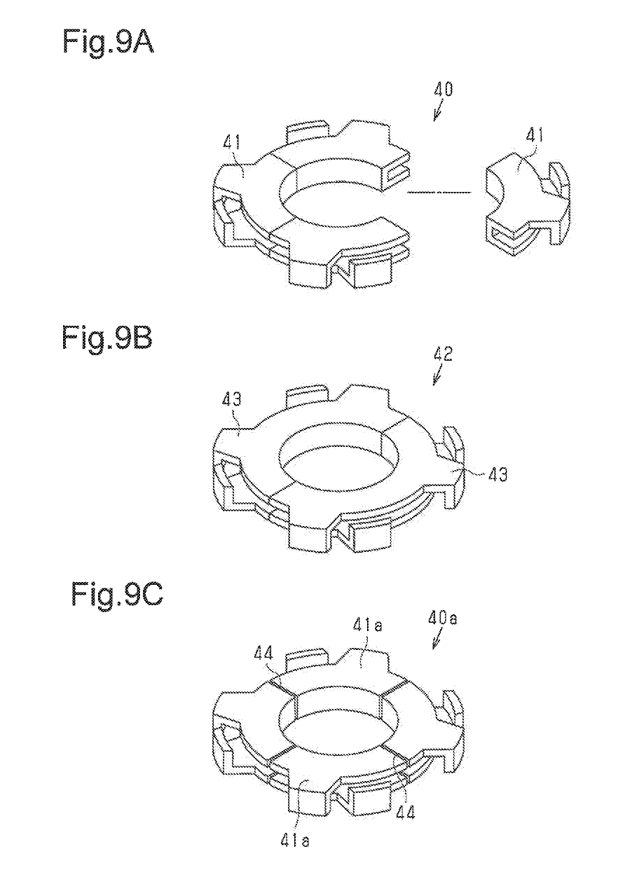

As shown in FIGS. 9A and 9B, stator cores 40, 42 that are divided in the circumferential direction may be used instead of the stator cores 23, 24 of the above embodiment that are divided at upper and lower sides. The stator core 40 shown in FIG. 9A is divided into four in the circumferential direction. The stator core 42 shown in FIG. 9B is divided into two in the circumferential direction. The stator cores 40, 42 include core components 41, 43, each of which has parts having different magnetic poles and connected together by a radially inner wall in the axial direction. The core components 41, 43 may each be formed by a magnetic powder core. In this case, each of the core components 41, 43 is small. This allows for miniaturization of a press machine and may reduce the manufacturing costs.

As shown in FIG. 9C, a stator core 40a may include core components 41a that are separated by gaps 44 in the circumferential direction. In this case, the gaps 44 allow the wire end of a winding (not shown) to be easily drawn out. Additionally, the winding can be cooled by the air passing through the gaps 44. Also, in the stator cores 23, 24 of the above embodiment, each of which is continuous in the circumferential direction, outer surfaces of the stator cores 23, 24 may include, for example, grooves that radially extend and allow the air to pass to improve the cooling properties.

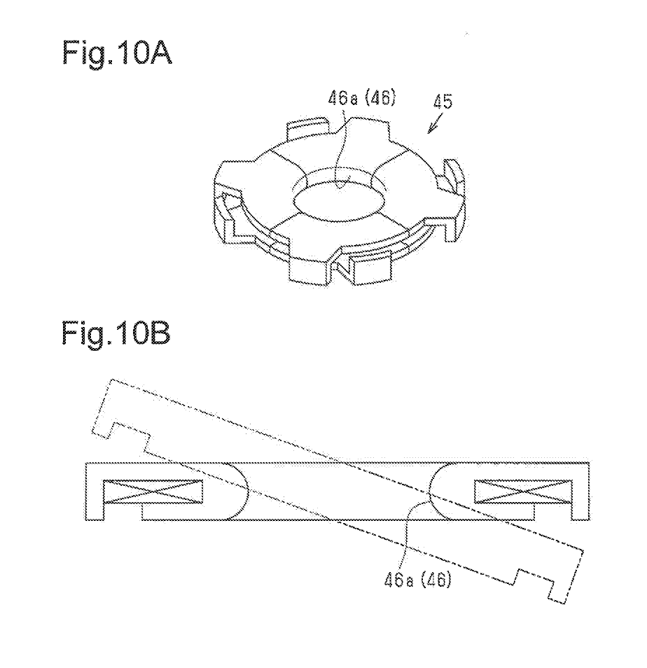

In the above embodiment, the tubes 26 of the stator cores 23, 24 each include an inner surface 26a that linearly extends in the axial direction. Instead, as shown in FIGS. 10A and 10B, a stator core 45 may include an arcuate inner surface 46a defining a central through hole 46 so that an axially central portion of the inner surface 46a is budged radially inward. In this case, when coupling the stator core, the arcuate inner surface 46a easily adjusts the inclination of the stator core. In this case, the magnets of the rotor may be appropriately opposed to the stator core. This may increase the amount of effective magnetic flux and reduce thrust force.

Technical concepts that can be acknowledged from the above embodiment and the modified examples are as follows.

(A) The stator includes a discharge passage that discharges heat generated in the winding out of the stator.

(B) The stator core includes a plurality of core components divided in the circumferential direction.

(C) The inner surface of the stator core is arcuate so that the axially central portion of the inner surface is bulged radially inward.

A second embodiment of a motor will now be described. For the sake of brevity, the same reference characters are given to elements that are the same as the corresponding elements of the motor M of the first embodiment. Such elements will not be described in detail.

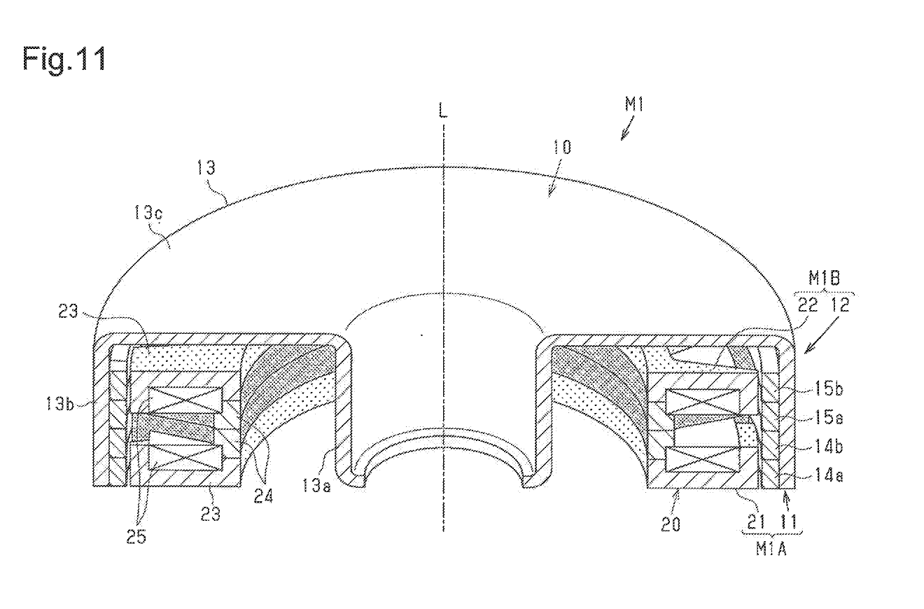

FIG. 11 shows the present embodiment of the motor M1 in which the A-phase first magnet 14a and the B-phase second magnet 15b, which are located outward in the axial direction, have magnetic properties that differ from those of the A-phase second magnet 14b and the B-phase first magnet 15a, which are located inward in the axial direction. The A-phase first magnet 14a and the B-phase second magnet 15b, which are located outward in the axial direction, have strong magnetic force relative to the A-phase second magnet 14b and the B-phase first magnet 15a, which are located inward in the axial direction. In other words, the A-phase second magnet 14b and the B-phase first magnet 15a, which are located, inward in the axial direction, have magnetic properties such that the magnetic force is weak relative to the A-phase first magnet 14a and the B-phase second magnet 15b, which are located outward in the axial direction. For example, when it is assumed that the magnetic property (magnetic force) of the A-phase first magnet 14a and the B-phase second magnet 15b, which are located outward in the axial direction, is 100%, the magnetic property (magnetic force) of the A-phase second magnet 14b and the B-phase first magnet 15a, which are located inward in the axial direction, is set to 80%.

In the same manner as the first embodiment, the stator cores 23, 24 may be formed by bending a plate or performing die casting. Alternatively, the stator cores 23, 24 may be formed by mixing magnetic powder such as iron powder with an insulator such as a resin and performing heat press-molding on the mixture in a mold. In this case, the degree of freedom for designing each of the stator cores 23, 24 is increased, and the manufacturing process is significantly simplified. The limit amount of eddy current may be easily adjusted by adjusting the mixture ratio of the magnetic powder and the insulator.

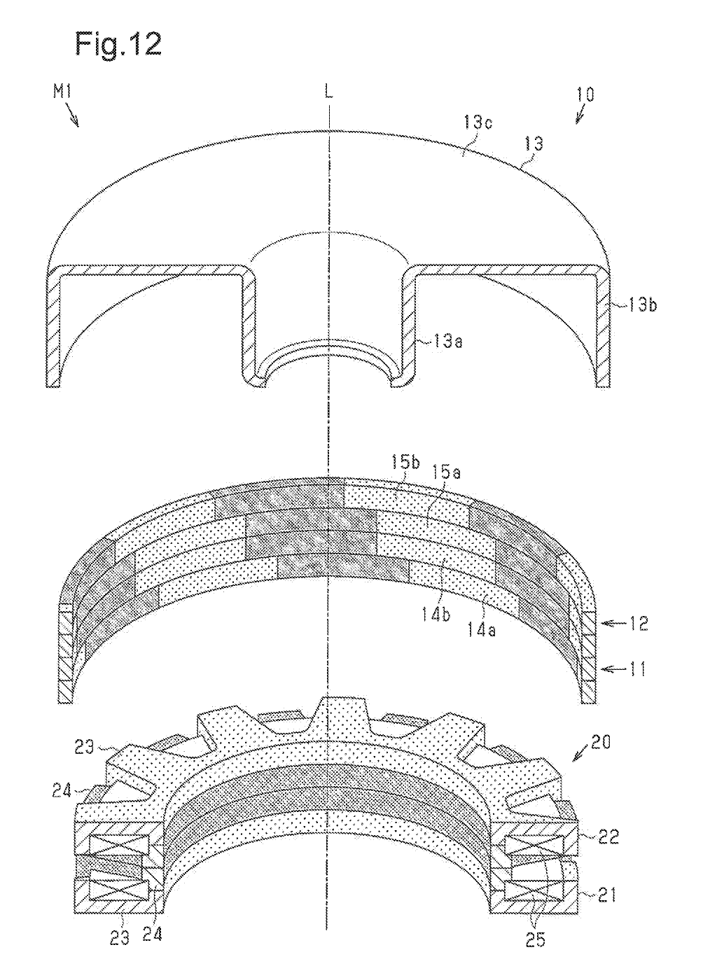

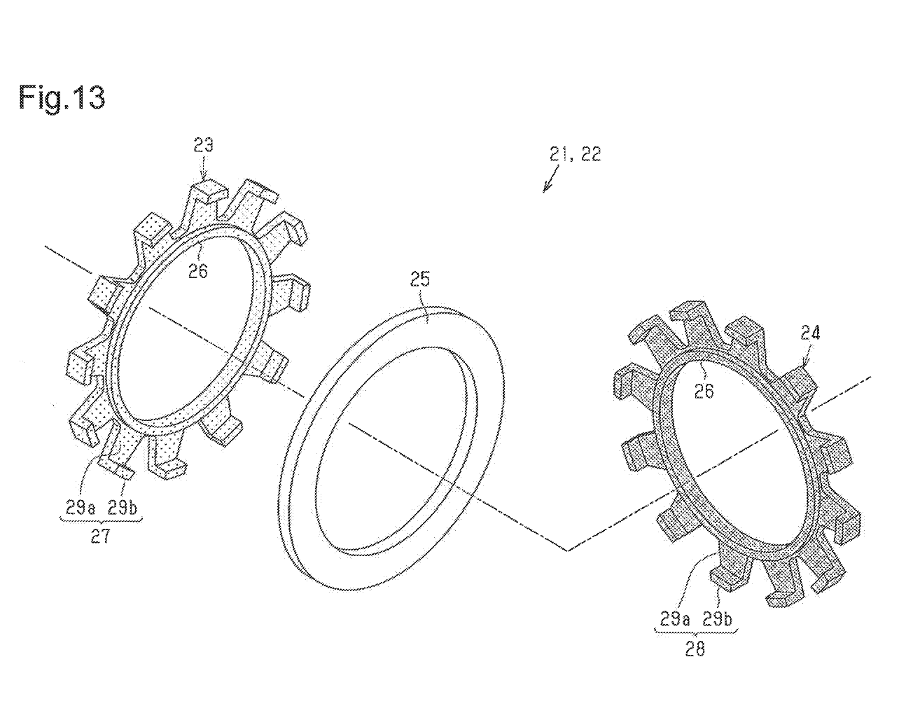

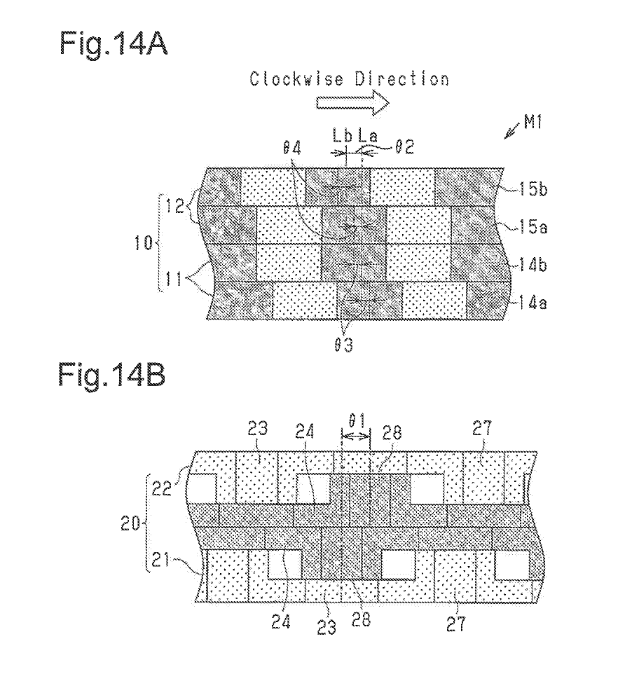

As shown in FIGS. 11 and 12, the A-phase and B-phase stator units 21, 22 are arranged so that the second stator cores 24 are opposed to each other in the axial direction. The A-phase stator unit 21 is located proximate to the open end (lower side) of the rotor core 13 in the axial direction. The B-phase stator unit 22 is located proximate to the upper wall end 13c (upper side) in the axial direction. Thus, the first stator core 23 of the A-phase stator unit 21, the second stator core 24 of the A-phase stator unit 21, the second stator core 24 of the B-phase stator unit 22, and the first stator core 23 of the B-phase stator unit 22 are sequentially arranged in the axial direction from the open end of the rotor core 13 toward the upper wall end 13c.

The positional relationship of the rotor 10 and the stator 20 is such that in the A-phase stator unit 21, the pole portions 29b of the first claw poles 27 of the first stator core 23 are opposed to the entire A-phase first magnet 14a and one-half of the A-phase second magnet 14b of the A-phase rotor unit 11 with respect to the axial direction. Additionally, in the A-phase stator unit 21, the pole portions 29b of the second claw poles 28 of the second stator core 24 are opposed to the entire A-phase second magnet 14b and one-half of the A-phase first magnet 14a of the A-phase rotor unit 11 with respect to the axial direction. Also, in the B-phase stator unit 22, the pole portions 29b of the second claw poles 28 of the second stator core 24 are opposed to the entire B-phase first magnet 15a and one-half of the B-phase second magnet 15b of the B-phase rotor unit 12 with respect to the axial direction. Additionally, in the B-phase stator unit 22, the pole portions 29b of the first claw poles 27 of the first stator core 23 are opposed to the entire B-phase second magnet 15b and one-half of the B-phase first magnet 15a of the B-phase rotor unit 12 with respect to the axial direction.

The motor M1 of the second embodiment has the circumferential positional relationship of the A-phase stator unit 21 and the B-phase stator unit 22 and the circumferential positional relationship of the A-phase rotor unit 11 and the B-phase rotor unit 12 that are the same as those of the motor M1 of the first embodiment.

The claw poles 26 of the second stator core 24 of each of the stator units 21, 22 receive thrust force when the rotor 10 is driven and rotated. The thrust force, for example, causes the motor to vibrate. Thus, it is desirable that the thrust force be reduced.

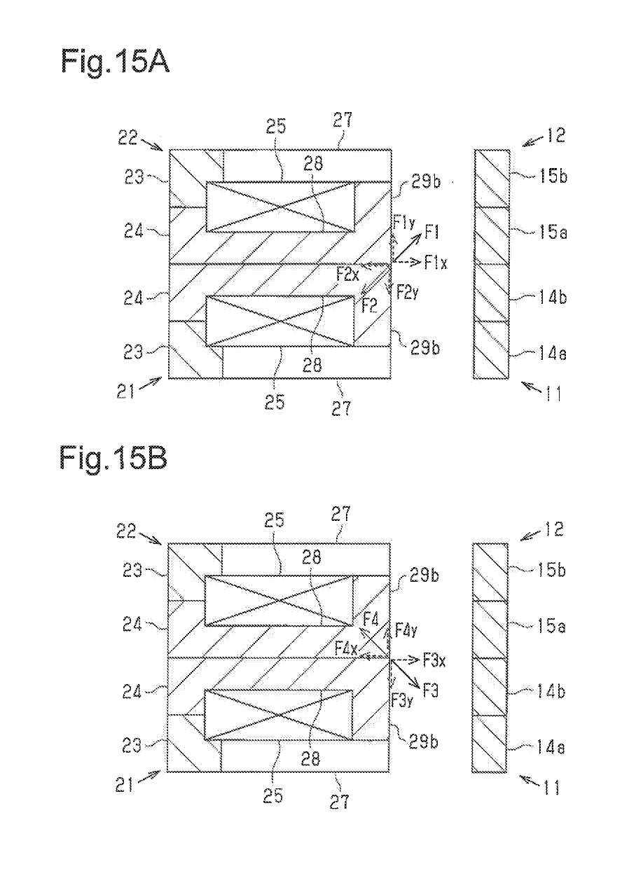

More specifically, as shown in FIG. 15A, the claw pole 28 of the stator core 24 of the A-phase stator unit 21 receives attraction force F1 from the B-phase first and second magnets 15a, 15b, which are adjacent to the magnets 14a, 14b, in addition to the A-phase first and second magnets 14a, 14b, which are opposed in the radial direction. The attraction force F1 may be divided into a radial component F1x and an axial component F1y. The stator core 24 of the A-phase stator unit 21 receives the axial component. F1y, which functions as thrust force upwardly directed in the axial direction. When the claw pole 28 of the stator core 24 of the A-phase stator unit 21 receives repulsion force F2 from the B-phase first and second magnets 15a, 15b, the repulsion force F2 is divided into a radial component F2x and an axial component F2y in the same manner. The stator core 24 of the A-phase stator unit 21 receives the axial component F2y, which functions as thrust force downwardly directed in the axial direction.

Also, as shown in FIG. 15B, the claw pole 28 of the stator core 24 of the B-phase stator unit 22 receives attraction force F3 from the A-phase first and second magnets 14a, 14b in addition to the B-phase first and second magnets 15a, 15b, which are opposed in the radial direction. The attraction force F3 may be divided into a radial component F3x and an axial component F3y. The stator core 24 of the B-phase stator unit 22 receives the axial component. F3y, which functions as thrust force downwardly directed in the axial direction. When the claw pole 28 of the stator core 24 of the B-phase stator unit 22 receives repulsion force F4 from the A-phase first and second magnets 14a, 14b, the repulsion force F4 is divided into a radial component F4x and an axial component F4y in the same manner. The stator core 24 of the B-phase stator unit 22 receives the axial component F4y, which functions as thrust force upwardly directed in the axial direction.

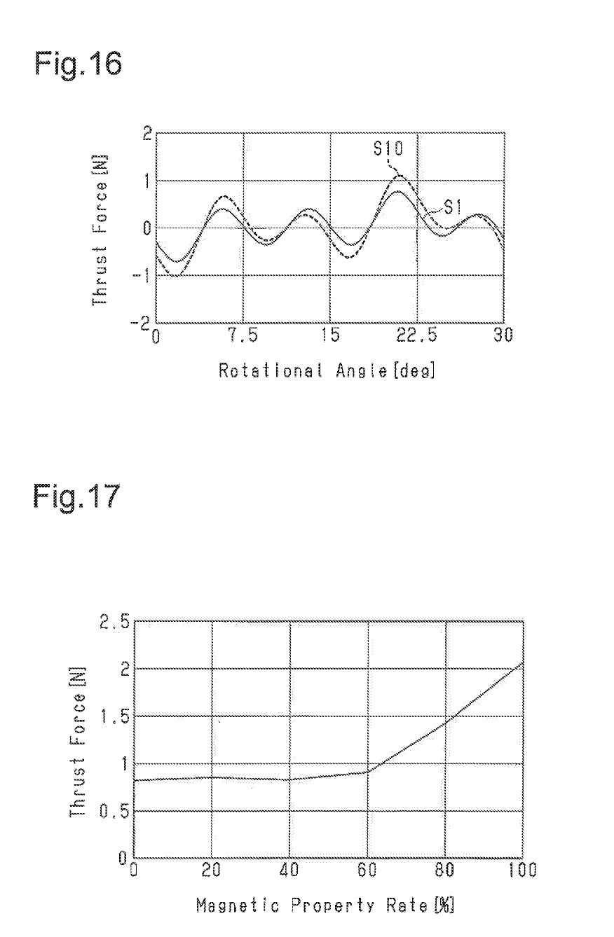

A first comparative example of a motor (M10) (not shown) relative to the motor M1 of the present embodiment will now be descried. The motor (M10) of the first comparative example has substantially the same structure as the motor M1 of the present embodiment. However, in the motor (M10) of the first comparative example, the A-phase first magnet, the A-phase second magnet, the B-phase first magnet, and the B-phase second magnet are set to have the same magnetic force. Thus, the effect of the magnetic for is easily received by different phases. As shown in FIG. 16, thrust force S10 of the motor (M10) of the first comparative example is relatively large.

However, as shown in FIG. 16, thrust force S1 of the motor M1 of the present embodiment is reduced to be less than the thrust force S10 of the motor (M10) of the first comparative example.

More specifically, in the motor M1 of the present embodiment, the magnetic force of the B-phase first magnet 15a, which is located proximate to the A-phase stator unit 21 and greatly affects the A-phase stator unit 21, is set to be weak relative to the magnetic force of the B-phase second magnet 15b. This reduces the attraction force F1 and the repulsion force F2. Accordingly, the thrust forces corresponding to the axial components F1y, F2y are reduced. In the same manner, the magnetic force of the A-phase second magnet 14b, which is located proximate to the B-phase stator unit 22 and greatly affects the B-phase stator unit 22, is set to be weak relative to the magnetic force of the A-phase first magnet 14a. This reduce the attraction force F3 and the repulsion force F4. Accordingly, the thrust forces corresponding to the axial components F3y, F4y are reduced.

FIG. 17 shows thrust force when the magnetic property rate is changed. As shown in FIG. 17, when the magnetic property rate (rate at which magnetic force is reduced) is in a range from 100% to 60%, the thrust force is reduced as the magnetic property rate becomes smaller. When the magnetic property rate is in a range of less than 60%, changes in the reduction amount of the thrust force are small even when the magnetic property rate is decreased. As the magnetic property rate becomes smaller, the output of the motor M1 is reduced. Thus, to reduce the thrust force while maintaining the output of the motor M1, it is preferred that the magnetic property rate be set within a range of 60% or greater to less than 100%.

The second embodiment has the advantages described below.

(4) Portions of the permanent magnets opposed to a part proximate to the boundary of the A-phase and B-phase stator units 21, 22 in the axial direction of the stator 20 (axial directions of A-phase stator unit 21 and B-phase stator unit 22), that is, axially inner portions of the permanent magnets, namely, the A-phase second magnet 14b and the B-phase first magnet 15a, have a large magnetic effect on the stator units 21, 22 of the phases that are arranged beside each other in the axial direction. In this regard, in the present embodiment, the magnetic forces of the A-phase second magnet 14b and the B-phase first magnet 15a, which correspond to the axially inner portions of the permanent magnets, are set to be weak relative to the magnetic forces of the A-phase first magnet 14a and the B phase second magnet 15b, which correspond to axially outer portions. This limits the attraction forces F1, F3 and the repulsion forces F2, F4 that obliquely applied to the stator units 21, 22 of the different phases. Thus, the axial components F1y, F2y, F3y, F4y, that is, the thrust forces, are reduced. This reduces vibration of the motor M1,

(5) The relatively weak magnetic forces of the A-phase second magnet 14b and the B-phase first magnet 15a are set to 80%, which is in the range of 60% or greater to less than 100% of the magnetic forces of the A-phase first magnet 14a and the B-phase second magnet 15b. Thus, the thrust forces are reduced while maintaining the output of the motor M1.

(6) The A-phase first magnet 14a, the A-phase second magnet 14b, the B-phase first magnet 15a, and the B-phase second magnet 15b are formed by separate magnets. Thus, the use of magnets having different magnetic forces easily realizes a mode in which the axially inner portions and the axially outer portions have different magnetic forces.

The second embodiment may be modified as follows.

In the above embodiment, the present invention is applied to the motor M1 of an outer rotor type. Instead, the present invention may be applied to an inner rotor type motor.

In the above embodiment, the magnetic forces of the A-phase second magnet 14b and the B-phase first magnet 15a are set to be weak relative to the magnetic forces of the A-phase first magnet 14a and the B-phase second magnet 15b. Instead, only one of the A-phase second magnet 14b and the B-phase first magnet 15a may be set to be relatively weak.

In the above embodiment, the magnetic property rate of the A-phase second magnet 14b and the B-phase first magnet 15a is set to be 80%. Instead, the magnetic property rate may be set to another value. In this case, it is preferred the setting be performed taking into consideration the output of the motor M1. For example, referring to FIG. 17, it is preferred that the magnetic property rate be set to 60% or greater and less than 100%.

In the above embodiment, the magnets 14a, 14b, 15a, 15b of the rotor 10 form a rotor having twelve poles (six pole pairs), and the claw poles 27, 28 of the stator 20 form a stator having twenty-four poles. However, the number of poles in each of the rotor and the stator is not limited to those described above.

In the above embodiment, the A-phase rotor unit 11 includes the magnets 14a, 14b, and the B-phase rotor unit 12 includes the magnets 15a, 15b. More specifically, each of the A phase and the B phase includes a magnet that is divided into two in the axial direction. Instead, each phase may include three magnets or more. Further, the number of separate magnets may differ between the A phase and the B phase. In the A-phase and B-phase rotor units 11, 12, the magnets 14a, 14b, 15a, 15b may be divided and arranged over the rotor units of the two phases. The magnets 14a, 14b, 15a, 15b have the same dimension in the axial direction. Instead, the magnets 14a, 14b, 15a, 15b may have different dimensions in the axial direction.

Although, not particularly described, the magnets 14a, 14b, 15a, 15b of the above embodiment may each include a plurality of magnets divided into each magnetic pole or each pair of magnetic poles or a single tubular magnet. Additionally, the magnets 14a, 14b, 15a, 15b may be coupled to the rotor core 13. Alternatively, the magnets 14a, 14b, 15a, 15b may be integrally formed with the rotor core 13. Further, the A-phase second magnet 14b and the B-phase first magnet 15a may be formed by an integral magnet.

### Reference Embodiment

A reference example of a motor M2 is a brushless motor and has the same structure as the motor M1 of the second embodiment. For the sake of brevity, the same reference characters are given to elements that are the same as the corresponding elements of the motor M of the first embodiment. Such elements will not be described in detail.

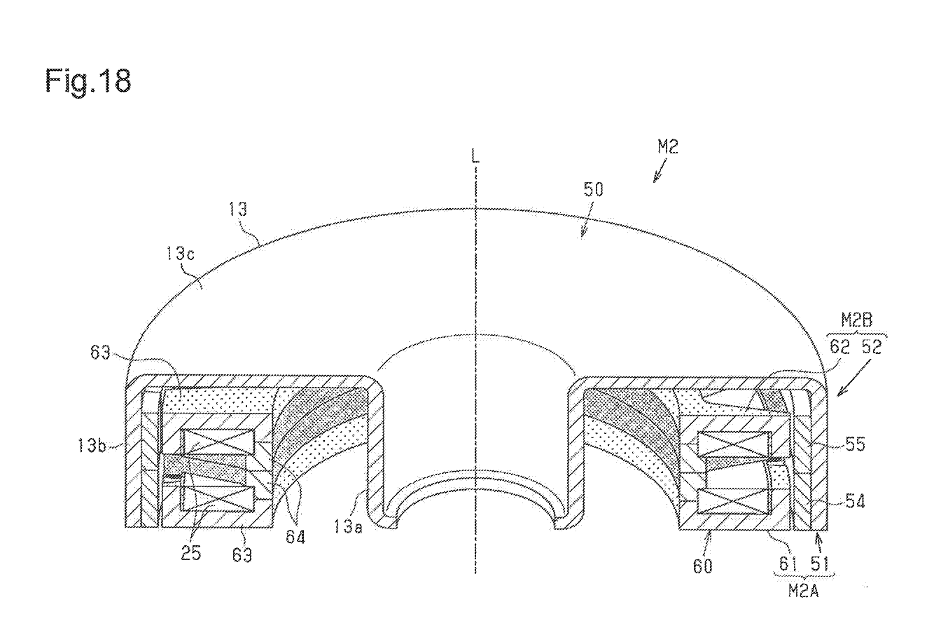

As shown in FIG. 18, the motor M2 of the reference embodiment includes the rotor 50 and the stator 60.

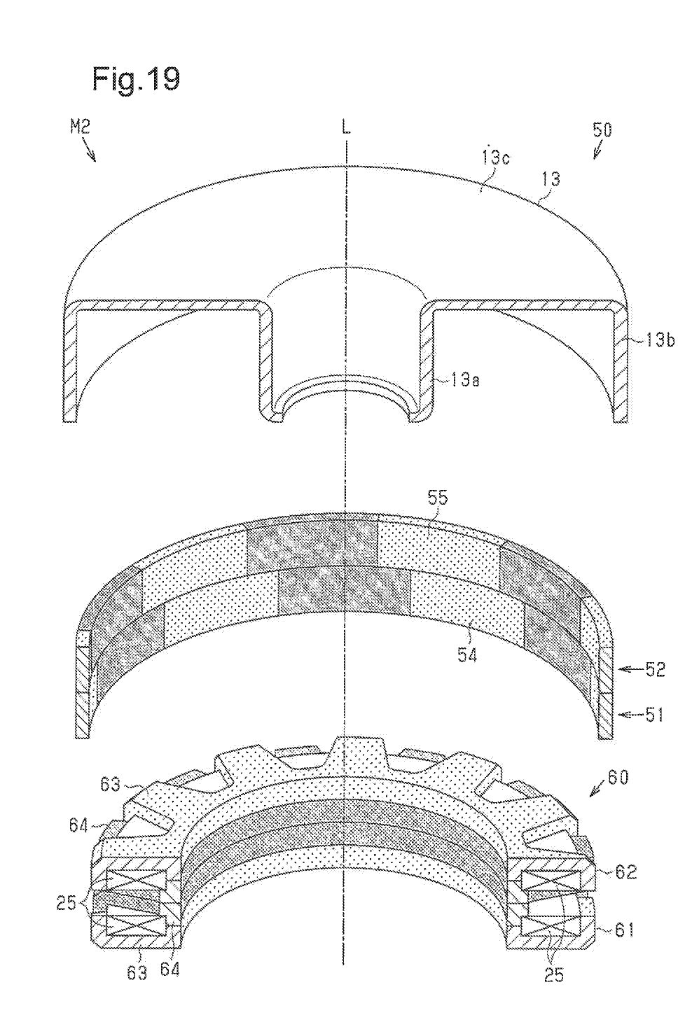

As shown in FIGS. 18 and 19, the rotor 50 includes two-phase rotor units, namely, the A-phase rotor unit 51 and the B-phase rotor unit 52. To obtain the rotor units, the rotor 50 includes the rotor core 13, which is formed by a magnetic element, and two magnets (A-phase magnet 54 and B-phase magnet 55) fixed to the rotor core 13.

The A-phase magnet 54 and the B-phase magnet 55 are sequentially arranged the inner circumferential surface of the outer tube 13b in the axial direction from the open end of the rotor core 13 toward the upper wall end 13c. The A-phase rotor unit 51 includes the A-phase magnet 54 located at a position opposing the A-phase stator unit 61, which will be described later, in the radial direction. In the same manner, the B-phase rotor unit 52 includes the B-phase magnet 55 located at a position opposing the B-phase stator unit 62, which will be described later, in the radial direction. The A-phase and B-phase magnets 54, 55 are magnetized in the radial direction so that north poles and south poles are alternately arranged at equal intervals in the circumferential direction. Additionally, the two phases have the same number of poles. The rotor 10 of the present embodiment has twelve poles (six pole pairs). The magnetic property (magnetic force) of the A-phase magnet 54 is the same as the magnetic property (magnetic force) of the B-phase magnet 55.

The stator 60 includes annular stator units 61, 62. In the present embodiment, the stator unit 61 is used for the A-phase and supplied with the A-phase drive current. The stator unit 62 is used for the B-phase and supplied with the B-phase drive current.

The stator units 61, 62, which have the same structure and the same shape, are arranged next to each other in the axial direction. The A-phase stator unit 61 is located proximate to the open end (lower side) of the rotor core 13 in the axial direction. The B-phase stator unit 62 is located proximate to the upper wall end 13c (upper side) in the axial direction.

In the motor M2 having the above structure, the A-phase stator unit 61 and the A-phase rotor unit 51, which is located at a circumferentially outer side of the A-phase stator unit 61 and includes the A-phase 54, form an A-phase motor unit M2A. In the same manner, the B-phase stator unit 62 and the B-phase rotor unit 52, which is located at a circumferentially outer side of the B-phase stator unit 62 and includes the B-phase magnet 55, form a B-phase motor unit M2B.

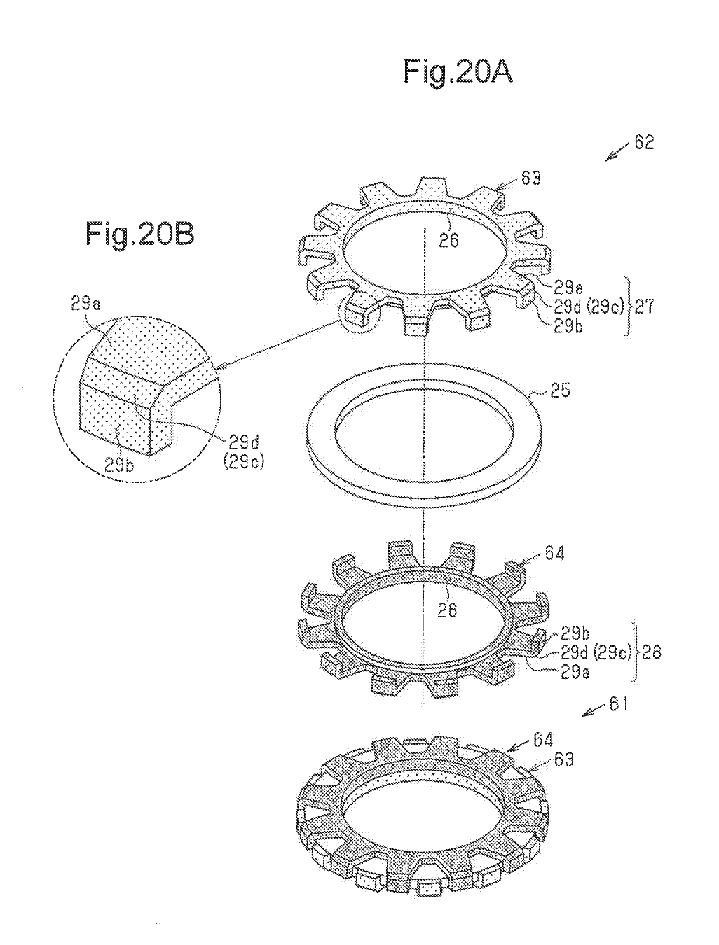

As shown in FIG. 20A, each of the A-phase and B-phase stator units 61, 62 includes two stator cores (first stator core 63 and second stator core 64), which have the same structure, and a coil 25, which is located between the two stator cores 63, 64.

In the same manner as the stator cores 23, 24 of the first and second embodiments, each of the stator cores 63, 64 includes the tube 26 and a plurality (twelve in present embodiment) of first and second claw poles 27, 28 extending circumferentially outward from a the tube 26. Each of the claw poles 27, 28 includes the radial extension 29a, which extends radially outward from the tube 26, and the pole portion 29b, which is a distal part bent in the axial direction.

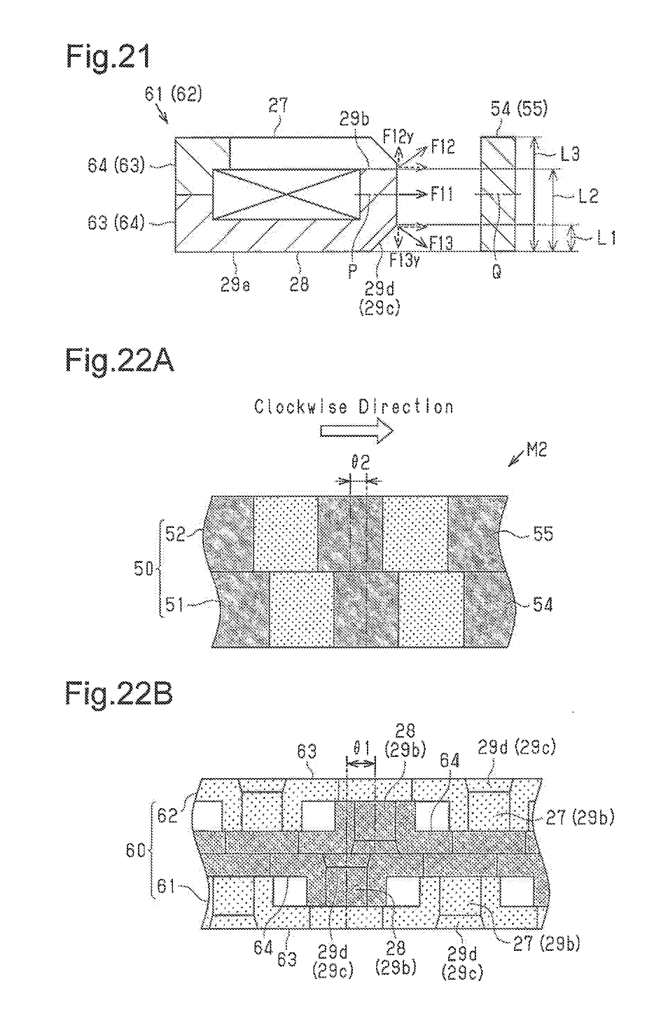

As shown in FIGS. 20B and 21, in the present embodiment, the radial extension 29a and the pole portion 29b include a boundary part 29c defining an inclined part 29d. The inclined part 29d of the present embodiment is formed by chamfering the bent corner of the boundary part 29c.

As shown in FIG. 21, the dimension of the inclined part 29d of the A-phase stator unit 61 (B-phase stator unit 62) in the axial direction is denoted by L1, and the dimension of the pole portion 29b from the base (outer side surface of radial extension 29a) to the distal surface is denoted by L2. The dimension the A-phase magnet 54 opposed to the A-phase stator unit 61 (B-phase magnet 55 opposed to B-phase stator unit 62) in the axial direction is denoted by L3. The dimension L1 of the inclined part 29d is set so that L1=L3−L2 is satisfied.

The positional relationship between the rotor 50 and the stator 60 will now be described.

As shown in 22A, in the rotor 50, the B-phase magnet 55 of the B-phase rotor unit 52 is shifted from the A-phase magnet 54 of the A-phase rotor unit 51 by the electrical angle θ1 (forty-five degrees in present embodiment) in the counterclockwise direction. As shown in FIG. 22B, in the stator 60, the first and second claw poles 27, 28 of the B-phase stator unit 62 are shifted from the first and second claw poles 27, 28 of the A-phase stator unit 61 by the electrical angle θ1 (forty-five degrees in present embodiment) in the clockwise direction. That is, in the motor M1 of the present embodiment, the phase difference between the A-phase motor unit M2A and the B-phase motor unit M2B is set to ninety degrees.

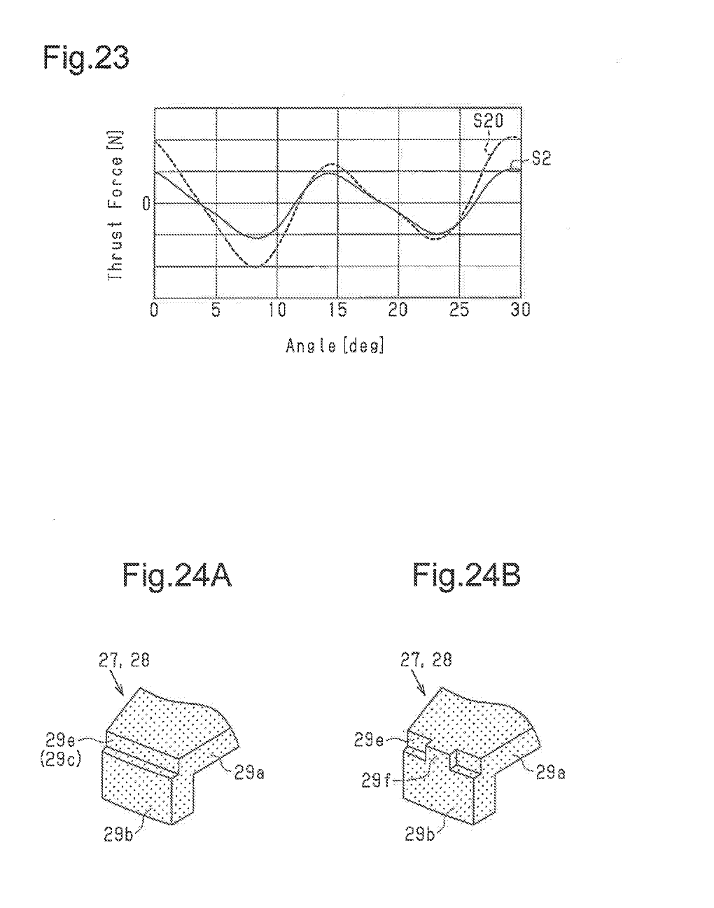

FIG. 23 shows thrust force S2 of the motor M2 of the present embodiment, which includes the inclined parts 23d, and thrust force S20 of a motor (M20) of a second comparative example (not shown), that is a motor (M20) that does not include the inclined parts 29d and includes cornered boundary parts 29c located between the radial extensions 29a and the pole portions 29b. The motor (M20) of the second comparative example easily receives the effect of magnetic forces acting between the different phases. Thus, the thrust force of the motor (M20) of the second comparative example is relatively large as indicated by the thrust force S20 in FIG. 23.

However, as shown in FIG. 23, the thrust force S2 of the motor M2 of the present embodiment is reduced to be less than the thrust force S20 of the motor (M20) of the second comparative example. This is understood that the balance of the axial components of the attraction force and the repulsion force received by the claw poles 27, 28 of the stator cores 63, 64 of the present embodiment is improved as compared to the second comparative example.

More specifically, as shown in FIG. 21, in the A-phase stator unit 61, the pole portion 29b of the first claw pole 27 of the stator core 63 receives attraction forces from the A-phase magnet 54 in three directions (attraction force F11 directed radially outward, attraction force F12 directed obliquely upward, and attraction force F13 directed obliquely downward). The obliquely downward attraction force F13 is generated when the first claw pole 27 includes the inclined, part 29d. The obliquely upward attraction force F12 has an axial component F12y, which is upwardly directed in the axial direction. The obliquely downward attraction force F13 has an axial component F13y, which is downwardly directed in the axial direction. Thus, the axial component F12y and the axial component F13y cancel out each other. This reduces the thrust forces received by the first claw pole 27 as a whole. Although not shown in the drawings, the claw poles 26 of the stator core 64 of the A-phase stator unit 61 and the claw poxes 27, 28 of the sensor cores 63, 64 of the B-phase stator unit 62 receive thrust forces that are reduced in the same manner as those received by the claw poles 27 of the stator core 63 of the A-phase stator unit 61. This also applies to the repulsion forces.

The dimension L1 of the inclined part 29d is set so that L1=L3−L2 is satisfied. Thus, a middle position of the pole portion 23b excluding the inclined part 23d in the axial direction is substantially aligned with a middle position Q of the A-phase magnet 54 in the axial direction. The axial component F12y of the obliquely upward attraction force F12 and the axial component F13y of the obliquely downward attraction force F13 have substantially the same value. When the axial component F12y and the axial component F13y cancel out each other, the remaining axial component is substantially zero. This effectively reduces the thrust forces.

The reference embodiment may be modified as follows.

In the above embodiment, the present invention is applied to the motor M2 of an outer rotor type. Instead, the present invention may be allied to an inner rotor type motor.

In the above embodiment, the magnets 54, 55 of the rotor 50 form a rotor having twelve poles (six pole pairs), and the claw poles 27, 28 of the stator 20 form a stator having twenty-four poles. However, the number of poles in each of the rotor and the stator is not limited to that described above.

In the above embodiment, the stator 60 is a two-phase stator including the A-phase stator unit 61 and the B-phase stator unit 62. Instead, the stator 60 may be a one-phase stator.

In the above embodiment, the stator cores 63, 64 of the stator units 61, 62 each include the inclined parts 23d. Instead, only one of the A-phase stator unit 61 and the B-phase stator unit 62 may include the inclined parts 29d.

In the above embodiment, the boundary parts 29c of the claw poles 27, 28 include the inclined parts 29d. However, as shown in FIG. 24A, the peripheral surface of the pole portion 29b may be recessed radially inward to form a recess 29e instead of the inclined parts 29d. Even in this case, the recess 29e functions in the same manner as the inclined part 29d and reduces the thrust forces.

The size, position, and length of the recess 29e may be changed. For example, as shown in FIG. 24B, the recess 29e may include a projection 29f (a portion that remains instead of being recessed) to adjust the thrust forces. The size and position of the projection 29f may be changed.

Each of the stator units 61, 62 of the above embodiment may include position restriction members 65, 66, which restrict the displacement of the first and second stator cores 63, 64 and are formed from an insulation material.

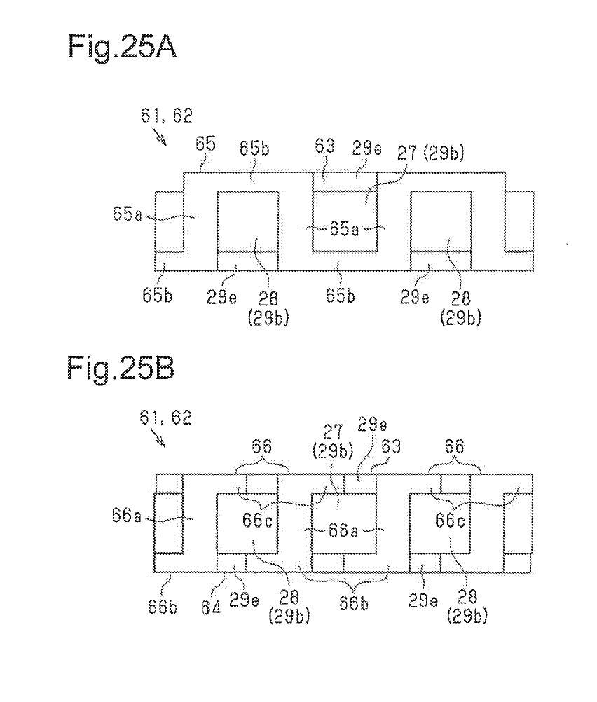

For example, FIG. 25A shows the stator units 61, 62 that include the annular position restriction member 65. The position restriction member 65 includes circumferential restriction portions 65a, which are arranged between each of the claw poles 27 and each of the claw poles 28 in the circumferential direction, and axial restriction portions 65b, which are alternately arranged on the distal end (axially distal end) of the pole portion 29b of each of the claw poles 27 and the distal end (axially distal end) of the pole portion 29b of each of the claw poles 28.

The circumferential restriction portions 65a restrict the displacement of the claw poles 27, 28 of the stator cores 63, 64 in the circumferential direction. The axial restriction portions 65b restrict the outward separation of the stator cores 63, 64 in the axial direction. This firmly couples the first and second stator cores 63, 64 to each other in each of the stator units 61, 62.

FIG. 25B shows another example of the stator units 61, 62 that include a plurality of position restriction members 65. Each of the position restriction members 66 includes circumferential restriction portions 66a, which are arranged between each of the claw poles 27 and each of the claw poles 28 in the circumferential direction. Each of the circumferential restriction portions 66a has one axial end including a first axial restriction part 66b, which extends toward one side in the circumferential direction. The other axial end of the circumferential restriction portion 66a includes a second axial restriction part 66c, which extends toward the other side in the circumferential direction. The length of each of the first and second axial restriction parts 65b, 66c is set to be approximately one-half of the dimension of each of the claw poles 27, 28 in the circumferential direction.

The circumferential restriction portions 66a restrict the displacement of the claw poles 27, 28 of the stator cores 63, 64 in the circumferential direction. The first axial restriction parts 66b and the second axial restriction parts 66c cooperate to restrict the separation of the stator cores 63, 64 from each other caused by the outward movement of the stator cores 63, 64 in the axial direction. This firmly coupes the first and second stator cores 63, 64 to each other in each of the stator units 61, 62.

Technical concepts that can be acknowledged from the second embodiment and the modified examples are as follows.

(D) A stator including a first stator core having a plurality of claw poles, a second stator core having a plurality of claw poles, and a coil located between the first stator core and the second stator core, wherein the claw poles of the first stator core and the claw poles of the second stator core each include a radial extension, which extends radially outward, and a pole portion, which corresponds to a distal end of the radial extension that is bent in an axial direction, and the radial extension and the pole portion include a boundary portion that includes an inclined surface or a recess.

In this structure, the boundary portion of the radial extension and the pole portion of each claw pole includes an inclined surface or a recess. When the stator, which includes the pole portions, and the rotor, which includes the permanent magnets opposed to the pole portions in the radial direction, are coupled together to obtain a motor, the axial components of attraction forces and repulsion forces received by the claw poles (pole portions) of the first and second stator cores from the permanent magnets of the rotor is balanced. Thus, the axial components of the attraction forces (also, repulsion forces) cancel out each other. This reduces the thrust forces.

(E) A motor including the stator according to concept (D) and a rotor including a permanent magnet opposed to the pole portions of the claw poles of the stator in the radial direction.

(F) The motor according to concept (E), wherein L1=L3−L2 is satisfied where L1 denotes the dimension of the inclined surface or the recess in the axial direction, L2 denotes the dimension of each pole portion from the base to the distal surface, and L3 denotes the dimension of the permanent magnet in the axial direction.

In this structure, the middle position of the pole portion excluding the inclined surface or the recess in the axial direction is substantially aligned with the middle position of the permanent magnet in the axial direction. This further improves the balance of the axial components of attraction forces (also, repulsion forces) received by the claw poles of the first and second stator cores from the permanent magnet of the rotor. The axial components of the attraction forces cancel out each other, and the remaining axial component becomes substantially zero (same in repulsion forces). This further effectively reduces the thrust forces.

A third embodiment of a motor will now be described.

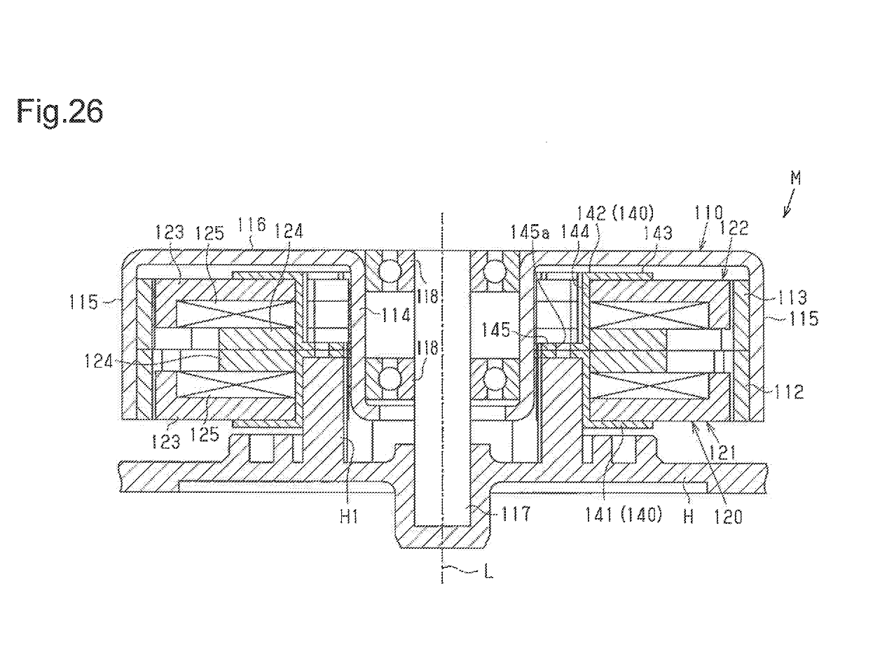

As shown in FIG. 26, the present embodiment of a motor M is a brushless motor and includes a rotor 110 and a stator 120.

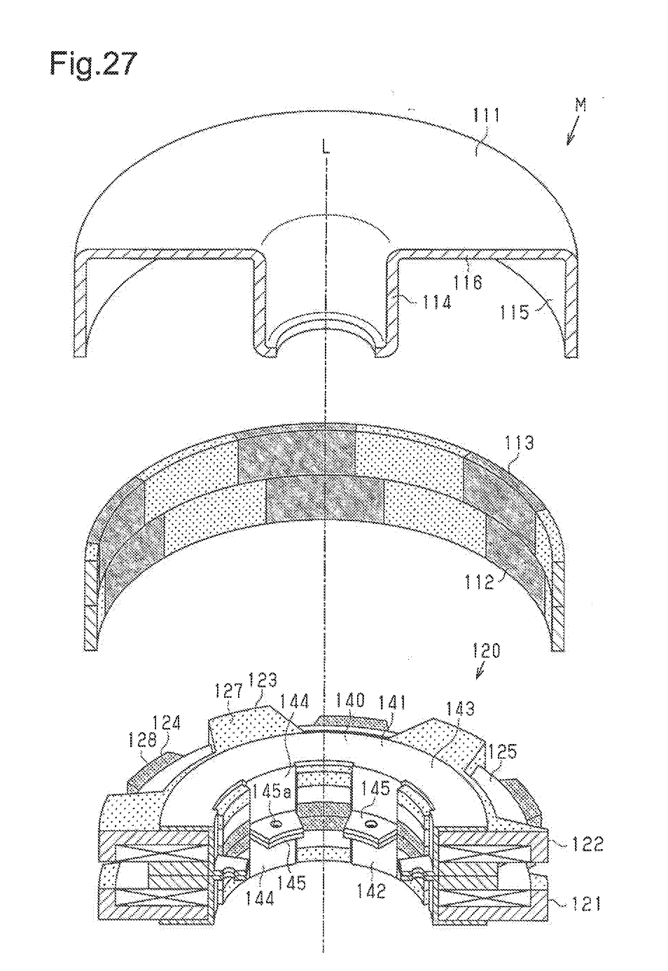

As shown in FIGS. 26 and 27, the rotor 110 includes a rotor core 111 formed by a magnetic element and magnets 112, 113 fixed to the rotor core 111.

The rotor core 111 includes a cylindrical inner tube 114, the center of which conforms to the axis L of the rotor 110, a cylindrical outer tube 115, the center of which conforms to the axis L and located at a circumferentially outer side of the inner tube 114, and an upper wall end 116, which connects an axial end of the inner tube 114 and an axial end of the outer tube 115. The upper wall end 116 is flat and perpendicular to the axis L. The inner surface of the inner tube 114 is supported by a bearing 118 onto a support shaft 117. Thus, the 117 rotationally supports the rotor core 111.

The A-phase magnet 112 and the B-phase magnet 113 are fixed to the inner surface of the outer tube 115. The magnets 112, 113 are arranged next to each other in the axial direction. The magnet 112 is opposed to a first stator unit 121, which will be described later, in the radial direction. The magnet 113 is opposed to a second stator unit 122, which will be described later, in the radial direction. The magnets 112, 113 are each magnetized in the radial direction and so that north poles and south poles are alternately arranged at equal intervals in the circumferential direction.

The stator 120, which is fastened to a housing H, includes the annular first stator unit 121, the annular second stator unit 122, and a fastener 140 (retainer), which fastens the first stator unit 121 and the second stator unit 122 to the housing H.

The first and second stator units 121, 122, which have the same structure and the same shape, are arranged next to each other in the axial direction. The second stator unit 122 is located proximate to the upper wall end 116 (upper side in FIGS. 26 and 27) in the axial direction. The first stator unit 121 is located proximate to the open end of the rotor core 111 (lower side in FIGS. 26 and 27) in the axial direction.

In the present embodiment, the first stator unit 121 is used for the A-phase and supplied with the corresponding phase (A-phase) drive current. The second stator unit 122 is used for the B-phase and supplied with the corresponding phase (B-phase) drive current.

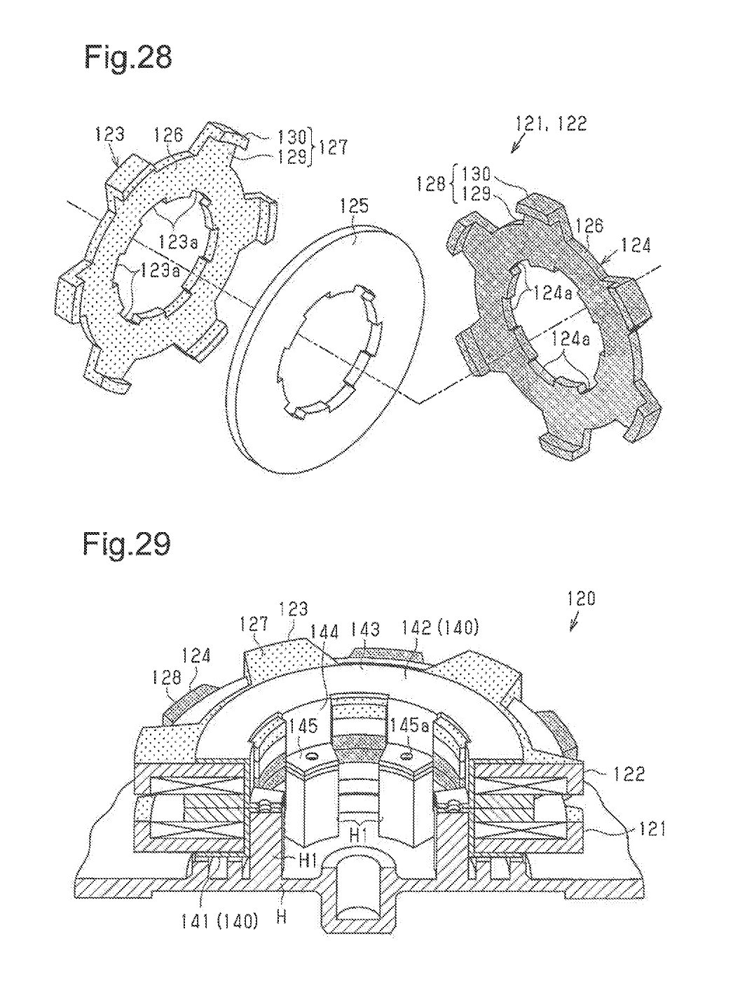

As shown in FIGS. 27 and 28, the first and second stator units 121, 122 each include two stator cores (first stator core 123 and second stator core 124) having the same shape and a winding 125 (coil), which is located between the two stator cores 123, 124. The first stator core 123 and the second stator core 124 function as a first core portion and a second core portion, respectively.

The stator cores 123, 124 each include a tubular core base 126, which is, for example, a magnetic powder core formed through compression molding, and a plurality (six in present embodiment) of claw poles, which extends from the core base 126. The claw poles of the first stator core 123 are referred to as the first claw poles 127. The claw poles of the second stator core 124 are referred to as the second claw poles 128. The claw poles 127, 128 have the same shape. The first claw poles 12 are arranged at equal intervals (sixty-degree intervals) in the circumferential direction. In the same manner, the second claw poles 128 are arranged at equal intervals (sixty-degree intervals) in the circumferential direction.

The claw poles 127, 12 8 are each extended radially outward from the core base 126 and perpendicularly bent and directed in the radial direction. In each of the claw poles 127, 128, the portion extending radially outward from the tube 126 is referred to as a radial extension 129, and the distal portion bent in the axial direction is referred to as a pole portion 130. The radial extension 129 has a dimension in the circumferential direction that narrows toward the circumferentially outer side. The pole portion 130 has an outer circumferential surface (radially outer surface) that is arcuate about the axis L.

The stator cores 123, 124 respectively include recesses 123a, 124a, which extend radially outward from radially inner surfaces of the stator cores 123, 124.

The first and second stator cores 123, 124 are coupled to each other so that the first and second claw poles 127, 128 (pole portions 130) are directed to opposite sides in the axial direction. In this coupling state, the pole portions 130 of the first claw poles 127 and the pole portions 130 of the second claw poles 128 are alternately arranged at equal intervals in the circumferential direction.

Additionally, in this coupling state, the winding 125 is located between the first and second stator cores 123, 124 in the axial direction. Although not shown, an insulation member is located between the winding 125 and the first and second stator cores 123, 124. The winding 125 is annular and extends in the circumferential direction of the stator 120. The winding 125 is located between the radial extensions 129 of the first claw poles 127 and the radial extensions 129 of the second claw poles 128 in the axial direction and between the core base 126 of each of the stator cores 123, 124 and the pole portions 130 of each of the claw poles 127, 128 in the radial direction.

Each of the stator units 121, 122, which are configured as described above, has the so-called Lundell construction. More specifically, the first and second stator units 121, 122 each have a twelve-pole Lundell construction that excites the first and second claw poles 127, 128 into different magnetic poles with the winding 125 located between the first and second stator cores 123, 124.

As shown in FIG. 27, the first and second stator units 121, 122 are arranged one on the other so that the second stator cores 124 are located adjacent to each other in the axial direction.

The B-phase second stator unit 122 is shifted from the A-phase first stator unit 121 by a predetermined angle in the clockwise direction as viewed from the upper side in the axial direction (stator unit 121). That is, the poles (claw poles 127, 128) of the first stator unit 121 are shifted from the poles (claw poles 127, 128) of the second stator unit 122 by the predetermined angle in the clockwise direction.

Also, the magnets 112, 113 of the rotor 110, which are opposed to the first and second stator units 121, 122 in the radial direction, are shifted from each other in the circumferential direction. More specifically, as viewed from the upper side in the axial direction (magnet 113), the north poles (south poles) of the B-phase magnet 113 are shifted from the north poles (south poles) of the A-phase magnet 112 by a predetermined angle in the counterclockwise direction.

As shown in FIGS. 26, 27, and 29, the stator units 121, 122, which are arranged one on the other in the axial direction, are retained by the fastener 140 and fastened to the housing H.

The fastener 140 includes a first fastener 141 and a second fastener 142. The first and second fasteners 141, 142 include contact portions (first retaining portion and second retaining portion) 143, which are respectively in contact with the stator units 121, 122 in the axial direction, a plurality of core back portions 144 (connection portions), and a plurality of coupling portions 145 (connection portions).

The contact portions 143 of the first and second fasteners 141, 142 each have the form of an annular plate. The contact portion 143 of the first fastener 141 is in contact with the core base 126 of the first stator core 123 of the first stator unit 121 in the axial direction. The contact portion 143 of the second fastener 142 is in contact with the core base 126 of the first stator core 123 of the second stator unit 122 in the axial direction.

The core back portions 144 extend from radially inner portions of the first and second fasteners 141, 142 in the axial direction. The core back portions 144 each have an arcuate cross section in a direction orthogonal to the axis. The core back portions 144 are fitted into the recesses 123a, 124a of the stator cores 123, 124.

The coupling portions 145 extend radially inward from distal ends of the core back portions 144. The coupling portions 145 each include an insertion hole 145a. The coupling portions 145 may be coupled to coupled portions H1 of the housing H by bolts or the like.

The coupling portions 145 are located at boundary positions of the first stator unit 121 and the second stator unit 122 in the axial direction, that is, a boundary position of each of the phases (A-phase, B-phase).

With the fastener 140 having the above structure, the contact portions 143 of the first and second fasteners 141, 142 retain the first and second stator units 121, 122, which are arranged one on the other in the axial direction, and the coupling portions 145 are coupled to the housing H. This fastens the first and second stator units 121, 122 to the housing H.

The operation of the third embodiment will now be described.

The windings 125 of the A-phase first stator unit 121 are supplied with the A-phase drive current. The windings 125 of the B-phase second stator unit 122 are supplied with the B-phase drive current. The A-phase drive current and the B-phase drive current are each alternating current. The phase difference of the A-phase drive current and the B-phase drive current is set to, for example, ninety degrees. When the A-phase and B-phase drive currents are respectively supplied to the stator units 121, 122, torque is generated to rotate the magnets 112, 113. This rotates the rotor 110.

The third embodiment has the advantages described below.

(7) The core back portions 144, which are separate from the first and second stator cores 123, 124 and formed by magnetic members, are located at a side of the first and second stator cores 123, 124 opposite to the claw poles 127, 128 in the radial direction. This simplifies the structure of each component (stator cores 123, 124, core back portions 144) as compared to when each of the first and second stator cores 123, 124 includes the core back portions 144 and is formed as a single component.

(8) The core back portions 144 are arranged in the recesses 123a, 124a of the stator cores 123, 124. Thus, the core back portions 144 position the stator cores 123, 124 relative to each other in the circumferential direction.

(9) A plurality of stator units 121, 122, each of which includes the first stator core 123, the second stator core 124, and the winding 125, is arranged one on another in the axial direction. The fastener 140 includes a retainer that retains the stator units 121, 122, which are arranged one on another, from opposite sides in the axial direction. The fastener 140 is capable of retaining and fastening the stator units 121, 122, which are arranged one on another.

(10) The fastener 140 includes the contact portion 143 of the first fastener 141, the contact portion 143 of the second fastener 142, and the core back portions 144 and the coupling portions 145 functioning as the connection portions. The first fastener 141 is located at one side in the axial direction when the stator units 121, 122 are arranged one on another. The second fastener 142 is located at the other side in the axial direction when the stator units 121, 122 are arranged one on another. The core back portions 144 and the coupling portion 145 connect between the two contact portions 143. More specifically, the fastener 140 that includes the core back portions 144 produces the effect of the core back portions 144 while performing the retaining and fastening. Additionally, the number of components is reduced as compared to when the fastener 140 is separate from the core back portions 144.

(11) The coupling portions 145 are located at the boundary position of the first stator unit 121 and the second stator unit 122. This allows for fine adjustments of circumferential positions between the first stator unit 121 and the second stator unit 122.

The third embodiment may be modified as follows.

In the above embodiment, the first stator unit 121 and the second stator unit 122 are arranged one on the other in the axial direction to obtain the stator 120. The number of the first stator units 121 and the second stator units 122 arranged one on another may be changed.

Alternatively, the stator 120 may include only one of the first stator unit 121 and the second stator unit 122.

In the above embodiment, the fastener 140 is integrally formed with the core back portions 144. Instead, the fastener 140 may be separate from the core back portions 144.

In the above embodiment, the stator cores 123, 124 include the recesses 123a, 124a. The core back portions 144 are fitted into the recesses 123a, 124a. However, the recesses 123a, 124a may be omitted from the structure as long as the core back portions 144 are in contact with the stator cores 123, 124 in the radial direction.

The above embodiment and modified examples may be combined.

A fourth embodiment of a motor will now be described. For the sake of brevity, the same reference characters are given to elements that are the same as the corresponding components of the motor M of the third embodiment. Such elements will not be described in detail.

The stator 120, which includes the annular first stator unit 121 and the annular second stator unit 122, is fixed to a holder 150.

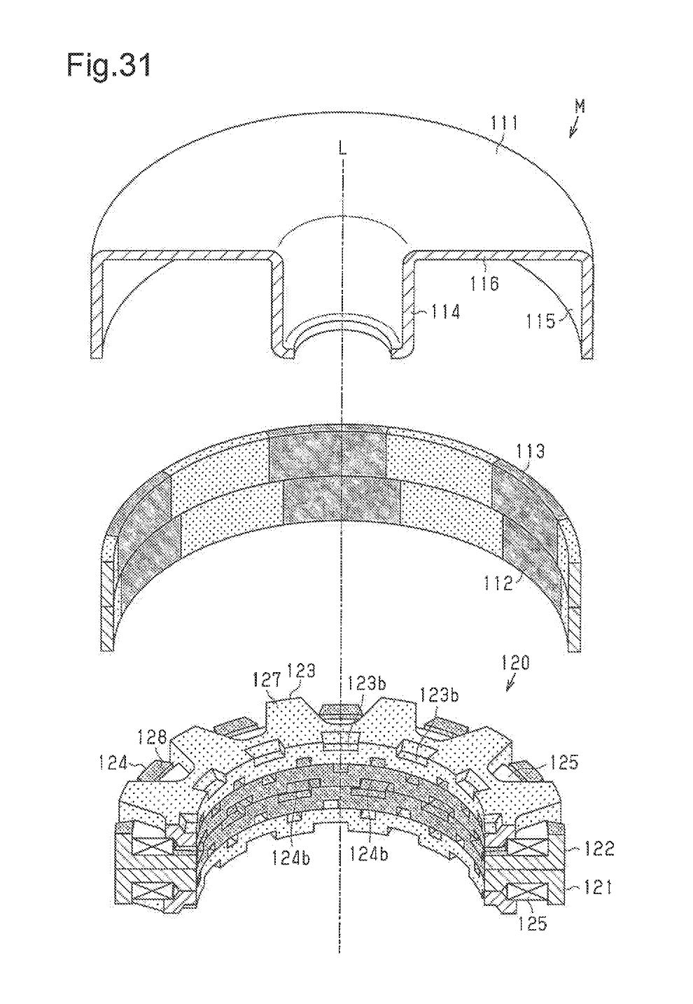

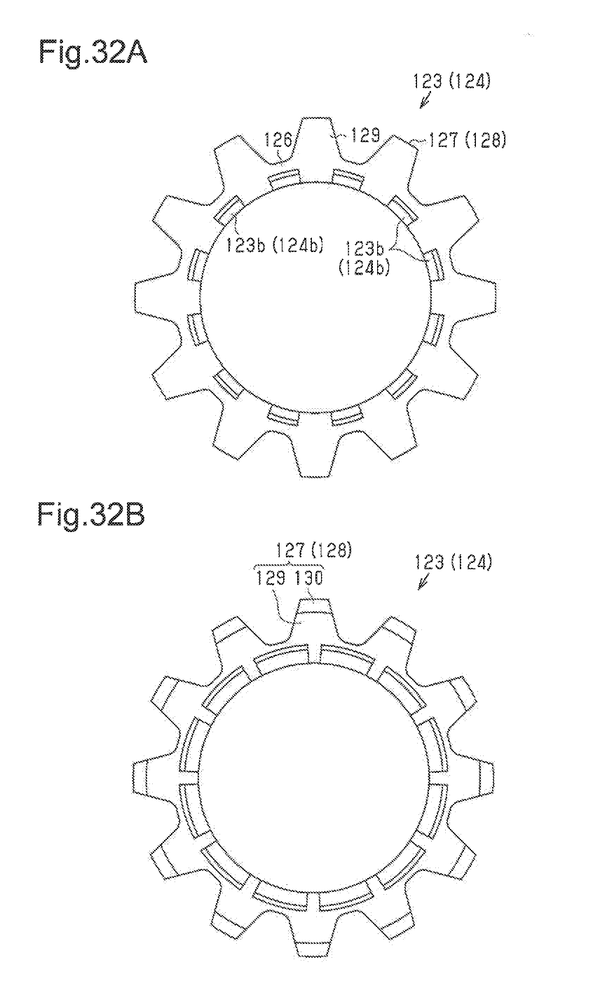

As shown in FIGS. 31, 32A, and 32B, the first and second stator units 121, 122 each include two stator cores (first stator core 123 and second stator core 124) having the same shape and the winding 125 (coil), which is located between the two stator cores 123, 124.

The stator cores 123, 124 each include a magnetic powder core formed, for example, by mixing magnetic powder such as iron powder with an insulator such as resin and performing heat press-molding (compression molding) on the mixture in a mold. The stator cores 123, 124 each include the tubular core base 126 and a plurality (twelve in present embodiment) of claw poles 127, 128, which extends from the core base 126. As described above, when the stator cores 123, 124 are formed by magnetic powder cores, the degree of freedom for designing is increased. Thus, the manufacturing process is significantly simplified as compared to, for example, when the stator cores 123, 124 are formed by curving (bending) a plate. Additionally, the limit amount of eddy current may be easily adjusted by adjusting the mixture ratio of the magnetic powder and the insulator.

The stator cores 123, 124 each include a plurality of recesses 123b, 124b arranged at a radially inner side at substantially equal angular intervals in the circumferential direction. The recesses 123b, 124b are respectively defined by recessed portions of the stator cores 12 3, 124 located at a radially outer side and one side in the axial direction.

The stator units 121, 122, which are configured as described above, each have the so-called Lundell construction. More specifically, the first and second stator units 121, 122 have a twenty-four pole Lundell construction that excites the first and second claw poles 127, 128 into different magnetic poles with the windings 125 located between the first and second stator cores 123, 124.

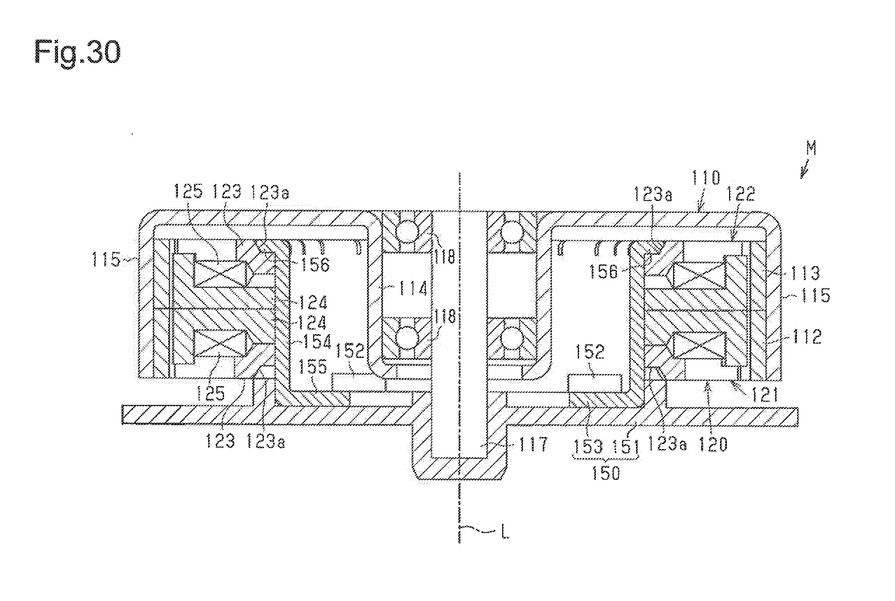

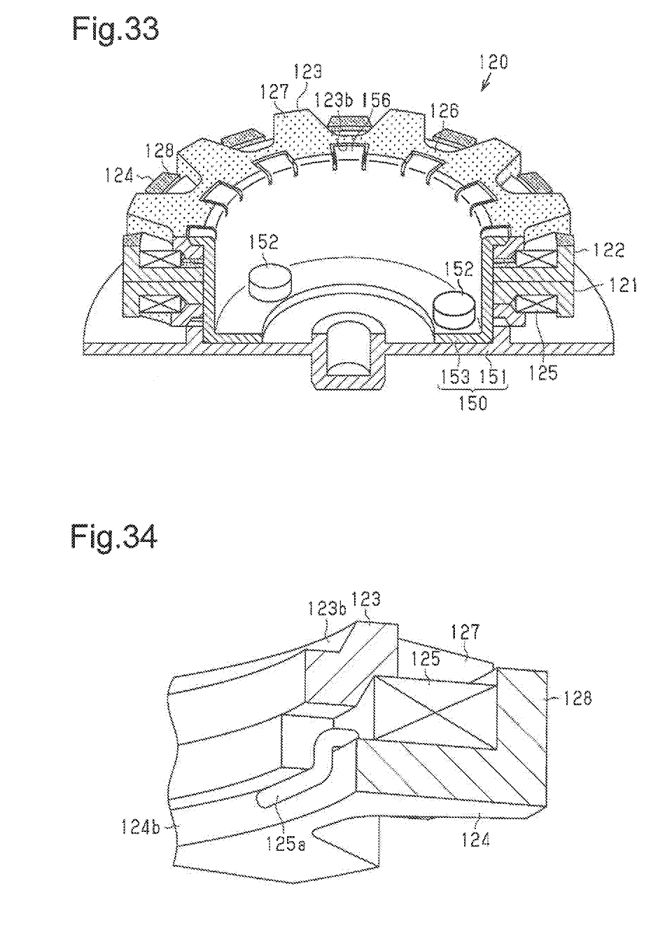

As shown in FIGS. 30, 31, 33, the stator units 121, 122, which are arranged one on the other, are fixed to the holder 150.

The holder 150 includes a plate-shaped base 151 and a holding piece 153, which is fastened to the base 151 by, for example, fastening members 152 such as bolts.

The holding piece 153, which functions as a positioning portion, includes a tube 154, an annular plate 155, and a plurality of hooks 156. The annular plate 155 extends radially inward from the inner surface of the end of the tube 154 located proximate to the base 151. The hooks 156, which extend radially outward from an end of the tube 154 opposite to the annular plate 155, are arranged at substantially equal angular intervals in the circumferential direction. In the present embodiment, the hooks 156 engage with the recesses 123b in the stator core 123 of the second stator unit 122 in the radial and circumferential directions.

The operation of the motor M will now be described.

The A-phase drive current is supplied to the winding 125 of the A-phase first stator unit 121. The B-phase drive current is supplied to the winding 125 of the B-phase second stator unit 122. The A-phase drive current and the B-phase drive current are each alternating current. The phase difference between the A-phase drive current and the B-phase drive current is set to ninety degrees. When the A-phase and B-phase drive currents are respectively supplied to the stator units 121, 122, torque is generated to rotate the magnets 112, 113. This rotates the rotor 110.

The fourth embodiment has the advantages described below.

(12) The core bases 126 of the first stator core 123 and the second stator core 124 include the recesses 123b, 124b at the radially inner side. The recesses 123b may be used, for example, with distal ends of the hooks 156 of the holding piece 153, which is in contact with the walls of the recesses 123b in the radial direction and functions as the positioning portion. This allows for easy positioning of the housing (holder 150) and the stator 120 in the radial and circumferential directions.

(13) The stator core 123 includes the recesses 123b, which are arranged at predetermined intervals in the circumferential direction. Thus, the use of the recesses 123b and the holder 150 including the hooks 156, which are fitted in and engaged with the recesses 123b, allows for the positioning of the housing (holder 150) and the stator 120 in the circumferential direction and prevents the rotation or separation of the stator cores 123, 124.

The fourth embodiment may be modified as follows.

In the above embodiment, the usage of the recesses 124b is not particularly described. However, the recesses 124b may have the following usage.

As shown in FIG. 34, the recess 124b has a valley. Thus, the winding 125 may be drawn into the recesses 124b, The drawn winding 125a may be located at a predetermined position. When the recesses 124b engage the holding piece 153 of the holder 150, the winding 125 may be drawn into one of the recesses 123b.

In the above embodiment, the holder 150 includes the base 151 and the holding piece 153 that are separate from each other. However, there is no limit to such a configuration.

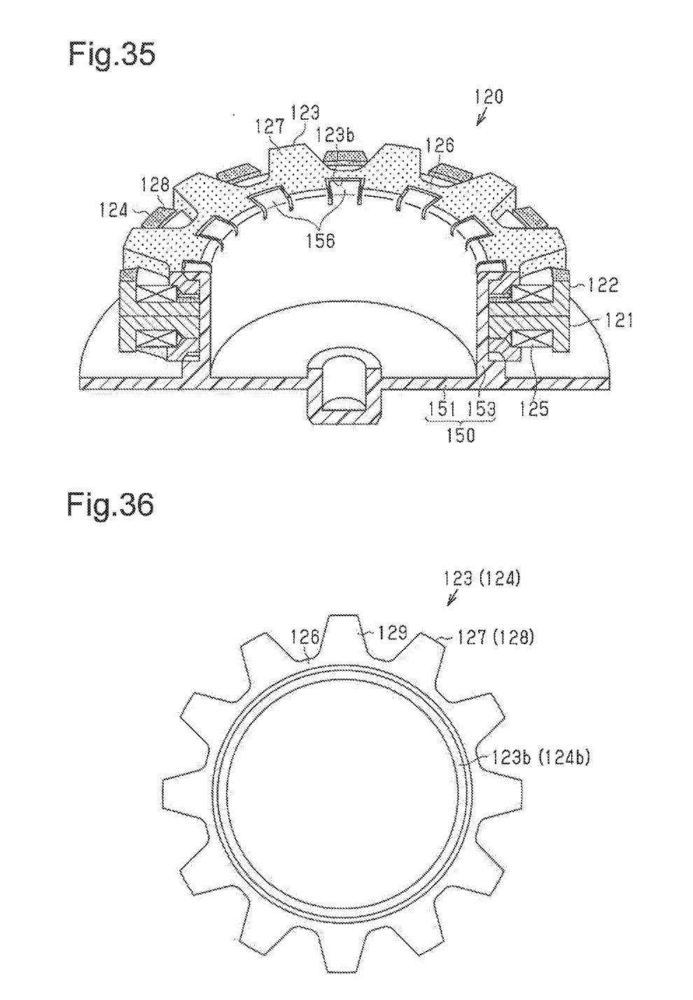

As shown FIG. 35, the base 151 and the holding piece 153 may be formed integrally with each other from, for example, a resin. This reduces the number of components as compared to when the base 151 and the holding piece 153 are separate from each other. Additionally, the step for fastening with the fastening members 152 may be omitted.

In the above embodiment, a plurality of recesses 123b (124b) is arranged at equal angular intervals in the circumferential direction. However, there is no limit to such a configuration. For example, one recess or more may be arranged in the circumferential direction.

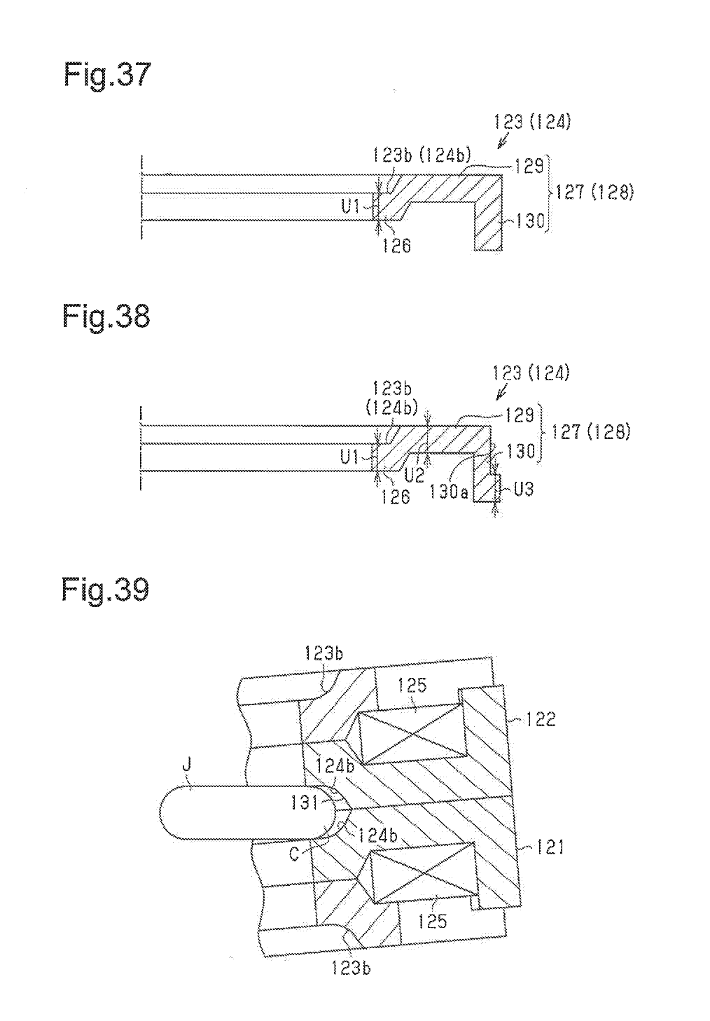

As shown in FIGS. 36 and 37, the recesses 123b (124b) may be annular.

With such a configuration, a thickness U1 of the core base 126 may be set to be the same as a thickness U2 of the claw pole 127 (128) in the axial direction by adjusting the depth of the recesses 123b (124b) in the axial direction. Thus, when the stator cores 123, 124 are formed by magnetic powder cores as described in the above embodiment, if the thicknesses U1, U2 are uniform in the axial direction as described above, a uniform density distribution is easily obtained.

As shown in FIG. 38, in addition to the configuration described above, the pole portion 130 of the claw pole 127 (128) may include a recess 130a. With such a configuration, a thickness U3 of a radially outer part of the pole portion 130 may be set to be the same as the other thicknesses U1, U2 in the axial direction. This increases the portions having the same thickness in the axial direction. Thus, when the stator cores 123, 124 are formed from magnetic powder cores as described in the above embodiment, if the thicknesses U1, U2, U3 are uniform in the axial direction as described above, a uniform density distribution is easily obtained.

Although not particularly described in the above embodiment, the recesses 123b (124b) may be defined by curved surfaces.

As shown in FIG. 39, when the recesses 123b, 124b are defined by curved surfaces, a distal curved portion C of a holding jig J may be inserted into a semicircular groove 131 defined by the recess 124b of the first stator unit 121 and the recess 124b of the second stator unit 122. When the groove 131 conforms to the curved portion C of the holding jig J, the positions of the first stator unit 121 and the second stator unit 122 are adjusted. Thus, the displacement of the stator 120 may be adjusted in the axial direction.

In the above embodiment, the stator cores 123, 124 are formed by magnetic powder cores. Instead, the stator cores 123, 124 may be formed by bending a plate or performing die casting.

In the above embodiment, the first stator unit 121 and the second stator unit 122 are arranged one on the other in the axial direction to obtain the stator 120. However, the number of the first stator units 121 and the second stator units 122, which are arranged one on another, may be changed.

Alternatively, the stator 120 may include only one of the first stator unit 121 and the second stator unit 122.

The above embodiment and modified examples may be combined.

A fifth embodiment of a motor (stator) will now be described.

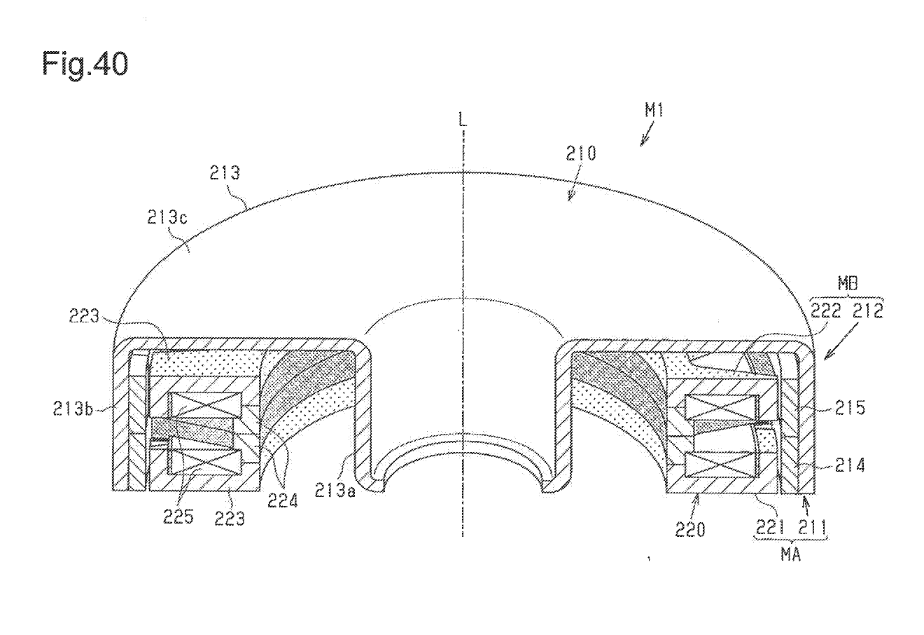

As shown in FIG. 40, the fifth embodiment of a motor M1 is a brushless motor and includes a rotor 210, which is rotationally supported by a support shaft of a housing (not shown), and a stator 220, which is fixed to the housing.

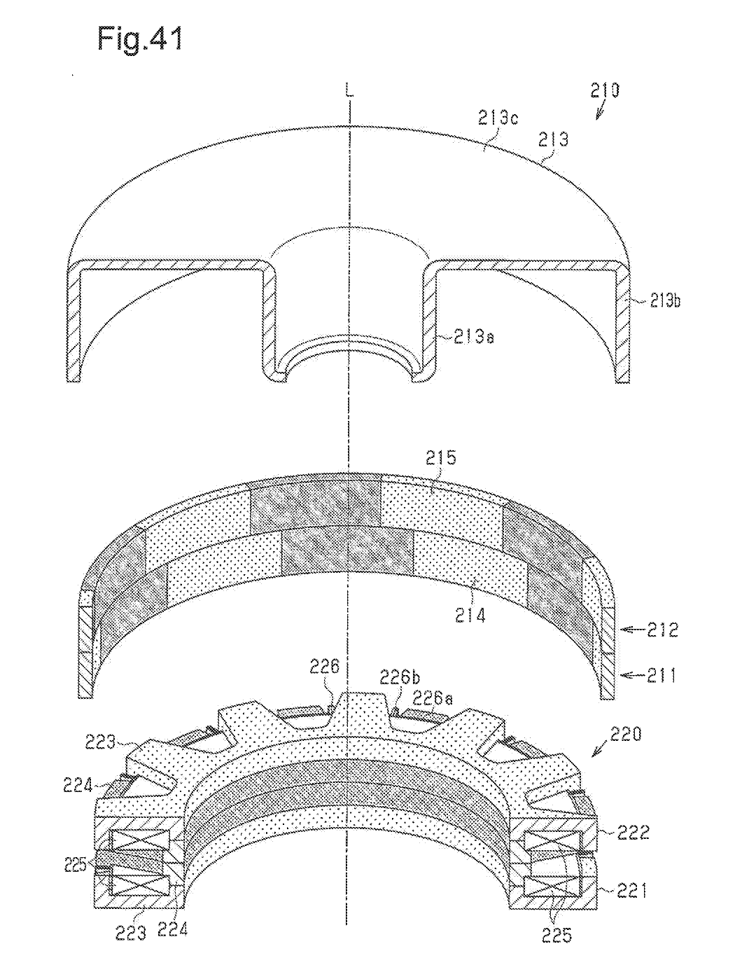

As shown in FIGS. 40 and 41, the rotor 210 includes two-phase rotor units, namely, an A-phase rotor unit 211 and a B-phase rotor unit 212. To obtain the rotor units, the rotor 210 includes a rotor core 213, which is formed by a magnetic element, and two magnets (A-phase magnet 214 and B-phase magnet 215) fixed to the rotor core 213.

The rotor core 213 includes a cylindrical inner tube 213a, the center of which conforms to an axis L of the rotor 210, a cylindrical outer tube 213b, the center of which conforms to the axis L and located at a circumferentially outer side of the inner tube 213a, and an upper wall end 213c, which connects an axial end (upper end) of the inner tube 213a and an axial end (upper end) of the outer tube 213b. The upper wall end 213c is flat and annular in a direction orthogonal to the axis L. In the rotor core 213, the inner surface of the inner tube 13a is supported by a bearing (not shown) onto the support shaft, which is described above and not shown in the drawings.

The A-phase magnet 214 and the B-phase magnet 215 are sequentially arranged on the inner surface of the outer tube 213b from the open end of the rotor core 213 toward the upper wall end 213c in the axial direction. The A-phase magnet 214 is located at a position opposing to an A-phase stator unit 221, which will be described later, in the radial direction to form the A-phase rotor unit 211. In the same manner, the B-phase magnet 215 is located at a position opposed to a B-phase stator unit 222, which will be described later, in the radial direction to form the B-phase rotor unit 212. The A-phase and B-phase magnets 214, 215 are magnetized in the radial direction so that north poles and south poles are alternately arranged at equal intervals in the circumferential direction. Additionally, the number of poles in each of the A-phase and B-phase magnets 214, 215 is the same. The rotor 210 of the present embodiment has twelve poles (six pole pairs).

The stator 220 includes annular stator units 221, 222. In the present embodiment, the stator unit 221 is used for the A-phase and supplied with the A-phase drive current. The stator unit 222 is used for the B-phase and supplied with the B-phase drive current.

The stator units 221, 222, which have the same structure and the same shape, are arranged next to each other in the axial direction. The A-phase stator unit 221 is located proximate to the open end (lower side) of the rotor core 213 in the axial direction. The B-phase stator unit 222 is located proximate to the upper wall end 213c (upper side) in the axial direction. The structure for supporting the stator units 221, 222 is such that the A-phase stator unit 221 is supported by the housing, which is described above and not shown in the drawings, and the B-phase stator unit 222 is supported by the A-phase stator unit 221.

In the motor M1 having the above structure, as shown in FIG. 40, the A-phase motor unit MA includes the A-phase stator unit 221 and the A-phase rotor unit 211, which is located at a circumferentially outer side of the A-phase stator unit 221 and includes the A-phase magnet 214. In the same manner, the B-phase motor unit MB includes the B-phase stator unit 222 and the B-phase rotor unit 212, which is located at a circumferentially outer side of the B-phase stator unit 222 and includes the B-phase magnet 215.

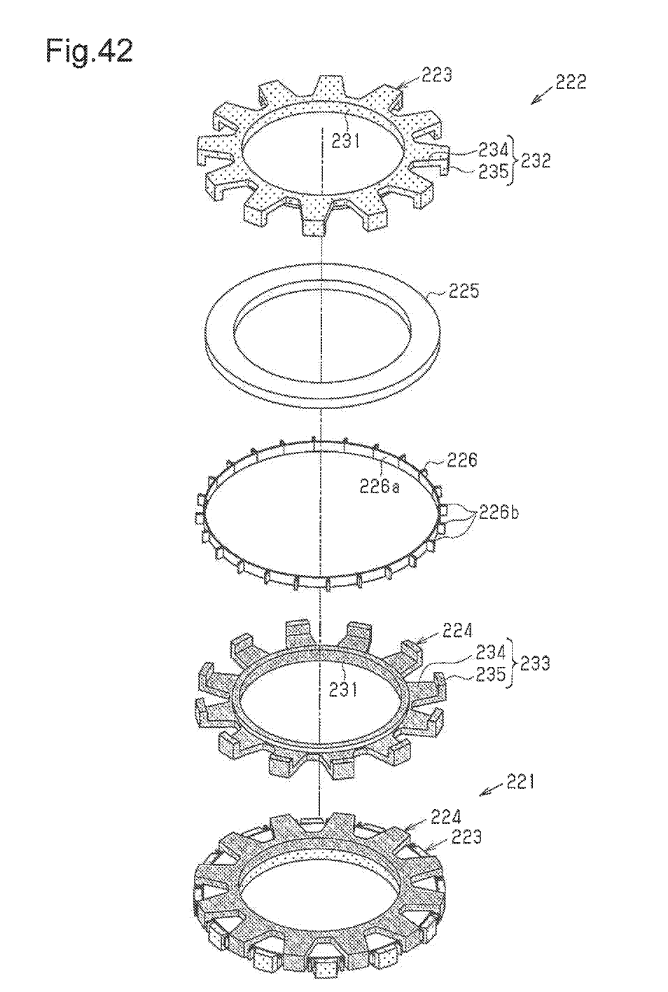

As shown in FIG. 42, the A-phase and B-phase stator units 221, 222 each include two stator cores (first stator core 223 and second stator core 224) having the same shape, a coil 225 located between the two stator cores 223, 224, and an auxiliary pole member 226.

The stator cores 223, 224 each include a tube 231 and a plurality (twelve in present embodiment) of claw poles 232, 233 extending circumferentially outward from the tube 231. The claw poles of the first stator core 223 are referred to as first claw poles 232. The claw poles of the second stator core 224 are referred to as second claw poles 233. The claw poles 232, 233 have the same shape. The first claw poles 232 are arranged at equal intervals (thirty-degree intervals) in the circumferential direction. The second claw poles 233 are also arranged at equal intervals (thirty-degree intervals) in the circumferential direction.

Each of the claw poles 232, 233, which extend radially outward from the tube 231, is perpendicularly bent and directed in the axial direction. In each of the claw poles 232, 233, the portion extending radially outward from the tube 231 is referred to as a radial extension 234, and the distal portion bent in the axial direction is referred to as a pole portion 235. The radial extension 234 has a dimension in the circumferential direction that narrows toward the circumferentially outer side. The pole portion 235 has an outer circumferential surface (radially outer surface) that is arcuate about the axis L.

The stator cores 223, 224, which include the claw poles 232, 233 having the perpendicular shape, may be formed by bending a plate or performing die casting. Alternatively, the stator cores 223, 224 may be formed by mixing magnetic powder such as iron powder with an insulator such as a resin and performing heat press-molding on the mixture in a mold.

The first and second stator cores 223, 224 having the above structure are coupled so that the first and second claw poles 232, 233 (pole portions 235) are opposed to each other in the axial direction (refer to FIG. 42). In this coupling state, the pole portions 235 of the first claw poles 232 and the pole portions 235 of the second claw poles 233 are alternately arranged in equal intervals in the circumferential direction. More specifically, the stator 220 of the present embodiment has twenty-four poles. The first and second stator cores 223, 224 are fixed to each other with the tubes 231 in contact with each other in the axial direction.

In this coupling state, the coil 225 is located between the first and second stator cores 223, 224 in the axial direction.

The coil 225 includes a winding, which is annularly wound in the circumferential direction of the stator 220, and an insulative resin bobbin, which is located between the winding and the first and second stator cores 223, 224. The coil 225 is located between the radial extension 234 of each of the first claw poles 232 and the radial extension 234 of each of the second claw poles 233 in the axial direction. Also, the coil 225 is located in a gap between the tube 231 of each of the stator cores 223, 224 and the pole portions 235 of the claw poles 232, 233 at a position closer to the tubes 231 in the radial direction.

The A-phase and B-phase stator units 221, 222, which are configured as described above, each have the so-called Lundell construction. More specifically, the A-phase and B-phase stator units 221, 222 each have a twelve-pole Lundell construction that excites the first and second claw poles 232, 233 into different magnetic poles whenever the current is supplied to the winding of the coil 225 located between the first and second stator cores 223, 224.

Additionally, the auxiliary pole member 226 is located between the first and second stator cores 223, 224 in a manner fitted to the outer circumference of the coil 225.

The auxiliary pole member 225 is formed from a magnetic metal material and includes an annular base 226a and a plurality of salient poles 226b, which projects radially outward from the outer circumference of the base 226a. The dimension of the base 226a in the axial direction is the same as the dimension of the coil 225 in the axial dimension. In this case, the dimension of the base 226a in the axial direction is set to be the same as the dimension between the radial extensions 234 of the first and second claw poles 232, 233 in the axial direction and less than the dimension of the pole portions 235 in the axial direction. The inner diameter of the base 226a is substantially the same as the outer diameter of the coil 225 and set to a size that allows the base 226a of the auxiliary pole member 226 to be fitted onto the outer circumference of the coil 225. The number of the salient poles 226b is twice the number of the claw poles 232, 233 of the first and second stator cores 223, 224. That is, twenty-four salient poles 226b are arranged on the base 226a at equal intervals (fifteen-degree intervals) in the circumferential direction.

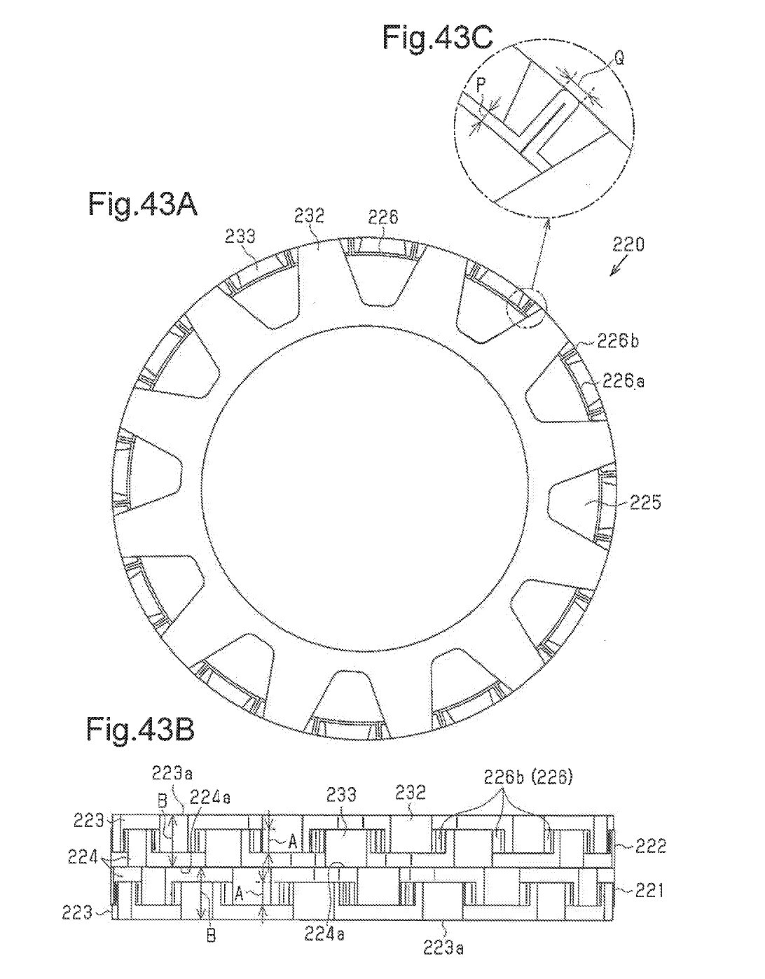

In the present embodiment, the base 226a of the auxiliary pole member 226 is obtained by forming a single plate into an annular shape. FIG. 43C shows an enlarged view of a salient pole 226b that is formed by folding the plate radially outward when forming the base 226a. Thus, a dimension Q of the salient pole 226b in the circumferential direction is large relative to (twice) a dimension P of the salient pole 226b in the radial direction. In other words, the dimension P of the salient poles 226b in the radial direction is small relative to the dimension Q of the salient poles 226b in the circumferential direction. The process for forming the auxiliary pole member 226 is not limited to the above configuration. Instead, after the annular base 226a is formed, separately prepared salient poles 226b may be joined to the annular base 226a through welding or the like.

As shown in FIGS. 43A, 43B, the auxiliary pole member 226 is located between the radial extension 234 of each of the first claw poles 232 and the radial extension 234 of each of the second claw poles 233 in the axial direction. Additionally, the base 226a of the auxiliary pole member 226 is located between the coil 225 and the pole portion 235 of each of the claw poles 232, 233 (rear surface side of pole portion 235 of each of claw poles 232, 233) in the radial direction. Circumferentially outer ends of the salient poles 226b of the auxiliary pole member 226 are coplanar with the outer circumferential surfaces of the pole portions 235. Additionally, the salient poles 226b of the auxiliary pole member 226 are each located in a central position of the pole portion 235 of the first claw pole 232 and the pole portion 235 of the second claw pole 233 in the circumferential direction.

The positional relationship of the rotor 210 and the stator 220 will now be described.

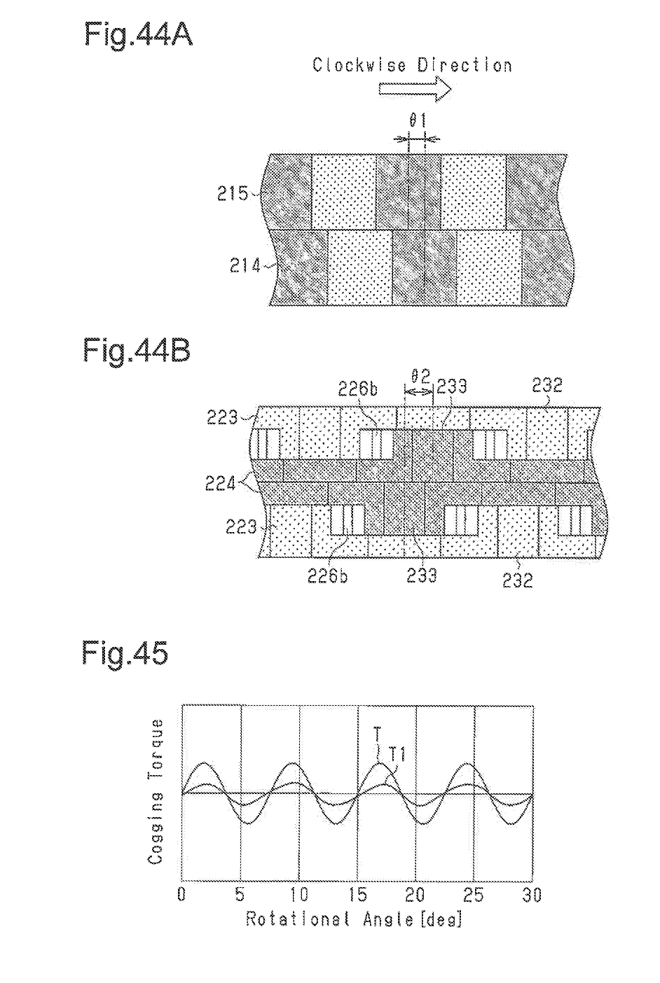

As shown in FIG. 44A, in the rotor 210, the B-phase magnet 215 of the B-phase rotor unit 212 is shifted from the A-phase magnet 214 of the A-phase rotor unit 211 by the electrical angle θ1 (forty-five degrees in present embodiment) in the counterclockwise direction. In the stator 220, as shown in FIG. 44B, the first and second claw poles 232, 233 of the B-phase stator unit 222 are shifted from the first and second claw poles 232, 233 of the A-phase stator unit 221 by the electrical angle θ1 (forty-five degrees in present embodiment) in the clockwise direction. That is, in the motor M1 of the present embodiment, the phase difference of the A-phase motor unit MA and the B-phase motor unit MB is set to ninety degrees.

The A-phase drive current is supplied to the winding of the coil 225 of the A-phase stator unit 221. The B-phase drive current is supplied to the winding of the coil 225 of the B-phase stator unit 222. The A-phase drive current and the B-phase drive current are each alternating current. The phase difference between the A-phase drive current and the B-phase drive current is set to ninety degrees in the present embodiment. Thus, rotational torque is generated due to the relationship between the stator units 221, 222 and the A-phase and B-phase magnets 214, 215 and rotates the rotor 210.

FIG. 45 shows cogging torque T1 of the motor M1, which includes the auxiliary pole member 226 of the present embodiment, and cogging torque T of a comparative example of a motor (M0) that does not include the auxiliary pole member 226. As shown in FIG. 45, the cogging torque of the motor M1 of the present embodiment is reduced to be less than the cogging torque T of the motor (M0) of the comparative example.

Since each of the A-phase and B-phase stator units 221, 222 of the present embodiment includes the auxiliary pole member 226, a magnetic flux flowing into the first claw poles 232 (second claw poles 233) flows out to the second claw poles 233 (first claw poles 232) and the salient poles 226b. In this state, the magnetic fluxes of the first and second claw poles 232, 233 change in the same phase, which is referred to as a first cogging torque component. However, the salient poles 226b are each located in the central position of the first and second claw poles 232, 233. Thus, the magnetic fluxes of the first claw poles 232 (second claw poles 233) and the salient poles 226b change in antiphase. More specifically, the arrangement of the salient poles 226b generates a second cogging torque component, which is in antiphase with the first cogging torque component. Thus, it is understood that the first and second cogging torque components cancel out each other, and the cogging torque T1 of the motor M1 is reduced as a whole.

The fifth embodiment has the advantages described below.

The stator units 221, 222 of the motor M1 each include the auxiliary pole member 226. The first and second claw poles 232, 233 generate the first cogging torque component. Also, the first claw poles 232 (second claw poles 233) and the salient poles 226b generate the second cogging torque component. Since the salient poles 226b are located between the first and second claw poles 232, 233, the phase shift occurs such that the second cogging torque component and the first cogging torque component cancel out each other. Thus, the cogging torque T1 of the motor M1 is reduced as shown in FIG. 45.

(15) The salient poles 226b of the auxiliary pole member 226 are each located in the central position of the first and second claw poles 232, 233. Thus, the phase difference between the first and second cogging torques is in antiphase or proximate to antiphase. This increases the effect of cancelling out the first and second cogging torque components each other and further reduces the cogging torque T1 of the motor M1 as shown in FIG. 45.

(16) In the auxiliary pole member 226, the dimension P of the base 226a in the radial direction is set to be less than the dimension Q of the salient poles 226b in the circumferential direction. Thus, magnetic saturation tends to occur in the base 226a of the auxiliary pole member 226. This limits the outflow of the magnetic flux from the salient poles 226b to adjacent ones of the salient poles 226b through the base 226a. Consequently, the cogging torque T1 is reduced while limiting decreases in the torque caused by the auxiliary pole member 226.

(17) The auxiliary pole member 226 is formed by a single plate. Thus, the auxiliary pole member 226 is easily manufactured by bending the plate.

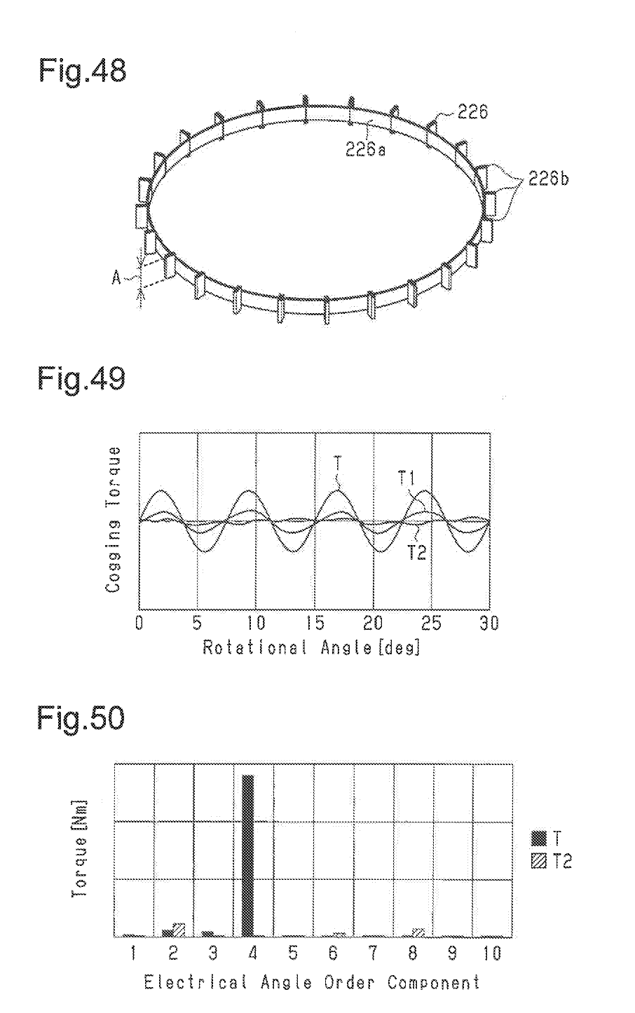

A sixth embodiment of a motor will now be described. The sixth embodiment of the motor (M2; not shown) and the fifth embodiment of the motor M1 have the same structure except only in that the salient poles 226b of the auxiliary pole member 226 have different dimensions A in the axial direction. More specifically, in the fifth embodiment of the motor M1, the dimension A of each salient pole 226b is set to be 50% of a dimension B of each of the stator units 221, 222. In the present embodiment of the motor (M2), the dimension A of the salient pole 226b is set to be 70% of the dimension B of each of the stator units 221, 222. In this setting, two axial ends of the salient pole 226b project from the base 226a (refer to FIG. 48).

The inventors have found that the magnitude of cogging torque is changed by the dimension A of the salient poles 226b of the auxiliary pole member 226 in the axial direction in addition to whether or not the auxiliary pole member 226 is arranged. More specifically, the inventors evaluated the ratio of cogging torque and the fourth order component of the cogging torque when the dimension A of the salient poles 226b was changed. In this case, the dimension A of the salient poles 226b is set with the dimension B of each of the stator units 221, 222 in the axial direction used as a reference (100%). The dimension B of each of the stator units 221, 222 in the axial direction refers to the distance from an end surface 223a of the first stator core 223 (end surface of first stator core 223 located at a side opposite to distal ends of pole portions 235) to an end surface 224a of the second stator core 224 (end surface of second stator cure 224 located at a side opposite to distal ends of pole portions 235). The dimension A of the salient poles 226b is changed in a range of 30% to 100% of the dimension E of each of the stator units 221, 222. In the fifth embodiment, the dimension A of the salient poles 226b is 50% of the dimension B of each of the stator units 221, 222. The cogging torque and the fourth order component of the cogging torque are set with the cogging torque T and its fourth order component of the comparative example used as a reference (100%).

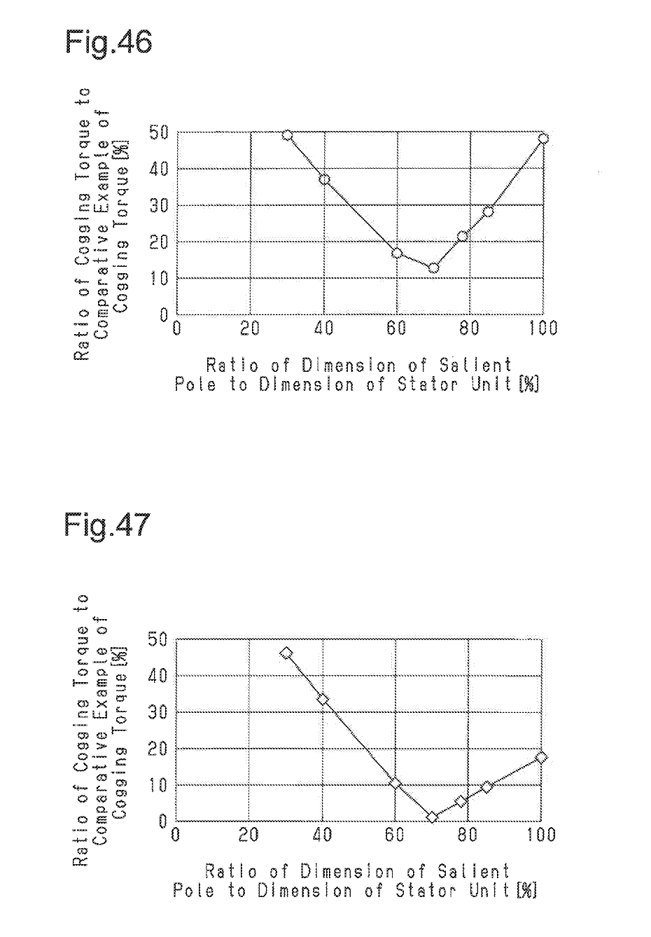

FIGS. 46 and 47 show the results. As the dimension A of the salient poles 226b is increased in a range of 30% to 70% of the dimension of each of the stator units 221, 222, the cogging torque and the fourth order component of the cogging torque are decreased. As the dimension A is increased in a range of 70% to 100%, the cogging torque and the fourth order component of the cogging torque are increased. More specifically, when the dimension A of the salient poles 226b is set to 60% to 80% of the dimension B of each of the stator units 221, 222, the cogging torque and its fourth order component are effectively reduced. Further, when the dimension, is set to 70%, the cogging torque and the fourth order component of the cogging torque are most effectively reduced.

Hence, in the motor (M2) of the present embodiment, the dimension A of the salient poles 226b in the axial direction is set to 70%. As shown in FIG. 48, cogging torque T2 of the motor (M2) of the present embodiment is reduced to be less than the cogging torque T of the comparative example. It is understood that although the first and second cogging torque components are generated in the motor (M2) of the present embodiment, the first and second cogging torque components cancel out each other in the same manner as the motor M1 of the fifth embodiment.

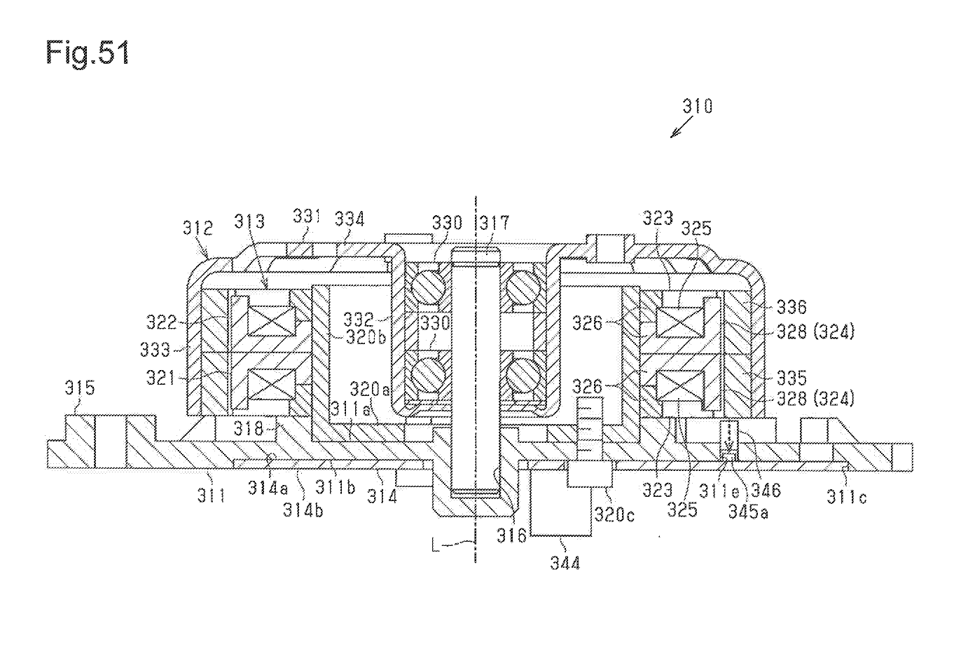

As shown in FIG. 50, the fourth order component of the cogging torque T of the motor (M0) of the comparative example is prominently large among the order components of the cogging torque. However, the cogging torque T2 of the motor (M2) of the present embodiment is significantly reduced.

Moreover, the cogging torque T2 of the motor (M2) of the present embodiment is reduced to be less than the cogging torque T1 of the motor M1 of the fifth embodiment. This is because the difference between the first and second cogging torque components of the present embodiment is smaller than the difference between the first and second cogging torque components of the fifth embodiment. This increases the effect of canceling out the first and second cogging torque components each other. The cogging torque T2 of the motor (M2) is reduced as a whole.

The sixth embodiment has the operation and the advantages described below in addition to advantages (14) to (17) of the fifth embodiment.

(18) The dimension A of the salient poles 226b in the axial direction is set to 60% to 80% of the dimension B of each of the stator units 221, 222 (first and second stator cores 223, 224 in coupled state) in the axial direction. Thus, the first and second cogging torque components have magnitudes similar to each other. This increases the effect of canceling out the first and second cogging torque components each other. The cogging torque T2 or the motor (M2) is further reduced as shown in FIG. 49.

The fifth and second embodiments may be modified as follows.

In the above embodiments, the present invention is applied to the motor M1 (M2) of an outer rotor type. Instead, the present invention may be applied to an inner rotor type motor.

In the above embodiments, the rotor 210 includes two sets of magnets, namely, the A-phase and B-phase magnets 214, 215, arranged one on the other in the axial direction. The stator 220 includes two phases, namely, the A-phase and B-phase stator units 221, 222, arranged in the axial direction. However, the number of magnets in the rotor and the number of phases in the stator are not limited to those described above.

In the above embodiments, the magnets 214, 215 of the rotor 210 have twelve poles (six pole pairs). The claw poles 232, 233 of the stator 220 have twenty-four poles. However, the number of poles is not limited to those described above.

In the above embodiments, the electrical angles θ1, θ2 are sec to forty-five degrees. However, the electrical angles θ1, θ2 are not limited to forty-five degrees.

In the above embodiments, the A-phase and B-phase stator units 221, 222 each include the auxiliary pole member 226. Instead, only one of the A-phase stator unit 221 and the B-phase stator unit 222 may include the auxiliary pole member 226.

In the above embodiments, the dimension A of the salient poles 226b of the auxiliary pole member 226 in the axial direction is set to 50% (fifth embodiment) and 70% (sixth embodiment) of the dimension B of each of the stator units 221, 222 in the axial direction. The dimension A is not limited to those described above.

A seventh embodiment of a motor will now be described.

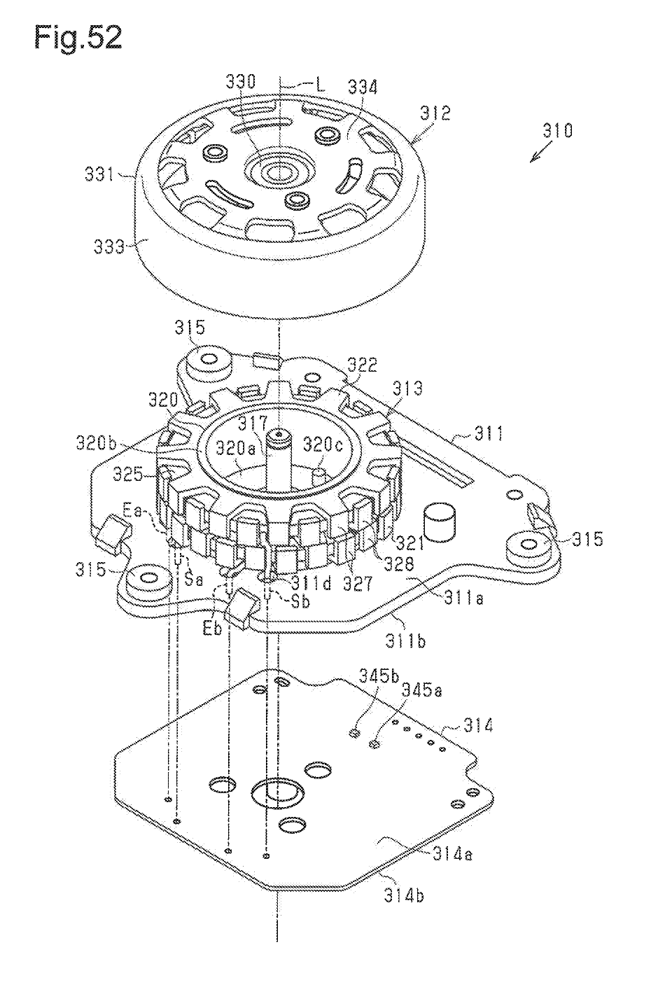

As shown in FIGS. 51 and 52, the present embodiment of a motor 310 is a brushless motor and includes a support member 311, a rotor 312 supported by the support member 311, a stator 313, and a circuit board 314.

The support member 311 is formed, for example, from a metal material such as aluminum. The support member 311 is flat (plate-shaped) and thin in the axial direction. More specifically, the support member 311 includes a first main surface 311a, which is orthogonal to the axial direction, and a second main surface 311b, which is the rear surface of the first main surface 311a and orthogonal to the axial direction. The support member 311 includes three coupling portions 315, which are used to couple the motor 310 to a predetermined installation position (refer to FIG. 52).

As shown, in FIG. 51, the support member 311 is recessed in a substantially central position defining a support shaft fixing portion 316, which is open toward the first main surface 311a in the axial direction. The basal portion of a support shaft 317 is fitted in and fixed to the support shaft fixing portion 316 in a non-rotational manner. The support shaft 317 projects from the first main surface 311a in the axial direction and is orthogonal to the first main surface 311a. The first main surface 311a includes a positioning projection 318, which projects in the axial direction and extends around the support shaft fixing portion 316. The positioning projection 318 is annular about the axis L of the support shaft 317 as viewed in the axial direction (in plan view).

As shown in FIGS. 51 and 52, the stator 313 includes a back yoke 320, which is fixed to the first main surface 311a of the support member 311, and two annular stator units 321, 322, which are fixed to the back yoke 320. In the present embodiment, the stator unit 321 is used for the A-phase and supplied with the A-phase drive current. The stator unit 322 is used for the B-phase and supplied with the B-phase drive current. The stator units 321, 322 have the same structure and the same shape.

The back yoke 320 is formed, for example, by stamping a plate of metal such as iron. The back yoke 320 includes a circular wall end 320a, which is in contact with the first main surface 311a of the support member 311 in the axial direction, and a tubular circumferential wall 320b, which extends from the circumferential edge of the wall end 320a in the axial direction. The wall end 320a is fastened to the first main surface 311a of the support member 311 by a screw 320c. The wall end 320a of the back yoke 320 is fitted into the inner circumferential surface of the positioning projection 318 of the support member 311. The A-phase stator unit 321 and the B-phase stator unit 322 are arranged next to each other in the axial direction and fixed to the outer circumferential surface of the circumferential wall 320b. The A-phase stator unit 321 and the B-phase stator unit 322 are sequentially arranged next to each other from the support member 311.

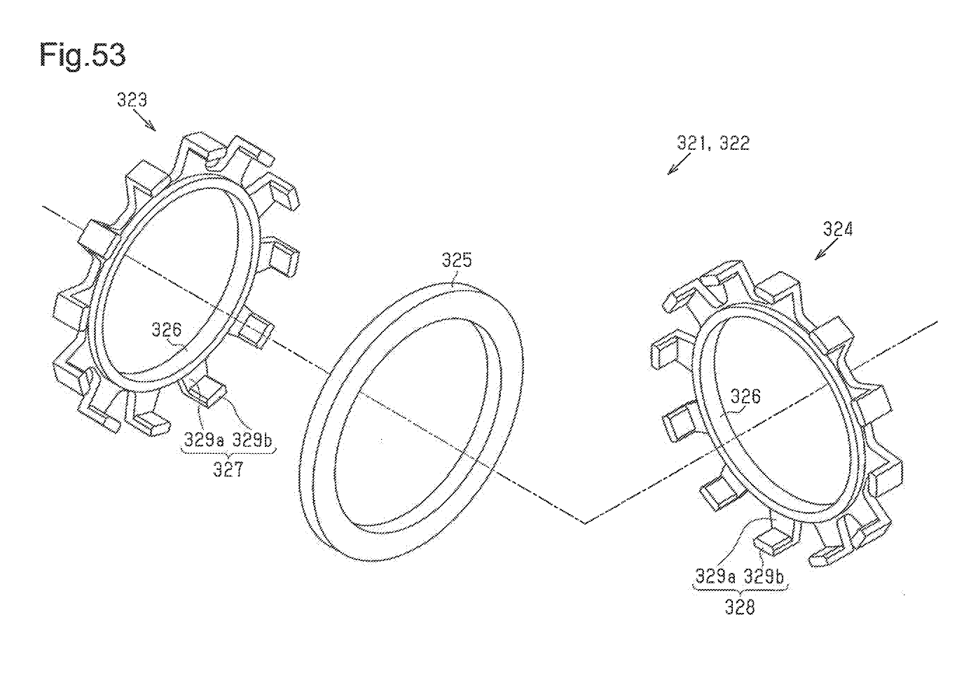

As shown in FIG. 53, the A-phase and B-phase stator units 321, 322 each include two stator cores (first stator core 323 and second stator core 324) having the same shape and a coil 325, which is located between the two stator cores 323, 324.

The stator cores 323, 324 each include a tube 326 and a plurality (twelve in present embodiment) of claw poles 327, 326 extending circumferentially outward from the tube 326. The claw poles of the first stator core 323 are referred to as first claw poles 327. The claw poles of the second stator core 324 are referred to as second claw poles 328. The claw poles 327, 328 have the same shape. The first claw poles 327 are arranged at equal intervals (thirty-degree intervals) in the circumferential direction. The second claw poles 328 are also arranged at equal intervals (thirty-degree intervals) in the circumferential direction.

Each of the claw poles 327, 328, which extend radially outward from the tube 326, is perpendicularly bent and directed in the axial direction. In each of the claw poles 327, 328, the portion extending radially outward from the tube 326 is referred to as a radial extension 329a, and the distal portion bent in the axial direction is referred to as a pole portion 329b. The radial extension 329a has a dimension in the circumferential direction that narrows toward the circumferentially outer side. The pole portion 329b has an outer circumferential surface (radially outer surface) that is arcuate about the axis L.

The stator cores 323, 324, which include the claw poles 327, 328 having the perpendicular shape, may be formed by bending a plate or performing die casting. Alternatively, the stator cores 323, 324 may be formed by mixing magnetic powder such as iron powder with an insulator such as a resin and performing heat press-molding on the mixture in a mold. In this case, the degree of freedom for designing each of the stator cores 323, 324 is increased, and the manufacturing process is significantly simplified. The limit amount of eddy current may be easily adjusted by adjusting the mixture ratio of the magnetic powder and the insulator.

The first and second stator cores 323, 324 having the above structure are coupled so that the first and second claw poles 327, 328 (pole portions 329b) are opposed to each other in the axial direction (refer to FIG. 53). In this coupling state, the pole portions 329b of the first claw poles 327 and the pole portions 329b of the second claw poles 328 are alternately arranged in equal intervals (fifteen-degree intervals) in the circumferential direction. More specifically, the stator 313 of the present embodiment has twenty-four poles. The first and second stator cores 323, 324 are fixed to each other with the tubes 326 in contact with each other in the axial direction.

In this coupling state, the coil 325 is located between the first and second stator cores 323, 324 in the axial direction. The coil 325 includes a winding, which is annularly wound in the circumferential direction of the stator 313, and an insulative resin bobbin (not shown), which is located between the winding and the first and second stator cores 323, 324. The coil 325 is located between the radial extension 329a of each of the first claw poles 327 and the radial extension 329a of each of the second claw poles 328 in the axial direction. Also, the coil 325 is located between the tube 326 of each of the stator cores 323, 324 and the pole portions 329b of the claw poles 327, 328 in the radial direction.

The A-phase and B-phase stator units 321, 322, which are configured as described above, have the so-called Lundell construction. More specifically, the A-phase and B-phase stator units 321, 322 have a twenty-four pole Lundell construction that excites the first and second claw poles 327, 328 into different magnetic poles whenever the current is supplied to the windings of the coils 325 located between the first and second stator cores 323, 324.

As shown in FIG. 51, the A-phase and B-phase stator units 321, 322 are arranged so that the second stator cores 324 are opposed to each other in the axial direction. Additionally, as described above, the A-phase stator unit 321 and the B-phase stator unit 322 are sequentially arranged next to each other from the support member 311 in the axial direction. Thus, the first stator core 323 of the A-phase stator unit 321, the second stator core 324 of the A-phase stator unit 321, the second stator core 324 of the B-phase stator unit 322, and the first stator core 323 of the B-phase stator unit 322 are sequentially arranged from the support member 311 in the axial direction.

The rotor 312 is supported by two bearings 330 onto the support shaft 317. The rotor 312 includes a rotor core 331, which is formed by a magnetic element such as an electromagnetic steel plate, and an A-phase magnet 335 and a B-phase magnet 336, which are fixed to the rotor core 331.

The rotor core 331 includes a cylindrical inner tube 332, the center of which conforms to the axis L of the support shaft 317 (axis of rotor 312), a cylindrical outer-tube 333, the center of which conforms to the axis L and located at a circumferentially outer side of the inner tube 332, and an upper wall end 334, which connects an axial end (upper end) of the inner tube 332 and an axial end (upper end) of the outer tube 333. In the rotor core 331, the inner circumferential surface of the inner tube 332 is rotationally supported by the bearings 330 onto the support shaft 317. The rotor core 331 includes an open end (end opposite to upper wall end 334), which is directed toward the support member 311 in the axial direction.

The A-phase magnet 335 and the B-phase magnet 336, which are sequentially arranged from the open end toward the upper wall end 334 of the rotor core 333 in the axial direction, are fixed to the inner circumferential surface of the outer tube 333. The A-phase magnet 335 and the B-phase magnet 336 have the same dimension in the axial direction. The A-phase magnet 335 is located at a radially outer side of the A-phase stator unit 321 and opposed to the pole portions 329b of the claw poles 327, 328 of the A-phase stator unit 321 in the radial direction. In the same manner, the B-phase magnet 336 is located at a radially outer side of the B-phase stator unit 322 and opposed to the pole portions 329b of the claw poles 327, 328 of the B-phase stator unit 322 in the radial direction.

The A-phase magnet 335 and the B-phase magnet 336 are magnetized in the radial direction so that north poles and south poles are alternately arranged at equal intervals in the circumferential direction. Additionally, the two phases have the same number of poles. The rotor 312 of the present embodiment has twenty-four poles (twelve pole pairs). More specifically, the pole pitch of each of the magnets 335, 336 of the rotor 312 is configured to be equal to the pole pitch of each, of the stator units 321, 322 (pitch between first claw pole 327 and second claw pole 328 that are adjacent to each other in circumferential direction). The A-phase magnet 335 and the B-phase magnet 336 may each be formed by a single annular permanent magnet or a plurality of permanent magnets arranged in the circumferential direction.

The positional relationship of the A-phase magnet 335 and the B-phase magnet 336 in the circumferential direction and the positional relationship of the A-phase stator unit 321 and the B-phase stator unit 322 in the circumferential direction will now be described.

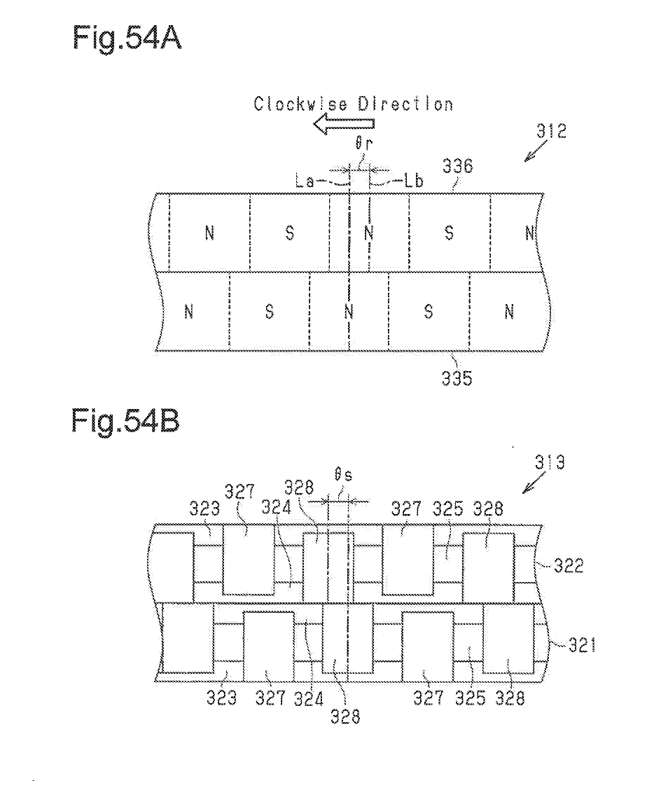

As shown in FIG. 54A, in the rotor 312, the B-phase magnet 336 is shifted from the A-phase magnet 335 in the counterclockwise direction by an electrical angle θr (forty-five degrees in present embodiment (3.75 degrees in mechanical angle)). In other words, the reference positions La, Lb of the A-phase magnet 335 and the B-phase magnet 336 are shifted from each other by the electrical angle θr.

As shown in FIG. 54B, in the stator 313, the B-phase stator unit 322 is shifted from the A-phase stator unit 321 by the electrical angle θs (forty-five degrees in present embodiment (3.75 degrees in mechanical angle)) in the clockwise direction. More specifically, the first and second claw poles 327, 328 of the B-phase stator unit 322 are shifted from the first and second claw poles 327, 328 of the A-phase stator unit 321 by the electrical angle θs in the clockwise direction. Thus, the phase difference between the A-phase motor unit (group of A-phase stator unit 321 and A-phase magnet 335) and the B-phase motor unit (group of B-phase stator unit 322 and B-phase magnet 336) is set to ninety degrees.

As shown in FIGS. 51 and 52, the stator 313 and the rotor 312 are located at one axial side (first main surface 311a) of the support member 311. The circuit board 314 is located at the other axial side (second main surface 311b) of the support member 311.

As shown in FIG. 51, the circuit board 314 is supported by the second main surface 311b of the support member 311. More specifically, the second main surface 311b is recessed defining an accommodation recess 311c. The circuit board 314 is accommodated in the accommodation recess 311c and fixed to the support member 311 by a screw, which is not shown in the drawings. The circuit board 314 is arranged so that a board surface of the circuit board 314 is orthogonal to the axial direction (axis L).

As shown in FIG. 52, an initial end Sa and a terminal, end Ea are drawn out from the coil 325 (winding described above and not shown) of the A-phase stator unit 321. In the same manner, an initial end Sb and a terminal end Eb are drawn out from the coil 325 (winding described above and not shown) of the B-phase stator unit 322. In the present embodiment, the initial ends Sa, Sb and the terminal ends Ea, Eb of the coils 325 are drawn out from a circumferentially outer side of the coils 325 toward the support member 311 extending through the first and second claw poles 327, 328 that are adjacent to each other in the circumferential direction. The initial ends Sa, Sb and the terminal ends Ea, Eb of the coils 325 are individually inserted through four insertion holes 311d, which extend through the support member 311 in the axial direction. The initial ends Sa, Sb and the terminal ends Ea, Eb of the coils 325 are connected to the circuit board 314, which is located on the second main surface 311b, for example, by performing soldering or the like. In each of the coils 325, the initial ends Sa, Sb are inlet terminals, and the terminal ends Ea, Eb are outlet terminals.

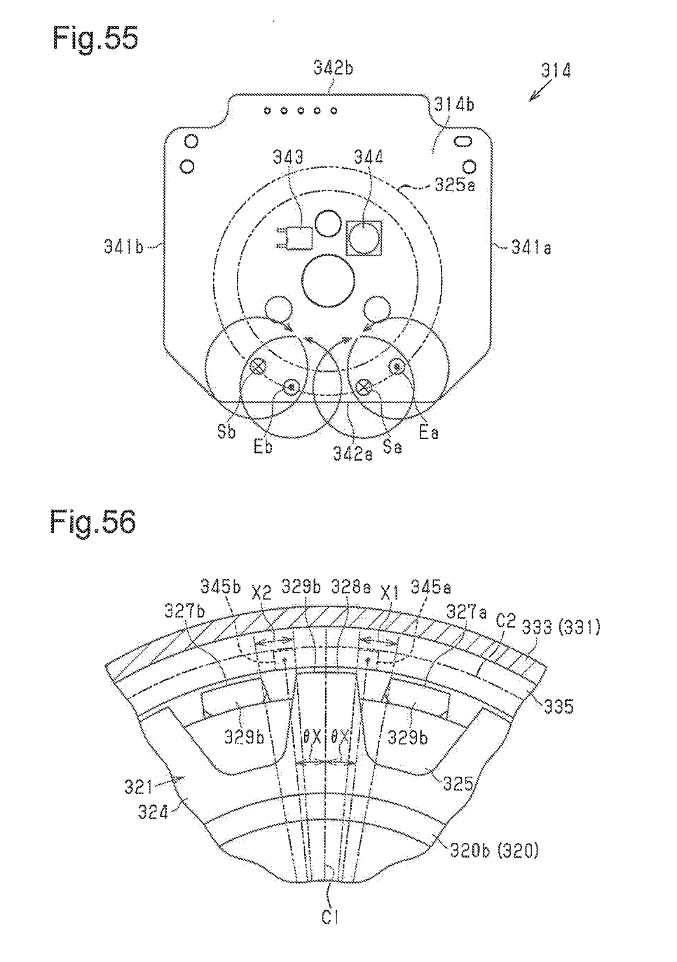

As shown in FIG. 55, the circuit board 314 has a rectangular shape in a plan view and has two first opposing sides 341a, 341b, which are opposed to each other, and two second opposing side 342a, 342b, which are opposed to each other in a direction orthogonal to the direction (sideward direction in FIG. 55) in which the first opposing sides 341a, 341b are opposed to each other. FIG. 55 is a plan view of the circuit board 314, having a front surface 314a and a rear surface 314b, taken from the rear surface 314b where the front surface 314a defines a surface opposed to the second main surface 311b of the support member 311 (refer to FIG. 52). The first opposing sides 341a, 341b are parallel to each other. The second opposing sides 342a, 342b are parallel to each other.

The initial end Sa and the terminal end Ea of the A-phase coil 325 are each connected to the circuit board 314 at a position closer to the first opposing side 341a, which is located at the right side in FIG. 55, than the first opposing side 341b and closer to the second opposing side 342a, which is located at the lower side in FIG. 55, than the second opposing side 342b. The initial end Sb and the terminal end Eb of the B-phase coil 325 are each connected to the circuit board 314 at a position closer to the first opposing side 341b, which is located at the left side in FIG. 55, than the first opposing side 341a and closer to the second opposing side 342a, which is located at the lower side in FIG. 55, than the second opposing side 342b. The connection positions of the initial ends Sa, Sb and the terminal ends Ea, Eb of the coils 325 are set in the order of the terminal end Ea of the A-phase coil 325, the initial end Sa of the A-phase coil 325, the terminal end Eb of the B-phase coil 325, and the initial end Sb of the B-phase coil 325 from the first opposing side 341a toward the first opposing side 341b. The connection positions of the initial end Sa of the A-phase coil 325 and the terminal end Eb of the B-phase coil 325 are set to be symmetrical at the left and right sides in FIG. 55. The connection positions of the terminal end Ea of the A-phase coil 325 and the initial end Sb of the B-phase coil 325 are set to be symmetrical at the left and right sides in FIG. 55.

When the connection positions of the initial ends Sa, Sb and the terminal ends Ea, Eb of the coils 325 are set in this manner, the connection positions of the initial ends Sa, Sb and the terminal ends Ea, Eb may be located proximate to each other in each phase. Currents flow to the initial ends Sa, Sb and the terminal ends Ea, Eb in opposite directions. This cancels out the magnetic field generated in the initial ends Sa, Sb and the magnetic field generated in the terminal ends Ea, Eb each other when energized.

For example, a switching element 343 formed by a power MOSFET and a capacitor 344, which is electrically connected to the coil 325 of each phase and functions as an anti-noise element, are mounted on the rear surface 314b of the circuit board 314. The switching operation of the switching element 343 adjusts power supplied to each of the coils 325 (A-phase and B-phase drive currents) thereby controlling rotation of the rotor 312. The switching element 343 and the capacitor 344 are arranged so as not to overlap the boundary of a projection region 325a of the coils 325 in the axial direction. In the present embodiment, the switching element 343 and the capacitor 344 are arranged at a radially inner side of the boundary of the projection region 325a of the coils 325 in the axial direction.

As shown in FIGS. 51 and 52, two Hall sensors (first Hall sensor 345a and second Hall sensor 345b) are mounted on the rear surface 314a of the circuit board 314 to detect the magnetic flux of the A-phase magnet 335 of the rotor 312. The Hall sensors 345a, 345b are arranged in a sensor reception slot 311e, which extend through the support member 311 in the axial direction. Additionally, the support member 311 supports sensor pins 346, which are formed by magnetic elements and located between the A-phase magnet 335 and each of the Hall sensors 345a, 345b in the axial direction.

The positions of the Hall sensors 345a, 345b in the circumferential and radial directions will now be described.

As shown in FIG. 56, the first Hall sensor 345a is arranged in an angular range X1 located between the pole portion 329b of any one (second claw pole 328a in FIG. 56) of the second claw poles 328 of the A-phase stator unit 321 and the pole portion 329b of the first claw pole 327a that is adjacent to the first claw pole 327a at one side in the circumferential direction. The second Hall sensor 345b is arranged in an angular range X2 located between the pole portion 329b of the second claw pole 328a and the pole portion 329b of the first claw pole 327b that is adjacent to the second claw pole 328a at the other side in the circumferential direction.

The first and second Hall sensors 345a, 345b are located at positions symmetrical about a circumferential centerline C1 of the pole portion 329b of the second claw pole 328a. It is preferred that the angular position θx (sensing position) of each of the Hall sensors 345a, 345b satisfy the following relational expressions (1) to (3) when the reference is set to the circumferential centerline C1 of the pole portion 329b of the second claw pole 328a.

θ2≤θx≤θ3 (1)

θ2=(360°/(8×p))+(n×(360°/p)) (2)

θ3=(360°/(4×p))+(n×(360°/p)) (3)

Here, p represents the number of pole pairs in the stator units 321, 322 (twelve in present embodiment), and n is an integer.

Additionally, it is preferred that each of the Hall sensors 345a, 345b be located radially inward from a radial centerline C2 of the A-phase magnet 335 at a position that overlaps the A-phase magnet 335 in the axial direction. This limits the effect of the magnetic flux from the A-phase stator unit 321 while ensuring the magnetic flux density of the A-phase magnet 335 detected by the Hall sensors 345a, 345b. Thus, the magnetic flux of the A-phase magnet 335 is detectable with high accuracy.

The operation of the present embodiment will now be described.

The A-phase drive current and the B-phase drive current are respectively supplied to the coil 325 of the A-phase stator unit 321 and the coil 325 of the B-phase stator unit 322 through the switching element 343 of the circuit board 314. The A-phase drive current and the B-phase drive current are each alternating current. In the present embodiment, the phase difference between the A-phase drive current and the B-phase drive current is set to ninety degrees. Thus, rotational torque is generated due to the relationship between the stator units 321, 322 and the magnets 335, 336 and rotates the rotor 312. At this time, the Hall sensors 345a, 345b perform sensing corresponding to the two phases based on the magnetic flux of the A-phase magnet 335. Based, on the results of sensing corresponding to the two phases, the drive current is switched at the optimal timing and supplied to the coil 325 from the switching element 343. This generates a favorable rotational magnetic field and rotates the rotor 312 in a favorable manner.

The seventh embodiment has the advantages described below.

(19) The support member 311, which is located between the Lundell-type stator 313 and the circuit board 314 in the axial direction, includes one axial side (first main surface 311a) that supports the stator 313 and the other axial side (second main surface 311b) that supports the circuit board 314. The initial ends Sa, Sb and the terminal ends Ea, Eb, which are drawn out from the coils 325 of the stator units 321, 322 of the two phases, are individually inserted into the through holes 311d of the support member 311 in the axial direction and connected to the circuit board 314. In this structure, the circuit board 314 is supported by the side of the support member 311 opposite to the side supporting the stator 313. Thus, when the initial ends Sa, Sb and the terminal ends Ea, Eb of the coils 325 of the stator 313 are connected to the circuit board 314, the first and second stator cores 323, 324 of the stator 313 and the support member 311 do not interfere. This facilitates the coupling. Additionally, the Lundell construction stator units 321, 322 have a few limitations on positions where the initial ends Sa, Sb and the terminal ends Ea, Eb of the coils 325 are drawn out. This minimizes the lengths of the initial ends Sa, Sb and the terminal ends Ea, Eb that are drawn out to the circuit board 314 in accordance with the layout of the circuit board 314.

(20) The circuit board 314 has the two first opposing sides 341a, 341b, which are opposed to each other, and the two second opposing side 342a, 342b, which are opposed to each other in a direction orthogonal to the direction in which the first opposing sides 341a, 341b are opposed to each other. The initial end Sa and the terminal end Ea of the A-phase coil 325 are connected to the circuit board 314 at positions closer to the first opposing side 341a and the second opposing side 342a. This structure allows the initial end Sa and the terminal end Ea of the A-phase coil 325 to be connected to the circuit board 314 at positions proximate to each other. When the coil 325 is energized, current flows to the initial end Sa and the terminal end Ea in opposite directions. Thus, the direction of the magnetic field generated around the initial end Sa is opposite to that generated around the terminal end Ea. When the initial end Sa and the terminal end Ea of the coil 325 are located close to each other, the magnetic fields of the initial end Sa and the terminal end Ea cancel out each other when energized. This limits adverse effects of the magnetic fields, which are generated at the initial end Sa and the terminal end Ea of the coil 325, on peripheral components such as electronic components mounted on the circuit board 314. Also, in the B-phase coil 325, the initial end Sb and the terminal end Eb are connected to the circuit board 314 at positions closer to the first opposing side 341b and the second opposing side 342a. Thus, the same advantage is obtained as described above.

(21) The switching element 343 is mounted on the circuit board 314 to adjust the power supplied to the coil 325. The switching element 343 is arranged so as not to overlap the projection region of the coils 325 in the axial direction. In this structure, the coils 325 and the switching element 343, each of which tends to generate heat, are arranged so as not to overlap each other in the axial direction. The dispersion of the heating sources limits concentration of heat.

(22) The capacitor 344 is mounted on the circuit board 314 and electrically connected to the coils 325. The capacitor 344 is arranged so as not to overlap the projection region of the coils 325 in the axial direction. In this structure, the capacitor 344, which is an element of a relatively low heating resistance, may be located at a position separated away from the coils 325, which tend to generate heat. This limits adverse effects of the heat of the coils 325 on the capacitor 344. Thus, the reliability of the motor 310 may be increased.

(23) The stator 313 includes the stator units 321, 322, which are arranged next to each other in the axial direction. With this structure, the coils 325 of the stator units 321, 322 each need to be connected to the circuit board 314. Thus, advantage (19), which facilitates the coupling, is more prominently obtained when the coils 325 of the above structure are connected to the circuit board 314.

(24) The first and second Hall sensors 345a, 345b, which detect the magnetic flux of the A-phase magnet 335, are respectively arranged in the angular ranges X1, X2 located, in the circumferential direction, between circumferentially adjacent ones of the claw poles 327, 328 of the closest one (A-phase stator unit 321) of the stator units to the support member 311. This structure limits the effect of the magnetic flux from the claw poles 327, 328 of the A-phase stator unit 321. Thus, the magnetic flux of the A-phase magnet 335 is detectable with high accuracy.

(25) The sensor pins 346 formed by magnetic elements are located between the A-phase magnet 335 and each of the Hall sensors 345a, 345b in the axial direction. This structure allows the magnetic flux of the A-phase magnet 335 to be drawn in through the sensor pins 346. Thus, the interval of the A-phase magnet 335 and each of the Hall sensors 345a, 345b may be widened in the axial direction while the magnetic flux of the A-phase magnet 335 is detectable by the Hall sensors 345a, 345b in a satisfactory manner. This may increase the degree of freedom of the layout. The sensor pins 346 may be directly supported by the support member 311. Alternatively, the sensor pins 346 may be supported, for example, by a fixing member formed from a resin material.

The seventh embodiment may be modified as follows.

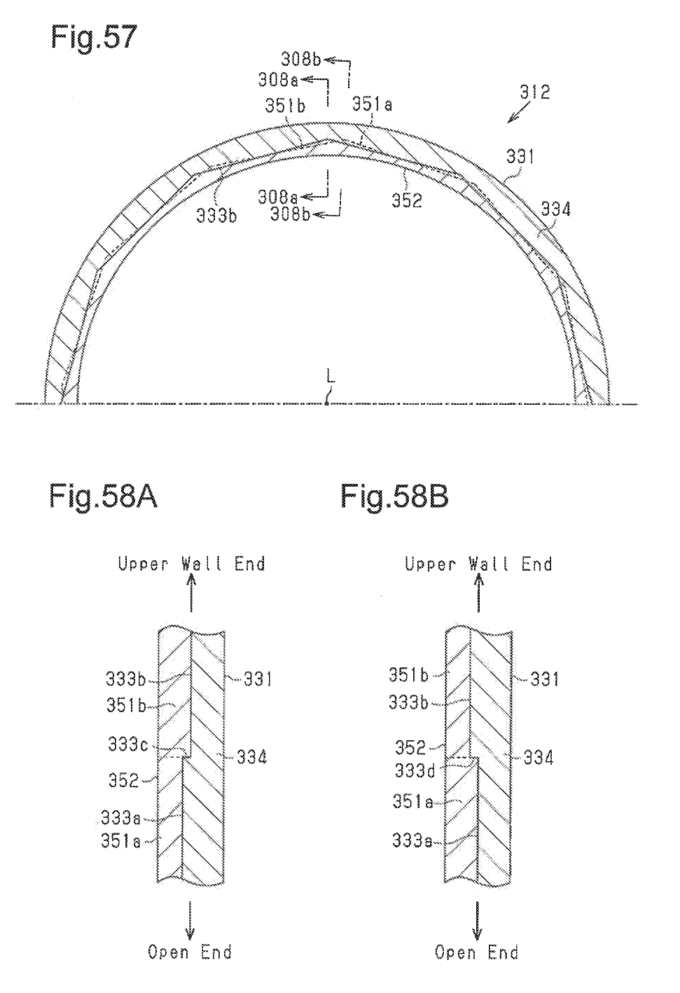

In the above embodiment, the outer tube 333 of the rotor core 331, the A-phase magnet 335, and the B-phase magnet 336 may have structures such as those shown in FIGS. 57, 58A, and 58B.

In the structures shown in FIGS. 57, 58A, and 58B, a permanent magnet 352 that integrally includes an A-phase magnet portion 351a and a B-phase magnet portion 351b is arranged on the inner circumferential surface of the outer tube 333 of the rotor core 331. The permanent magnet 352 is formed, for example, by a bonded magnet on the inner circumferential surface of the outer tube 333 integrally through injection molding. In the permanent magnet 352, the A-phase magnet portion 351a and the B-phase magnet portion 351b are sequentially arranged in the axial direction from the open end (lower side in FIG. 58) toward the upper wall end 334 (refer to FIG. 51) of the rotor core 331.

The inner circumferential surface of the outer tube 333 has an A-phase magnet formation surface 333a, on which the A-phase magnet portion 351a is formed, and a B-phase magnet formation surface 333b, on which the B-phase magnet portion 351b is formed. Each of the magnet formation surfaces 333a, 333b has the form of a regular polygon about the axis L as viewed in the axial direction (in plan view). Thus, the A-phase magnet portion 351a and the B-phase magnet portion 351b, which are respectively formed on the A-phase magnet formation surface 333a and the B-phase magnet formation surface 333b through injection molding, each have an outer circumferential surface having the form of a regular polygon in conformance with the shape of the A-phase magnet formation surface 333a and the B-phase magnet formation surface 333b. The A-phase magnet portion 351a and the B-phase magnet portion 3 51b each have an inner circumferential surface that are flush with each other and circular about the axis L as viewed in the axial direction.

The regular polygons of the outer circumferential surfaces of the A-phase magnet portion 351a and the B-phase magnet portion 351b have the same number of edges. In the present example, the outer circumferential surfaces of the A-phase magnet portion 351a and the B-phase magnet portion 351b have the form of a regular dodecagon. The positional relationship of the A-phase magnet portion 351a and the B-phase magnet portion 351b in the circumferential direction is the same as the positional relationship of the A-phase magnet 335 and the B-phase magnet 336 of the seventh embodiment in the circumferential direction. More specifically, the E-phase magnet portion 351b is shifted from the A-phase magnet portion 351a by a predetermined angle (in present example, forty-five degrees in electrical angle, 3.75 degrees in mechanical angle) in the counterclockwise direction.

Thus, as shown in FIG. 58A, the inner circumferential surface of the outer tube 333 includes a step 333c between the B-phase magnet formation surface 333b and the A-phase magnet formation surface 333a in the proximity of each edge of the outer circumferential surface of the B-phase magnet portion 351b. The B-phase magnet portion 351b is hooked on the step 333c toward the open end of the rotor core 331 in the axial direction. Also, as shown in FIG. 58B, the inner circumferential surface of the outer tube 333 includes a step 333d between the A-phase magnet formation surface 333a and the B-phase magnet formation surface 333b in the proximity of each edge of the outer circumferential surface of the A-phase magnet portion 351a. The A-phase magnet portion 351a is hooked on the step 333b toward the upper wall end 334 in the axial direction. This restricts the displacement of the permanent magnet 352 from the rotor core 331 toward opposite sides in the axial direction. Additionally, separation of the permanent magnet 352 from the open end of the rotor core 331 is limited.

In the same manner as the A-phase magnet 335 and the B-phase magnet 336 of the above embodiment, the A-phase magnet portion 351a and the B-phase magnet portion 351b are magnetized in the radial direction so that north poles and south poles are alternately arranged at equal intervals in the circumferential direction. The A-phase magnet portion 351a and the B-phase magnet portion 351b have the same number of poles and, in the present example, twenty-four poles (twelve pole pairs). More specifically, in the present example of the magnetic portions 351a, 351b of the two phases, the number of edges of the outer circumferential surface and the number of pole pairs are twelve and conform to each other. In the magnetic portions 351a, 351b of the two phases, the centers of the north poles (or south poles) are set to positions of the edges of the outer circumferential surface. The centers of the south poles (or north poles) are set to middle positions between edges of the outer circumferential surface of the magnetic portions 351a, 351b (positions where magnetic portions 351a, 351b are thinnest in the radial direction).

With the above structure, the outer circumferential surface of the permanent magnet 352 is polygonal and engages with the inner circumferential surface of the outer tube 333 of the rotor core 331 in the circumferential direction. This restricts the displacement of the permanent magnet 352 from the rotor core 331 in the circumferential direction.

Additionally, with the above structure, when the thickness of each of the magnet portions 351a and 351b is adjusted in the radial direction, the even-number components may be superimposed on the base wave of the surface magnetic flux density waveform. This cancels out the even number components, which are the main component of the cogging torque of the two-phase Lundell-type motor. Thus, the cogging torque is reduced.

In the above embodiment, the sensor pins 346 may be omitted, and the Hall sensors 345a, 345b may be located further closer to the A-phase magnet 335.

In the above embodiment, the first and second Hall sensors 345a, 345b are respectively arranged in the angular ranges X1, X2 located, in the circumferential direction, between circumferentially adjacent ones of the claw poles 327, 328 of the A-phase stator unit 321. However, the first and second Hall sensors 345a, 345b may be located outside the angular ranges X1, X2. Additionally, the radial positions of the Hall sensors 345a, 345b are not limited to those of the seventh embodiment and may be changed.

In the above embodiment, the switching element 343 and the capacitor 344 are arranged at the radially inner side of the boundary of the projection region 325a of the coils 325 in the axial direction. Instead, the switching element 343 and the capacitor 344 may be arranged, for example, at a radially outer side of the boundary of the projection region 325a of the coils 325 in the axial direction.

In the above embodiment, the initial ends Sa, Sb and the terminal ends Ea, Eb of the coils 325 are drawn out from the circumferentially outer sides of the coils 325. Instead, the initial ends Sa, Sb and the terminal ends Ea, Eb of the coils 325 may be drawn out from circumferentially inner sides of the coils 325.

The positions where the initial ends Sa, Sb and the terminal ends Ea, Eb of the coils 325 are connected to the circuit board 314 are not limited to the positions of the seventh embodiment and may be changed in accordance with the structure.

The number of poles in the rotor 312 and the stator 313 is not limited to the number of poles of the seventh embodiment and may be changed.

The number of phases in the rotors 312 and the stators 313 is not limited to two, as described in the above embodiment, and may be one or three or more.

The above embodiments and modified examples may be combined.

Technical concepts that can be acknowledged from the seventh embodiment and the modified examples are as follows.

(G) A motor including:

a stator including a Lundell-type stator unit, wherein the stator unit includes a first stator core, a second stator core, and a coil located between the first stator core and the second stator core, each of the first stator core and the second stator core has a circumferential portion and a plurality of claw poles arranged on the circumferential portion, and the first stator core and the second stator core are arranged so that the claw poles of the first stator core and the claw poles of the second stator core are alternately arranged in a circumferential direction; and

a rotor including an annular rotor core and a permanent magnet located on an inner circumferential surface of the rotor core, wherein the rotor core is located at a circumferentially outer side of the stator unit, the permanent magnet is annular about an axis of the rotor and opposed to the claw poles in a radial direction, wherein

the inner circumferential surface of the rotor core is polygonal as viewed in an axial direction, and

the permanent magnet has an outer circumferential surface that is in close contact with the inner circumferential surface of the rotor core and is polygonal in conformance with a shape of the inner circumferential surface of the rotor core.

With this structure, the outer circumferential surface of the permanent magnet engages the inner circumferential surface of the rotor core in the circumferential direction. This limits the displacement of the permanent magnet from the rotor core in the circumferential direction.

1. A motor comprising:
an A-phase stator unit that includes two stator cores and a coil located between the stator cores, wherein each of the stator cores includes a plurality of claw poles arranged at equal angular intervals;
a B-phase stator unit that includes two stator cores and a coil located between the stator cores, wherein each of the stator cores includes a plurality of claw poles arranged at equal angular intervals; and
a rotor that includes at least two permanent magnets respectively opposed to the claw poles of the A-phase stator unit and the claw poles of the B-phase stator unit, wherein
the A-phase stator unit and the B-phase stator unit are arranged next to each other in an axial direction and shifted from each other by a predetermined electrical angle,
the two permanent magnets are arranged next to each other in the axial direction and shifted from each other by a predetermined electrical angle, and
a direction in which the A-phase stator unit and the B-phase stator unit are shifted from each other is opposite to a direction in which the two permanent magnets are shifted from each other.

2. The motor according to claim 1, wherein
the at least two permanent magnets are at least three permanent magnets arranged next to one another in the axial direction, and
at least two of the at least three permanent magnets are located at different angles.

3. The motor according to claim 2, wherein
the rotor includes an A-phase rotor unit, which is opposed to the A-phase stator unit, and a B-phase rotor unit, which is opposed to the B-phase stator unit,
the A-phase rotor unit includes two of the permanent magnets that are arranged next to each other in the axial direction at different angles, and
the B-phase rotor unit includes two of the permanent magnets that are arranged next to each other in the axial direction at different angles.

4. The motor according to claim 3, wherein the permanent magnet of the A-phase rotor unit has a dimension in the axial direction that is equal to that of the permanent magnet of the B-phase rotor unit.

5. The motor according to claim 3, wherein
the A-phase rotor unit and the B-phase rotor unit each have a reference position,
the reference position of the A-phase rotor unit is shifted from the reference position of the B-phase rotor unit by an electrical angle that is equal to an angle by which the A-phase stator unit and the B-phase stator unit are shifted from each other,
a direction in which the reference position of the B-phase rotor unit is shifted from the reference position of the A-phase rotor unit is opposite to a direction in which the B-phase stator unit is shifted from the A-phase stator unit,
the two permanent magnets of the A-phase rotor unit are shifted from the reference position of the A-phase rotor toward opposite sides of the reference position by one-half of the electrical angle, and
the two of the permanent magnets of the B-phase rotor unit are shifted from the reference position of the B-phase rotor toward opposite sides of the reference position by one-half of the electrical angle.

6. The motor according to claim 1, wherein
the at least two permanent magnets include an axially inner portion and axially outer portions,
the axially inner portion is opposed to a part of the A-phase stator unit and the B-phase stator unit proximate to a boundary of the A-phase stator unit and the B-phase stator unit in the axial direction,
the axially outer portions are opposed to parts of the A-phase stator unit and the B-phase stator unit located at opposite sides of the boundary in the axial direction, and
the at least two permanent magnets are configured so that magnetic force of the axially inner portion is weak relative to magnetic force of the axially outer portions.

7. The motor according to claim 6, wherein the magnetic force of the axially inner portion is set to 60% or greater and less than 100% of the magnetic force of the axially outer portion.

8. The motor according to claim 6, wherein the axially inner portion and the axially outer portions include separate magnets.

9. The motor according to claim 1, wherein
the two stator cores of the A-phase stator unit include a first core portion and a second core portion,
the two stator cores of the B-phase stator unit include a first core portion and a second core portion,
each of the first core portions includes a discoid core base and a plurality of claw poles arranged on the core base in a circumferential direction and extending in the axial direction,
each of the second core portions includes a discoid core base and a plurality of claw poles arranged on the core base in the circumferential direction and extending in the axial direction,
the coil is held between the first core portion and the second core portion in the axial direction, and
the motor further comprises a core back portion that is separate from the first core portion and the second core portion and is formed by a magnetic member,
wherein the core back portion is located on the first core portion at a side opposite to the claw poles of the first core portion in a radial direction and on the second core portion at a side opposite to the claw poles of the second core portion in the radial direction.

10. The motor according to claim 9, wherein
the first core portion and the second core portion each include a recess that extends toward the claw poles from where the core back portion is located in the radial direction, and
the core back portion is arranged in the recess.

11. The motor according to claim 9, wherein
the A-phase stator unit and the B-phase stator unit are two of a plurality of stator units stacked in the axial direction, and
the motor further includes a retainer that retains the stacked stator units from opposite sides in the axial direction.

12. The motor according to claim 11, wherein
the retainer includes a first retaining portion located at one side of the stacked stator units in the axial direction, a second retaining portion located at another side of the stacked stator units in the axial direction, and a connection portion that connects the first retaining portion and the second retaining portion, and
the connection portion partially includes the core back portion.

13. The motor according to claim 1, wherein
the two stator cores of the A-phase stator unit include a first core portion and a second core portion,
the two stator cores of the B-phase stator unit include a first core portion and a second core portion,
each of the first core portions includes an annular core base and a plurality of claw poles arranged on the core base in a circumferential direction and extending in the axial direction,
each of the second core portions includes an annular core base and a plurality of claw poles arranged on the core base in the circumferential direction and extending in the axial direction,
the coil is held between the first core portion and the second core portion in the axial direction, and
at least one of the core base of the first core portion and the core base of the second core portion includes a recess located in a radially inner portion of the core base and at least partially extending in the circumferential direction.

14. The motor according to claim 13, wherein the recess is annular and continuous in the circumferential direction.

15. The motor according to claim 13, wherein
the recess is one of a plurality of recesses, and
the recesses are arranged at predetermined intervals in the circumferential direction.

16. The motor according to claim 13, wherein
the A-phase stator unit and the B-phase stator unit are two of a plurality of stator units, and
the stator units are stacked in the axial direction.

17. The motor according to claim 16, wherein the core base of one of the first core portions and the second core portions of the stator cores that is located at an axially outer side includes the recess located in a radially inner portion of the core base.

18. The motor according to claim 16, wherein
the first core portions and the second core portions of the stator units include a plurality of core bases, and
at least one of the core bases includes the recess located in a radially inner portion of the core base.

19. The motor according to claim 13, further comprising a holder that holds the stator when the holder engages the recess.

20. The motor according to claim 1, wherein
the two stator cores of the A-phase stator unit include a first stator core and a second stator core,
the two stator cores of the B-phase stator unit include a first stator core and a second stator core,
the claw poles of each of the first stator cores correspond to a plurality of first claw poles,
the claw poles of each of the second stator cores correspond to a plurality of second claw poles,
the motor further comprises an auxiliary pole member located between each of the first stator cores and each of the second stator cores,
the auxiliary pole member includes a plurality of salient poles arranged at equal angular intervals and an annular base that connects the salient poles, and
each of the salient poles is located between one of the first claw poles and one of the second claw poles.

21. The motor according to claim 20, wherein the salient poles of the auxiliary pole member each have a dimension in the axial direction that is set to 60% to 80% of a dimension, in the axial direction, of the first stator core and the second stator core that are coupled to each other.

22. The motor according to claim 20, wherein the salient poles of the auxiliary pole member are each located in a central position of circumferentially adjacent ones of the first claw poles and the second claw poles.

23. The motor according to claim 20, wherein the auxiliary pole member is configured so that a dimension of the base in a radial direction is less than a dimension of each of the salient poles in the circumferential direction.

24. The motor according to claim 20, wherein the auxiliary pole member is formed by a single plate.

25. The motor according to claim 1, further comprising:
a stator that includes the A-phase stator unit and the B-phase stator unit;
a circuit board located at a side of the stator in the axial direction and connected to the coil of each of the A-phase stator unit and the B-phase stator unit; and
a support member located between the stator and the circuit board, wherein the support member includes insertion holes, a surface located at one side in the axial direction and supporting the stator, and a surface located at another side in the axial direction and supporting the circuit board, wherein
the coil has an initial end and a terminal end that are drawn out from the coil, and
the initial end and the terminal end of the coil are inserted through the insertion holes in the support member in the axial direction and connected to the circuit board.

26. The motor according to claim 25, wherein
the circuit board has two first opposing sides, which are opposed to each other, and two second opposing sides, which are opposed to each other in a direction orthogonal to a direction In which the two first opposing sides are opposed to each other, and
the initial end and the terminal end of the coil are each connected to the circuit board at a position closer to one of the two first opposing sides and one of the two second opposing sides.

27. The motor according to claim 25, wherein
a switching element is mounted on the circuit board to adjust power supplied to the coil, and
the switching element is arranged so as not to overlap a boundary of a projection region of the coil in the axial direction.

28. The motor according to claim 25, wherein
a capacitor is mounted on the circuit board and electrically connected to the coil, and
the capacitor is arranged so as not to overlap a boundary of a projection region of the coil in the axial direction.

29. The motor according to claim 25, wherein
the A-phase stator unit and the B-phase stator unit are two of a plurality of stator units, and
the stator includes the stator units arranged next to one another in the axial direction.

30. The motor according to claim 29, further comprising:
a sensor that detects a magnetic flux of the permanent magnets, wherein the sensor is arranged in an angular range located between circumferentially adjacent ones of the claw poles of the stator unit that is located closest to the support member.

31. A method for manufacturing a stator, wherein the stator includes a first core portion, which includes a discoid core base and a plurality of claw poles extending from the core base in an axial direction, a second core portion, which includes a discoid core base and a plurality of claw poles extending from the core base in the axial direction, and a coil, which is held between the first core portion and the second core portion in the axial direction, the method comprising:
forming magnetic powder cores that form the first core portion and the second core portion through compression molding;
forming a core back portion from a magnetic member separately from the first core portion and the second core portion; and
arranging the core back portion so that the core back portion is in contact with the first core portion and the second core portion at a portion of the stator located at a side opposite to the claw poles in a radial direction.
